(19) United States
(12) Patent Application Publication
(10) Pub. No.: US 2025/0343900 A1
(43) Pub. Date: Nov. 6, 2025

(54) ENCODING METHOD, DECODING METHOD, BITSTREAM, ENCODER, DECODER, AND STORAGE MEDIUM

(71) Applicant: GUANGDONG OPPO MOBILE TELECOMMUNICATIONS CORP., LTD., Dongguan (CN)

(72) Inventors: Yanzhuo MA, Dongguan (CN); Junyan HUO, Dongguan (CN); Fuzheng YANG, Dongguan (CN); Wenhan QIAO, Dongguan (CN); Ming LI, Dongguan (CN)

(21) Appl. No.: 19/273,581

(22) Filed: Jul. 18, 2025

Related U.S. Application Data
(63) Continuation of application No. PCT/CN2023/073455, filed on Jan. 20, 2023.

(51) Int. Cl. H04N 19/105; H04N 19/117; H04N 19/132; H04N 19/159; H04N 19/167; H04N 19/176; H04N 19/463; H04N 19/52; H04N 19/82

(52) U.S. Cl. CPC H04N 19/105; H04N 19/117; H04N 19/132; H04N 19/159; H04N 19/167; H04N 19/176; H04N 19/463; H04N 19/52; H04N 19/82

(57) ABSTRACT

The embodiments of the present invention provide an encoding method which includes: determining a first template of a current block, and determining a matching template and a reference block; determining a model parameter according to the first template and the matching template; filtering the reference block according to the model parameter, to determine a filtered reference block; determining a prediction value of the current block according to the filtered reference block; and determining a reconstructed value of the current block according to the prediction value of the current block.

### CROSS-REFERENCE TO RELATED APPLICATION

This application is a Continuation Application of International Application No. PCT/CN2023/073455 filed on Jan. 20, 2023, which is incorporated herein by reference in its entirety.

### TECHNICAL FIELD

The present disclosure relates to the field of video encoding and decoding technology, and in particular to, an encoding method, a decoding method, a bitstream, an encoder, a decoder and a storage medium.

### RELATED ART

A template matching (TM) prediction technology searches for, according to a preset cost function, a matching template with a minimum cost value relative to a template of a coding block within a predefined search range via the template of a coding block, and uses a best matching reconstructed block corresponding to the matching template as a prediction block of a current coding block.

However, in an actual coding process, reconstructed samples of the best matching reconstructed block are usually directly used as predicted samples of the current coding block in the related art. However, due to incomplete consideration, there will be large deviations in some scenarios, which causes low accuracy of prediction.

### SUMMARY

The present disclosure provides an encoding method, a decoding method, a bitstream, an encoder, a decoder and a storage medium.

Technical solutions of the present disclosure may be implemented as follows:

In a first aspect, embodiments of the present disclosure provide a decoding method, which is applied to a decoder and includes:
determining a first template of a current block, and determining a matching template and a reference block;
determining a model parameter according to the first template and the matching template;
filtering the reference block according to the model parameter, to determine a filtered reference block;
determining a prediction value of the current block according to the filtered reference block; and
determining a reconstructed value of the current block according to the prediction value of the current block.

In a second aspect, the embodiments of the present disclosure provide an encoding method, which is applied to an encoder and includes:
determining a first template of a current block, and determining a matching template and a reference block;
determining a model parameter according to the first template and the matching template;
filtering the reference block according to the model parameter, to determine a filtered reference block;
determining a prediction value of the current block according to the filtered reference block; and
determining a prediction residual value of the current block according to the prediction value of the current block.

In a third aspect, the embodiments of the present disclosure provide a bitstream, which is generated by bit encoding according to information to be encoded; where the information to be encoded includes at least one of:
a prediction residual value of a current block, a number of coefficients of a target filter, a shape of a target filter, a value of first syntax element flag information, a value of second syntax element flag information, or a value of third syntax element flag information; where the first syntax element flag information is used for indicating whether template matching is applied to the current block, the second syntax element flag information is used for indicating whether a filter model is applied to the current block, and the third syntax element flag information is used for indicating a reference block of the current block.

In a fourth aspect, the embodiments of the present disclosure provide an encoder, which includes a first determining unit, a first filtering unit, and a first prediction unit; where the first determining unit is configured to determine a first template of a current block, and determine a matching template and a reference block; and the first determining unit is further configured to determine a model parameter according to the first template and the matching template;
the first filtering unit is configured to filter the reference block according to the model parameter, to determine a filtered reference block;
the first prediction unit is configured to determine a prediction value of the current block according to the filtered reference block;
the first determining unit is further configured to determine a prediction residual value of the current block according to the prediction value of the current block.

In a fifth aspect, the embodiments of the present disclosure provide an encoder, which includes a first memory and a first processor; where
the first memory is configured to store a computer program executable on the first processor; and
the first processor is configured to, when running the computer program, perform the method according to the second aspect.

In a sixth aspect, the embodiments of the present disclosure provide a decoder, which includes a second determining unit, a second filtering unit, and a second prediction unit; where
the second determining unit is configured to determine a first template of a current block, and determine a matching template and a reference block; and the second determining unit is further configured to determine a model parameter according to the first template and the matching template;
the second filtering unit is configured to filter the reference block according to the model parameter, to determine a filtered reference block;
the second prediction unit is configured to determine a prediction value of the current block according to the filtered reference block; and
the second determining unit is further configured to determine a reconstructed value of the current block according to the prediction value of the current block.

In a seventh aspect, the embodiments of the present disclosure provide a decoder, which includes a second memory and a second processor; where
the second memory, configured to store a computer program executable on the second processor; and
the second processor, configured to, when running the computer program, perform the method according to the first aspect.

In an eighth aspect, the embodiments of the present disclosure provide a non-transitory computer-readable storage medium that stores a computer program, where when the computer program is executed, the method according to the first aspect is implemented, or the method according to the second aspect is implemented.

### BRIEF DESCRIPTION OF THE DRAWINGS

FIG. 1A is a schematic diagram of a prediction process of an inter TM technology.

FIG. 1B is a schematic diagram of a prediction process of an intra TM technology.

FIG. 1C is a schematic diagram of a prediction process of another intra TM technology.

FIG. 2 is a schematic diagram of a prediction process based on TM technology.

FIG. 3A to FIG. 3F are schematic diagrams of template types of TM technology.

FIG. 4A is a schematic block diagram of composition of an encoder provided in embodiments of the present disclosure.

FIG. 4B is a schematic block diagram of composition of a decoder provided in embodiments of the present disclosure.

FIG. 5 is a schematic diagram of a network architecture of an encoding and decoding system provided in embodiments of the present disclosure.

FIG. 6 is a schematic flowchart of a decoding method provided in embodiments of the present disclosure.

FIG. 7A to FIG. 7H are schematic diagrams of different partitioning of sub-regions of a search region provided in embodiments of the present disclosure.

FIG. 8A is a schematic flowchart of a prediction process based on TM-FLM technology provided in embodiments of the present disclosure.

FIG. 8B is a schematic position diagram of sources of spatially neighbouring coding units provided in embodiments of the present disclosure.

FIG. 9 is a schematic flowchart of a search process based on TM technology provided in embodiments of the present disclosure.

FIG. 10 is a schematic diagram of parameter definition of a current block and a template of the current block provided in embodiments of the present disclosure.

FIG. 11 is a schematic diagram of a template search region provided in embodiments of the present disclosure.

FIG. 12 is a schematic diagram of a determining process of an exemplary search region provided in embodiments of the present disclosure.

FIG. 13 is a schematic flowchart of a search process provided in embodiments of the present disclosure.

FIG. 14A to FIG. 14F are schematic diagrams of shapes of filters provided in embodiments of the present disclosure.

FIG. 15 is a schematic flowchart of calculating filter coefficients provided in embodiments of the present disclosure.

FIG. 16A is a schematic diagram of a boundary padding region provided in embodiments of the present disclosure.

FIG. 16B is a schematic diagram of another boundary padding region provided in embodiments of the present disclosure.

FIG. 17A to FIG. 17F are schematic diagrams of boundary padding regions of other template types provided in embodiments of the present disclosure.

FIG. 18A is a schematic diagram of composition of filter coefficients provided in embodiments of the present disclosure.

FIG. 18B is a schematic diagram of a composition of a predicted sample provided in embodiments of the present disclosure.

FIG. 19A is a first schematic diagram of a determining process of an exemplary search region provided in embodiments of the present disclosure.

FIG. 19B is a second schematic diagram of a determining process of an exemplary search region provided in embodiments of the present disclosure.

FIG. 19C is a third schematic diagram of a determining process of an exemplary search region provided in embodiments of the present disclosure.

FIG. 19D is a fourth schematic diagram of a determining process of an exemplary search region provided in embodiments of the present disclosure.

FIG. 19E is a fifth schematic diagram of a determining process of an exemplary search region provided in embodiments of the present disclosure.

FIG. 19F is a sixth schematic diagram of a determining process of an exemplary search region provided in embodiments of the present disclosure.

FIG. 19G is a seventh schematic diagram of a determining process of an exemplary search region provided in embodiments of the present disclosure.

FIG. 19H is an eighth schematic diagram of a determining process of an exemplary search region provided in embodiments of the present disclosure.

FIG. 20 is a schematic flowchart of an encoding method provided in embodiments of the present disclosure.

FIG. 21 is a schematic diagram of a composition structure of an encoder provided in embodiments of the present disclosure.

FIG. 22 is a schematic diagram of an exemplary hardware structure of an encoder provided in embodiments of the present disclosure.

FIG. 23 is a schematic diagram of a composition structure of a decoder provided in embodiments of the present disclosure.

FIG. 24 is a schematic diagram of an exemplary hardware structure of a decoder provided in embodiments of the present disclosure.

FIG. 25 is a schematic diagram of a composition structure of an encoding and decoding system provided in embodiments of the present disclosure.

### DETAILED DESCRIPTION

In order to understand features and technical contents in the embodiments of the present disclosure in more detail, implementation in the embodiments of the present disclosure will be described in detail below in conjunction with the accompanying drawings. The accompanying drawings are used for reference only and are not used to limit the embodiments of the present disclosure.

Unless defined otherwise, all technical and scientific terms used here have the same meaning as commonly understood by one of ordinary skill in the art to which the present disclosure belongs. The terms used here are only for the purpose of describing the embodiments of the present disclosure and are not intended to limit the present disclosure.

In the following description, reference is made to “some embodiments”, which describe a subset of all possible embodiments, but it will be understood that “some embodiments” may be the same subset or different subsets of all possible embodiments, and may be combined with each other without conflict. It should also be pointed out that the terms “first\second\third” involved in the embodiments of the present disclosure are only used to distinguish similar objects and do not represent a specific ordering of the objects. It may be understood that “first\second\third” may be interchanged in a specific order or a sequence where permitted, so that the embodiments of the present disclosure described here may be implemented in an order other than that illustrated or described here.

Before the embodiments of the present disclosure are further described in detail, nouns and terms involved in the embodiments of the present disclosure are described first. The nouns and the terms involved in the embodiments of the present disclosure are applicable to following interpretations:
Coding Block (CB);
Block Matching (BM);
Coding Unit (CU);
Block Vector (BV);
Motion Vector (MV);
Sum of Absolute Difference (SAD);
Sum of Absolute Transformed Difference (SATD);
Mean Square Error (MSE);
Sum of Squared Differences (SSD);
Mean Absolute Deviation (MAD);
Mean Square Differences (MSD);
Normalized Correlation Coefficient (NCC);
H.266/Versatile Video Coding (VVC);
reference software test platform for VVC (VVC Test Model, VTM);
Template Matching (TM);
Intra Template Matching Prediction (Intra TMP);
Intra block copy (IBC); and
reference software test platform for Beyond VVC (Enhanced Compression Model, ECM).

It may be understood that in a video picture, a first color component, a second color component, and a third color component are generally used to represent a coding block. These three color components are respectively a luma component, a blue chroma component and a red chroma component. In some implementation, the luma component is generally represented by the symbol Y, the blue chroma component is generally represented by the symbol Cb or U, and the red chroma component is generally represented by the symbol Cr or V. In this way, the video picture may be represented in an YCbCr format or in an YUV format.

A template matching (TM) prediction technology is a motion vector (MV) or block vector (BV) refinement technology. Both the encoder and the decoder search, within a predefined range near an initial MV/BV, for a matching template (T_BEST) with the minimum cost value relative to a template of a coding block according to a preset cost function via the template of the coding block. In an inter-frame technology, an offset of the best matching template relative to a template of a current coding block is a best motion vector (MV_BEST) and in an intra-frame technology, an offset of the best matching template relative to a template of a current coding block is a best block vector (BV_BEST). Then, a reconstructed block (Ref Block) pointed to by the best motion vector/block vector is used as a prediction block of the current coding block (Cur Block). That is, a reference block pointed to by the MV and the current coding block are in different pictures, and a reference block pointed to by the BV and the current coding block are in the same picture.

The MV belongs to an inter prediction coding technology, and the IBC belongs to an intra prediction coding technology, but details in the TM-based vector refinement technology of the MV and the IBC are very similar.

It may also be understood that Intra TMP is a special intra prediction mode. Both the encoder and the decoder search, within a predefined search range in a current picture, for the matching template (T_BEST) with a minimum cost value relative to a template (T) of a coding block according to a preset cost function via the template (T) of the coding block, where an offset of the best matching template relative to a template of the current coding block is a best block vector (BV_BEST), and then a reconstructed block (Ref Block) corresponding to the matching template is used as a prediction block of the current coding block (Cur Block). The template of the coding block is generally selected from a neighbouring reconstructed region of the current coding block. IntraTMP is very similar to the IBC, a difference is that an initial BV of the IntraTMP may be regarded as 0, and TM-based BV acquisition is its only source of the BV.

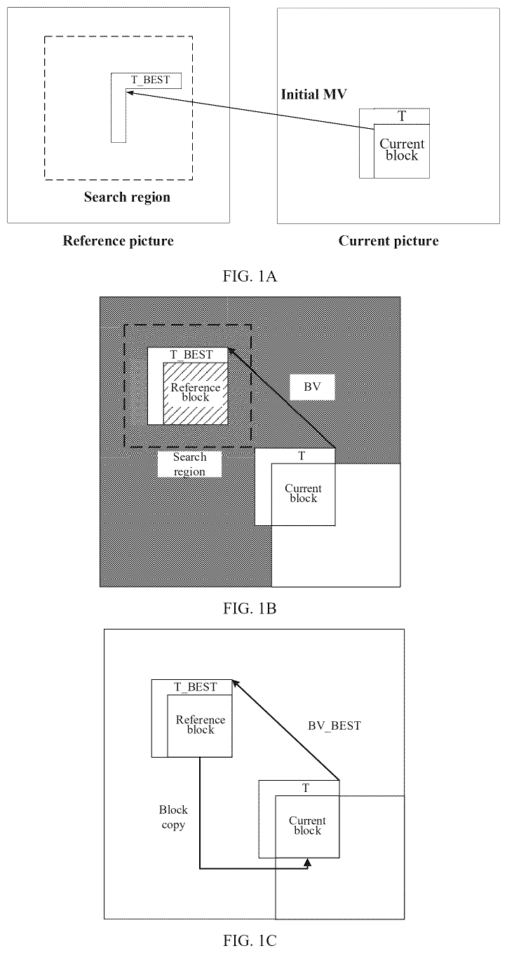

Exemplarily, taking the neighbouring reconstructed region of the current block as an example, in a case where a reference block and a current coding block are in different pictures, positions of the reference block and a matching block are as illustrated in FIG. 1A, a region filled with dark color within a reference picture represents a reconstructed region, a dashed box is a search region, a block filled with grids within the current picture is the current block, and a neighbouring region of the current block is a first template (T), the reference block is determined within the search region of the reference picture according to the MV, and a neighbouring region of the reference block is a second template (i.e., “reference template” or called “matching template”, T_BEST). In this case, block copy may be performed on the reference block, and the obtained block may be used as a prediction block of the current block. A refine search range for the TM-based MV includes a partial or entire reconstruction region within the reference picture.

In a case where the reference block and the current coding block are in the same picture, as illustrated in FIGS. 1B and 1C, a region filled with dark color represents the reconstructed region, a block filled with grids is the current block, and a neighbouring region of the current block is a first template (T); a block filled with oblique lines is the reference block, and a neighbouring region of the reference block is a second template (i.e., “reference template” or called “matching template”, T_BEST); where an offset of the second template relative to the first template is a best block vector (BV_BEST). In this case, block copy may be performed on the reference block, and the obtained block may be used as a prediction block of the current block. As illustrated in FIG. 1B, a refine search range for the TM-based BV in the IBC includes: search regions within multiple left and top coded and reconstructed coding tree blocks (CTBs). As illustrated in FIG. 1C, a search range for the TM-based BV in the IntraTMP includes: reconstructed regions on the left and top sides of the current block within a search window of a certain size.

In the embodiments of the present disclosure, the preset cost function may be the sum of absolute difference (SAD), the sum of absolute transformed difference (SATD), the mean square error (MSE), the sum of squared differences (SSD), the mean absolute deviation (MAD), the mean square differences (MSD), the normalized correlation coefficient (NCC), or the like, which is not limited here in detail.

For example, taking the SAD as examples, in this case, the cost function is as follows:

$$S A D ( {T}_{i} ) = {\sum }_{m = 0}^{M - 1} \vert {T}_{i , m} - {T}_{m} \vert , m = 0 , 1 , … , M - 1 \qquad ( 1 )$$

Here, Tᵢ represents a template in a search process, and M represents the number of samples in the template.

A prediction process in a template matching technology will be introduced in detail below.

Input of the TM: a position of the current block (xTbCmp, yTbCmp), a width of the current block nTbW, a height of the current block nTbH; positions of reconstructed samples and sample information of a reference region.

Output of the TM: a prediction value of the current block predSamples[x][y], where x=0 . . . nTbW-1 and y=0 . . . nTbH-1.

An exemplary prediction process of TM vector search technology is partitioned into five steps: determining an initial MV/BV, determining a current template type, obtaining reconstructed samples of the current template, refining an MV/BV within a predefined search range near an initial vector, and generating a prediction value. After the above process, the prediction value of the current block may be obtained. It should be noted that TM may be used to predict the luma component or the chroma component, which is not limited here in detail.

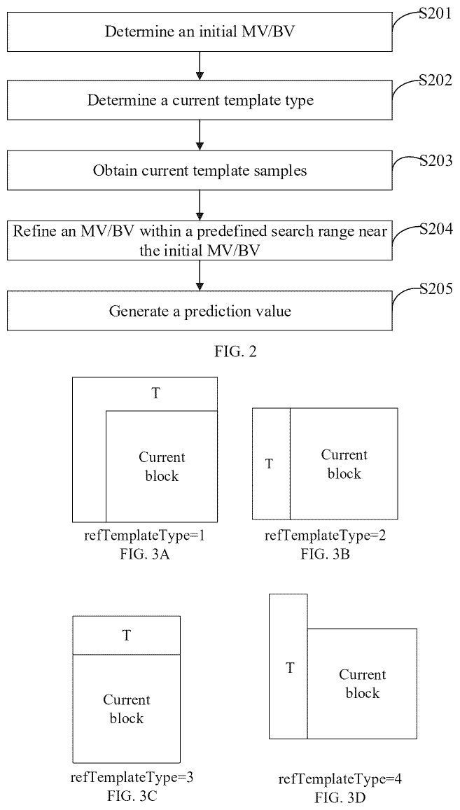

Referring to FIG. 2, a schematic diagram of a prediction process based on the TM technology is illustrated. As illustrated in FIG. 2, the process may include following steps.

In S201, an initial MV/BV is determined.

It should be noted that, in an MV technology, the initial MV may be an MV of inter Merge or an MV of inter advanced motion vector prediction (AMVP), where in an IBC technology, the initial BV may be a BV in a candidate list of IBC Merge or IBC AMVP, and in an IntraTMP technology, the initial BV may be regarded as 0 or non-existent.

In S202, a current template type is determined.

It should be noted that, in the TM technology, neighbouring reconstructed samples of the current block are used as a template to search for as a matching template within a predefined search region, where the neighbouring reconstructed samples may be top reference samples, top-left reference samples, top-right reference samples, left reference samples and bottom-left reference samples of the current block, and the like. Therefore, based on availability of the neighbouring reconstructed samples, the template type may be classified and the corresponding template type may be determined.

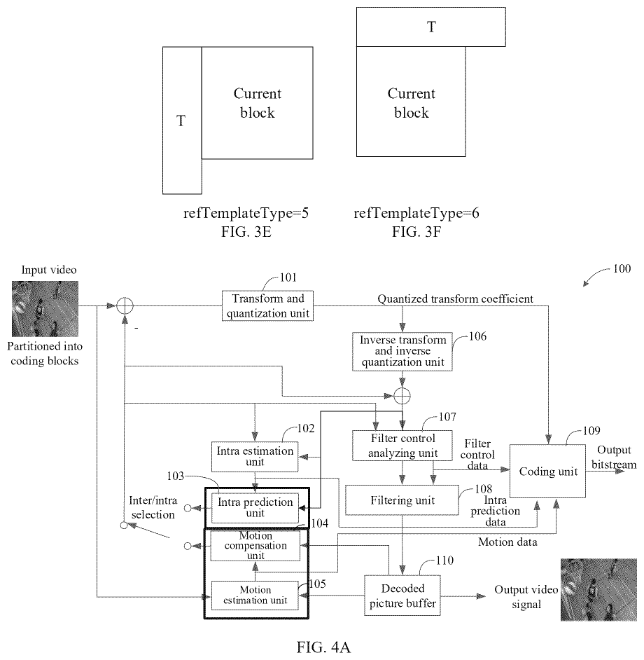

It should also be noted that refTemplateType may be used to represents the template type. FIG. 3A to FIG. 3F illustrate schematic diagrams of template types of the TM technology. As illustrated in FIG. 3A to FIG. 3F, a block filled with grids is the current block, and the neighbouring region of the current block is the template T, where six template types are illustrated.

Exemplarily, the six template types are as follows:
in a case where the top-left reference sample, the top reference sample, and the left reference sample are all available, a value of refTemplateType is 1, and a template shape is as illustrated in FIG. 3A;
in a case where only the left reference sample is available, a value of refTemplateType is 2, and a template shape is as illustrated in FIG. 3B;
in a case where only the top reference sample is available, a value of refTemplateType is 3, and a template shape is as illustrated in FIG. 3C;
in a case where only the left reference sample and the top-left reference sample are available, a value of refTemplateType is 4, and a template shape is as illustrated in FIG. 3D;
in a case where only the left reference sample and the bottom-left reference sample are available, a value of refTemplateType is 5, and a template shape is as illustrated in FIG. 3E;
in a case where only the top reference sample and the top-right reference sample are available, a value of refTemplateType is 6 and a template shape is as illustrated in FIG. 3F.

In S203, current template samples are obtained.

It should be noted that the template of the TM technology may be composed of reconstructed samples within one or more regions of the top side, the top-right side, the left side, the bottom-left side and the top-left side of the current block. In addition, the size of the template may be preset, or may be sent via a bitstream, or adaptively selected according to information such as a block size. For example, in a case where a left template is obtained, a template width templateW_size may be set to 4, and in a case where a top template is obtained, a template height templateH_size may be set to 4.

It should also be noted that the value of refTemplateType may be used to determine to obtain the reconstructed samples of which part. Exemplarily, in a case where the value of refTemplateType is 1, the reconstructed samples on the left side, the top-left side and the top side of the current block are obtained; alternatively, in a case where the value of refTemplateType is 2, only the reconstructed samples on the four columns on the left side of the current block are obtained; alternatively, in a case where the value of refTemplateType is 3, only the reconstructed samples on the four rows on the top side of the current block are obtained.

In S204, an MV/BV is refined within a predefined search range near the initial MV/BV, to determine a best MV/BV.

It should be noted that the refinement process of the MV/BV of the TM is mainly partitioned into an initialization process, determining the search region of the template, and performing a search to determine a best vector within the search region. It should also be noted that in a case where a best matching template is searched within the search region, a search strategy of performing coarse search at first and then performing fine search may be adopted, or only the fine search may be performed, or only the coarse search may be performed, which is not limited here in detail.

In the embodiments of the present disclosure, the coarse search here may be that: a best coarse matching template within the search region is determined with a first preset step (e.g., 2), or a best coarse matching template within the search region is determined by using a downsampling template (e.g., a downsampling factor is 2).

In the embodiments of the present disclosure, the fine search here may be that: a best fine matching template within the search region is determined with a second preset step (e.g., 1), or a best fine matching template near the best coarse matching template is determined after the coarse search is performed.

In the embodiments of the present disclosure, the coarse search is performed first and then the fine search is performed. In some implementation, the best coarse matching template is determined within the search region with the first preset step (e.g., 2), and then the best fine matching template is determined with the second preset step (e.g., 1) near the best coarse matching template.

In this way, after the above operations are completed, a best vector parameter MV_BEST/BV_BEST (pX_BEST, pY_BEST) may be obtained, where pX_BEST is an offset at a horizontal direction of the best matching template relative to the template of the current block and pY_BEST is an offset at a vertical direction of the best matching template relative to the template of the current block, and pX_BEST is also an offset at a horizontal direction of a best matching reconstructed block relative to the current block, and pX_BEST is also an offset at a vertical direction of the best matching reconstructed block relative to the current block.

In S205, a prediction value is generated.

Here, it may be implemented by using a simple translation and copy. The exemplary operations are:
for x=0 . . . nTbW-1, y=0 . . . nTbH-1;

$$predSamples [ x ] [ y ] = recSamples [ x + pX\_BEST ] [ y + pY\_BEST ] \qquad ( 2 )$$

Here, recSamples represents reconstructed samples of the current picture.

In simple terms, in related technology, the TM technology is searching, within a predefined search range within the current picture, for a matching template with a minimum cost value relative to a template of the current block according to a preset cost function via the template of the current block, and taking the best matching reconstructed block (Ref Block) corresponding to the matching template as the prediction block of the current block (Cur Block). The template of the current block may usually be selected from the neighbouring reconstructed region of the current block.

However, in an actual coding process, reconstructed samples of the best matching reconstructed block is directly as predicted samples of the current block in related technology, which is not a best solution in some cases. For example, in a case where there is a linear illumination change between the best matching reconstructed block and the current block, in response to that the reconstructed samples of the best matching reconstructed block are directly used as the predicted samples of the current block, there will be a large deviation, which causes low accuracy of prediction, and failure to achieve the best prediction effect.

Based on this, an encoding method is provided in the embodiments of the present disclosure, which includes: determining a first template of a current block, and determining a matching template and a reference block; determining a model parameter according to the first template and the matching template; filtering the reference block according to the model parameter, to determine a filtered reference block; determining a prediction value of the current block according to the filtered reference block; and determining a prediction residual value of the current block according to the prediction value of the current block.

A decoding method is further provided in the embodiments of the present disclosure, which includes: determining a first template of a current block, and determining a matching template and a reference block; determining a model parameter according to the first template and the matching template; filtering the reference block according to the model parameter, to determine a filtered reference block; determining a prediction value of the current block according to the filtered reference block; and determining a reconstructed value of the current block according to the prediction value of the current block.

In this way, whether it is an encoding end or a decoding end, the model parameter is determined according to the first template and the matching template, where the model parameter fully reflects a correlation between the matching template and the first template of the current block. The correlation is applied to the reference block, reconstructed samples of the reference block are filtered and corrected, and then the filtered reconstructed samples are used as predicted samples of the current block, to effectively correct the prediction value of the template matching technology, so as improve prediction accuracy, save bit rate, and further to improve efficiency of encoding and decoding at the same time, thereby improving performance of the encoding and decoding.

The embodiments of the present disclosure will be described in detail below in conjunction with the accompanying drawings.

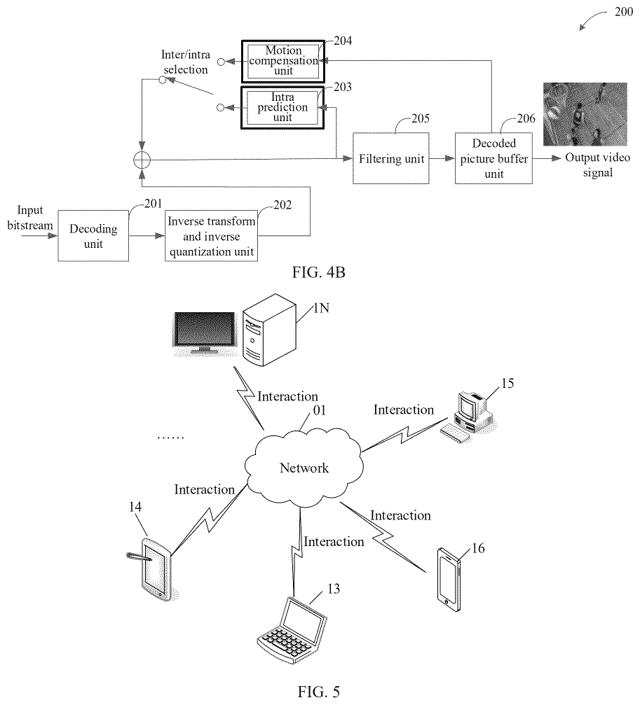

Referring to FIG. 4A, a schematic block diagram of composition of an encoder provided in embodiments of the present disclosure is illustrated. As illustrated in FIG. 4A, the encoder (in some implementation, a video encoder) 100 may include a transform and quantization unit 101, an intra estimation unit 102, an intra prediction unit 103, a motion compensation unit 104, a motion estimation unit 105, an inverse transform and inverse quantization unit 106, a filter control analysis unit 107, a filtering unit 108, an coding unit 109, and a decoded picture buffer unit 110, or the like, where the filtering unit 108 may implement deblocking filtering and sample adaptive offset (SAO) filtering, and the coding unit 109 may implement header information coding and context-based adaptive binary arithmetic coding (CABAC). For an input original video signal, a video coding block may be obtained by partitioning a coding tree unit (CTU), and then residual sample information obtained after performing intra prediction or inter prediction on the video coding block is transformed by the transform and quantization unit 101, which includes transforming the residual information from a sample domain to a transform domain, and quantizing the obtained transform coefficients to further reduce the bit rate. The intra estimation unit 102 and the intra prediction unit 103 are configured to perform intra prediction on the video coding block. Explicitly speaking, the intra estimation unit 102 and the intra prediction unit 103 are configured to determine an intra prediction mode to be used to encode the video coding block. The motion compensation unit 104 and the motion estimation unit 105 are configured to perform inter prediction coding of a received video coding block relative to one or more blocks in one or more reference pictures to provide time prediction information. The motion estimation performed by the motion estimation unit 105 is a process of generating a motion vector, and the motion vector may estimate the motion of the video coding block, and then the motion compensation unit 104 performs motion compensation based on the motion vector determined by the motion estimation unit 105. After determining the intra prediction mode, the intra prediction unit 103 is further configured to provide selected intra prediction data to the coding unit 109, and the motion estimation unit 105 further transmits the motion vector data determined by calculation to the coding unit 109. In addition, the inverse transform and inverse quantization unit 106 is configured to reconstruct the video coding block, which includes: reconstructing the residual block in the sample domain, and providing the reconstructed residual block to the filter control analysis unit 107 and the filtering unit 108 to remove a blocking effect artifact, and adding the reconstructed residual block to a predictive block in a picture in the decoded picture buffer unit 110, to generate a reconstructed video coding block. The coding unit 109 is configured to code various coding parameters and quantized transform coefficients. In the CABAC-based coding algorithm, context content may be based on neighbouring coding blocks and may be configured to encode information indicating the determined intra prediction mode to output a bitstream of the video signal. The decoded picture buffer unit 110 is configured to store the reconstructed video coding block for prediction reference. As video picture encoding progresses, new reconstructed video coding blocks are continuously generated, and these reconstructed video coding blocks are stored in the decoded picture buffer unit 110.

Referring to FIG. 4B, a schematic block diagram of a decoder provided in embodiments of the present disclosure is illustrated. As illustrated in FIG. 4B, a decoder (in some implementation, a video decoder) 200 includes a decoding unit 201, an inverse transform and inverse quantization unit 202, an intra prediction unit 203, a motion compensation unit 204, a filtering unit 205, and a decoded picture buffer unit 206, or the like, where the decoding unit 201 may implement header information decoding and CABAC decoding, and the filtering unit 205 may implement deblocking filtering and SAO filtering. After the input video signal is encoded in FIG. 4A, a bitstream of the video signal is output; the bitstream is input to the decoder 200, and is processed by the decoding unit 201 first to obtain decoded transform coefficients. The transform coefficients are processed by the inverse transform and inverse quantization unit 202, to generate residual blocks in the sample domain. The intra prediction unit 203 may be configured to generate prediction data for the current video decoding block based on the determined intra prediction mode and the data from a previously decoded block of the current frame or picture. The motion compensation unit 204 is configured to determine the prediction information for the video decoding block by analyzing the motion vector and other associated syntax elements, and generate a predictive block of the video decoding block that is being decoded by using the prediction information. The decoded video block is formed by summing the residual block from the inverse transform and inverse quantization unit 202 and the corresponding prediction block generated by the intra prediction unit 203 or the motion compensation unit 204. The decoded video signal is processed by the filtering unit 205 to remove the blocking effect artifacts, which may improve the quality of the video, and then the decoded video block is stored in the decoded picture buffer unit 206, which stores the reference picture used for subsequent intra prediction or motion compensation, and also used for output of the video signal. That is, the restored original video signal is obtained.

Furthermore, network architecture of an encoding and decoding system including an encoder and a decoder is further provided in the embodiments of the present disclosure, where FIG. 5 illustrates a schematic diagram of network architecture of an encoding and decoding system provided in the embodiments of the present disclosure. As illustrated in FIG. 5, the network architecture includes one or more electronic devices 13 to 1N and a communication network 01, where the electronic devices 13 to 1N may perform video interaction through the communication network 01. During the implementation process, the electronic device may be various types of devices with video encoding and decoding functions, for example, the electronic device may include a smart phone, a pad, a personal computer, a personal digital assistant, a navigator, a digital phone, a video phone, a television, a sensor device, a server, which is not limited here. In addition, the decoder or the encoder described in the embodiments of the present disclosure may be the above electronic device.

It should be noted that the method in the embodiments of the present disclosure is mainly applied to the intra prediction unit 103 part and the inter prediction part as illustrated in FIG. 4A, and the intra prediction unit 203 part and the motion compensation unit 204 as illustrated in FIG. 4B. That is to say, the embodiments of the present disclosure may be applied to the encoder, may also be applied to the decoder, and may even be applied to both the encoder and the decoder at the same time, which is not limited in the embodiments of the present disclosure.

It should also be noted that in a case where the embodiments of the present disclosure are applied to the encoding end, a term “current block” refers to a encoding block currently to be intra predicted; in a case where the embodiments of the present disclosure are applied to the decoding end, the term “current block” refers to a decoding block currently to be intra predicted.

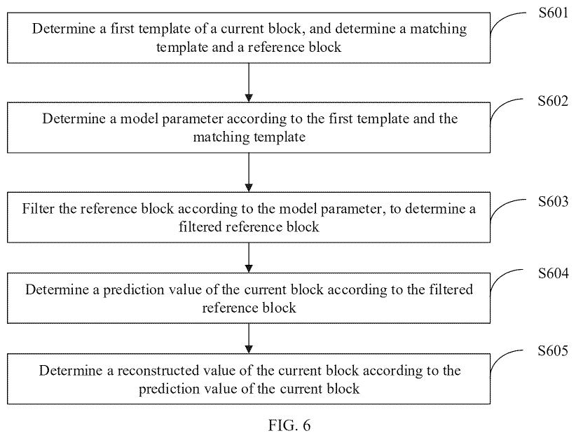

In an embodiment of the present disclosure, referring to FIG. 6, a schematic flowchart of a decoding method provided in the embodiments of the present disclosure is illustrated. As illustrated in FIG. 6, the method may include following steps.

In S601, a first template of a current block is determined, and a matching template and a reference block are determined.

It should be noted that the decoding method in the embodiments of the present disclosure is applied to the decoder. The decoding method may be called a prediction method of template matching based on a filter-based linear model (TM-FLM). In some embodiments, the decoding method may refer to an intra prediction method, in some implementation, an intra prediction method based on a technology of intra template matching prediction based on filter-based linear model (Intra TMP-FLM), or an intra prediction method based on an intra block copy based on filter-based linear model (IBC-FLM). A video picture may be partitioned into multiple decoding blocks, and the current block in the embodiments of the present disclosure refers to a decoding block that is currently to be intra predicted in the video picture, and the reference block is a reconstructed block within a current picture. In addition, the decoding method in the embodiments of the present disclosure may be used to predict both the luma component and the chroma component, which is not limited here in detail.

In some embodiments, the decoding method may also be an inter prediction method, and in some implementation, an inter prediction method of template matching based on a filter-based linear model. The video picture may be partitioned into decoding blocks, and the current block in the embodiments of the present disclosure refers to a decoding block that is currently to be inter predicted in the video picture, and the reference block is a reconstructed block within a reference picture.

It should also be noted that, in the embodiments of the present disclosure, the first template of the current block needs to be determined first, so that the matching template may be determined according to the first template. In some embodiments, determining the first template of the current block may include: determining a template type of the current block; and determining the first template of the current block according to the template type of the current block. In some embodiments, determining the first template of the current block may include: decoding a bitstream, to determine the first template of the current block.

Here, the template type may be represented by refTemplateType. In some embodiments, determining the template type of the current block may include one of: determining the template type of the current block according to reference samples of the current block; or decoding a bitsteam, to determine the template type of the current block; or determining the template type of the current block according to a size of the current block.

Here, the reference samples of the current block include at least one of: left neighbouring reference samples of the current block, top neighbouring reference samples of the current block, top-left neighbouring reference samples of the current block, bottom-left neighbouring reference samples of the current block, and top-right neighbouring reference samples of the current block.

That is to say, in the embodiments of the present disclosure, the reference samples of the current block are determined based on a neighbouring reconstructed region of the current block. The neighbouring reconstructed region of the current block includes at least one of: a left neighbouring region, a top neighbouring region, a top-left neighbouring region, a bottom-left neighbouring region, and a top-right neighbouring region. For example, the left neighbouring reference samples of the current block may be determined by at least one column of reconstructed samples in the left neighbouring region, the top neighbouring reference samples of the current block may be determined by at least one row of the reconstructed samples in the top neighbouring region, the bottom-left neighbouring reference samples of the current block may be determined by at least one column of the reconstructed samples in the bottom-left neighbouring region, and the like, which is not limited here.

Furthermore, according to whether the neighbouring reference samples are available, the template type may be classified and the template type of the current block may be determined. In some embodiments, determining the template type of the current block may include:
in response to that the left neighbouring reference samples of the current block, the top neighbouring reference samples of the current block, and the top-left neighbouring reference samples of the current block are all available, determining that the template type of the current block is a first value;
in response to that the left neighbouring reference samples of the current block are available, determining that the template type of the current block is a second value;
in response to that the top neighbouring reference samples of the current block are available, determining that the template type of the current block is a third value;
in response to that the left neighbouring reference samples of the current block and the top-left neighbouring reference samples of the current block are both available, determining that the template type of the current block is a fourth value;
in response to that the left neighbouring reference samples of the current block and the bottom-left neighbouring reference samples of the current block are both available, determining that the template type of the current block is a fifth value; or
in response to that the top neighbouring reference samples of the current block and the top-right neighbouring reference samples of the current block are both available, determining that the template type of the current block is a sixth value.

In the embodiments of the present disclosure, the first value, the second value, the third value, the fourth value, the fifth value and the sixth value may be different. Exemplarily, the first value may be set to 1, the second value may be set to 2, the third value may be set to 3, the fourth value may be set to 4, the fifth value may be set to 5, and the sixth value may be set to 6. In addition, for the six template types, refer to FIG. 3A to FIG. 3F for details.

In some embodiments, determining the first template of the current block according to the template type of the current block may include: obtaining template samples of the current block according to the template type of the current block and a corresponding size of the template; and determining the template samples of the current block as the first template of the current block.

In the embodiments of the present disclosure, the size of the template may be preset, or may be determined according to the size of the current block, or may even be related to the template type of the current block, which is not limited here in detail.

Exemplarily, in response to that the template type indicates that only the left template is obtained, the template width templateW_size may be set to 4; in response to that the template type indicates that only the top template is obtained, the template height templateH_size may be set to 4.

In addition, the reconstructed samples of which part that the first template obtains may be determined based on a value of the template type. For example, in a case where the value of refTemplateType is 1, the left reconstructed samples, the top-left reconstructed samples and the top reconstructed samples of the current block are obtained; in a case where the value of refTemplateType is 2, only the left 4 columns of reconstructed samples of the current block are obtained; and in a case where the value of refTemplateType is 3, only the top 4 rows of reconstructed samples of the current block are obtained.

For the matching template and the reference block, in a possible implementation, determining the matching template and the reference block may include: decoding a bitstream, to determine a vector parameter; determining the reference block according to the vector parameter; and determining the matching template according to the first template and the reference block.

That is to say, the reference block of the current block may be determined according to the vector parameter (e.g., an MV or a BV) obtained by decoding the bitstream, and the matching template may be determined from the reference block according to the first template of the current block.

For the matching template and the reference block, in another possible implementation, determining the matching template and the reference block may include: performing template matching within a search region according to the first template, to determine the matching template; and determining the reference block according to the matching template. In a possible implementation, determining the matching template may include: decoding a bitstream, to determine the matching template. In a possible implementation, determining the reference block may include: decoding a bitstream, to determine a reference template.

In some embodiments, performing template matching in the search region according to the first template, to determine the matching template may include: performing a search within the search region according to the first template, to determine a target vector parameter, and determining the matching template according to the target vector parameter.

In another possible implementation, determining the matching template may include: performing template matching within the search region according to the first template, to determine the matching template, including: determining an initial vector parameter of a current block; determining a search region according to the initial vector parameter; performing a search within the search region based on the template matching, to determine the target vector parameter; and determining the matching template according to the target vector parameter and the first template.

It should be noted that the vector parameter may be a motion vector including a horizontal component and a vertical component. In the MV technology, the initial MV may be the MV of the inter Merge or the inter AMVP. In the IBC technology, the initial BV may be the BV in a candidate list of the IBC Merge or IBC AMVP. In the IntraTMP technology, the initial BV may be regarded as 0 or non-existent.

In a possible implementation, determining the initial vector parameter of the current block includes: determining to construct a vector parameter candidate list of the current block according to a prediction mode parameter of the current block; and determining the initial vector parameter according to the vector parameter candidate list. The prediction mode parameter is used for indicating a relevant parameter of the prediction mode of the current block. In a possible implementation, determining the initial vector parameter according to the vector parameter candidate list includes: obtaining a vector parameter at a preset position (e.g., a first vector parameter) from the vector parameter candidate list as the initial vector parameter; or obtaining a vector parameter at a preset position from the vector parameter candidate list, decoding a bitstream to determine a prediction residual value of the vector parameter, and determining the initial vector parameter according to the vector parameter at the preset position and the prediction residual value of the vector parameter.

In a possible implementation, determining to construct the vector parameter candidate list of the current block according to the prediction mode parameter of the current block includes: determining to construct a merge vector parameter candidate list of the current block according to the prediction mode parameter of the current block; or determining to construct an AMVP vector parameter candidate list of the current block according to the prediction mode parameter of the current block.

In a possible implementation, the initial vector parameter of the current block is determined as a preset vector parameter according to the prediction mode parameter of the current block. In some embodiments, an initial block vector of the Intra TMP is 0. In yet another embodiment, an initial block vector parameter of the Intra TMP is a vector parameter obtained by performing a coarse search within the search region, and correspondingly, the target vector parameter is a vector parameter obtained by performing a fine search within the search region.

In a possible implementation, determining the search region according to the initial vector parameter includes: determining the search region according to the initial vector parameter and a preset search range. Exemplarily, the reference block is determined according to the initial vector parameter and the current block; and the search region is determined according to the reference block and the preset search range. The search region includes reconstructed samples.

It should be noted that the search range may be preset, or may be transmitted via a bitstream, or may be adaptively selected according to information such as a block size.

In a possible implementation, the determining method of the search range includes at least one of: using a preset horizontal component search range as a horizontal component search range of the preset search range; using a preset vertical component search range as a vertical component search range of the preset search range; decoding a bitstream, to determine a horizontal component search range of the preset search range and/or a vertical component search range of the preset search range; or determining, according to a size of the current block, a horizontal component search range of the preset search range and/or a vertical component search range of the preset search range.

In a possible implementation, determining the search region according to the initial vector parameter includes: in response to that an inter prediction mode is determined according to a prediction mode parameter of the current block, determining the search region within a reference picture according to the initial vector parameter; or in response to that an intra prediction mode is determined according to a prediction mode parameter of the current block, determining the search region within a current picture according to the initial vector parameter.

In a possible implementation, in response to that an intra prediction mode is determined according to a prediction mode parameter of the current block, the search region includes at least one of: a partial region of a reconstructed coding tree block of a current picture, an entire region of a reconstructed coding tree block of a current picture, an entire reconstructed region of a current coding tree block where the current block is located, or a partial reconstructed region of a current coding tree block where the current block is located.

In a possible implementation, performing the search within the search region based on the template matching, to determine the target vector parameter includes: performing the search within the search region, to determine reference templates, and calculating a respective matching cost value between each of the reference templates and the first template; and determining a vector parameter of a reference template corresponding to a minimum matching cost value as the target vector parameter. Exemplarily, available reference templates are determined by performing the search within the search region.

In a possible implementation, a determination condition for availability of the reference templates includes at least one of: a first sample within a template not exceeding a boundary of a picture where the first sample is located; a second sample within a reference block corresponding to a template not exceeding a boundary of a picture where the second sample is located; a first sample within a template not exceeding the search region; a second sample within a reference block corresponding to a template not exceeding the search region; a first sample within a template having been reconstructed; or a second sample within a reference block corresponding to a template having been reconstructed.

In a possible implementation, the determination condition for availability of the reference templates includes at least one of: a first sample within a template and the current block being within a same sub-picture; a second sample within a reference block corresponding to a template and the current block being within a same sub-picture; or a second sample within a reference block corresponding to a template not being within the current block. Exemplarily, the sub-picture may include a plurality of coding tree units. Exemplarily, the sub-picture may be a Tile.

In a possible implementation, the first sample is each sample within the template, or a first identification sample which is preset. The first identification sample includes a sample in at least one corner position within the template.

In a possible implementation, the second sample is each sample within the reference block corresponding to the template, or a second identification sample which is preset. The second identification sample includes a sample in at least one corner position within the reference block corresponding to the template. In some implementation, whether the sample is located within the preset picture may be determined by whether coordinates of the sample are within a valid coordinate range of a preset picture region.

It should be noted that the sample may be each of the samples within the template or within a reconstructed block corresponding to the template or a sample at a preset specific position. In some embodiments, the identification sample within the template refers to one or more samples located within a corner position of a template region. For example, in a case where there is only a top template, the identification sample refers to a sample at a top-left corner of the top template region and a sample at a bottom-right corner of the top template region; or the identification sample refers to only the sample at the bottom-right corner. The identification sample within the reconstructed block corresponding to the template refers to one or more samples located within a corner position of a reconstructed block region. For example, the identification sample refers to a sample at a top-left corner of the reconstructed block region and a sample at a bottom-right corner of the reconstructed block region; or the identification sample refers to only the sample at the bottom-right corner of the reconstructed block region.

That is to say, searching may be performed within a search region according to the first template, and a matching template with a minimum cost value relative to the first template is searched out according to a preset cost function. Here, one or more candidate vector parameters may be obtained by traversing all search points within the search region, where the one or more candidate vector parameters may indicate one or more candidate matching templates; cost calculation is respectively performed on each of the one or more candidate matching templates with the first template of the current block, and a search point with a minimum cost value is obtained through comparison, and a candidate vector parameter corresponding to the minimum cost value is a best vector parameter (i.e., the target vector parameter, BV_BEST); a candidate matching template corresponding to the minimum cost value is a best matching template (i.e., the matching template in the embodiment, T_BEST); and the reference block may be determined according to the best matching template. In the embodiments of the present disclosure, the target vector parameter may be understood as the best vector parameter or a matching vector parameter. Exemplarily, the vector parameter for the inter prediction mode may be the MV, and the vector parameter for the intra prediction mode may be the BV.

In embodiments of the present disclosure, the preset cost function may be the sum of absolute difference (SAD), the sum of absolute transformed difference (SATD), the mean square error (MSE), the sum of squared differences (SSD), the mean absolute deviation (MAD), the mean square differences (MSD), the normalized correlation coefficient (NCC), or the like, which is not limited here in detail.

It may be understood that the search process within the search region may be a coarse search, or a fine search, or a coarse search first and then a fine search; the details are as follows.

In a possible implementation, performing the search within the search region based on the template matching, to determine the target vector parameter may include: performing a first search within the search region, to determine the target vector parameter; or performing a second search within the search region, to determine the target vector parameter; where a search step corresponding to the first search is greater than a search step corresponding to the second search.

In another possible implementation, performing the searching within the search region based on the template matching, to determine the target vector parameter includes: performing a first search within the search region, to determine a first vector parameter, and determining an initial matching template according to the first vector parameter; determining a first search region according to the initial matching template, and performing a second search within the first search region, to determine the target vector parameter; where a search step corresponding to the first search is greater than a search step corresponding to the second search, and the first search region is smaller than the search region.

It should be noted that, in the embodiments of the present disclosure, the search step corresponding to the first search is greater than the search step corresponding to the second search. Exemplarily, the search step corresponding to the first search is 2, and the search step corresponding to the second search is 1. Alternatively, a downsampling factor corresponding to the first search is greater than a downsampling factor corresponding to the second search. Exemplarily, the downsampling factor corresponding to the first search is 4, and the downsampling factor corresponding to the second search is 2. That is to say, the first search is the coarse search, and the second search is the fine search, which is not limited in detail as long as it may reflect a feature that the first search is coarser than the second search.

It should also be noted that in a case where the first search is performed first and then the second search is performed, not only the search step corresponding to the first search is greater than the search step corresponding to the second search, but also the first search region is smaller than the search region. The first search region is a search region near the initial matching template. Exemplarily, a best coarse matching template may be first determined within the search region with a step of 2; and then a best fine matching template (i.e., a final matching template) may be determined near the best coarse matching template with a step of 1.

In yet another possible implementation, the search region includes at least one sub-search region; performing the search within the search region based on the template matching, to determine the target vector parameter includes: performing the search within each of the at least one sub-search region respectively, to determine a respective best vector parameter corresponding to each sub-search region and a respective matching cost value corresponding to each best vector parameter; determining a best vector parameter corresponding to a minimum matching cost value according to the respective best vector parameter corresponding to each sub-search region and the respective matching cost value corresponding to the best vector parameter; and using the best vector parameter corresponding to the minimum matching cost value as the target vector parameter.

In a possible implementation, performing the search within the search region based on the template matching, to determine the target vector parameter includes: performing the search within the search region based on the template matching, to determine the first vector parameter; decoding a bitstream, to determine the prediction residual value of the vector parameter; and determining the target vector parameter according to the first vector parameter and the prediction residual value of the vector parameter.

In a possible implementation, performing the search within the search region based on the template matching, to determine the target vector parameter includes: performing a first search within each of the at least one sub-search region respectively, to determine a respective best vector parameter corresponding to each sub-search region and a respective second search region corresponding to each best vector parameter; performing region determination according to the respective best vector parameter corresponding to each sub-search region and the respective second search region corresponding to each best vector parameter, to determine at least two target sub-search regions participating in a second search; performing the second search within the at least two target sub-search regions, to determine a best vector parameter corresponding to the at least two target sub-search regions; and using the best vector parameter corresponding to the at least two target sub-search regions as the target vector parameter.

It should be noted that, in some embodiments, for the search region of the BV, the search region of the template of the current block may be a reconstructed part of the CTB where the current block is located, or may be other reconstructed CTB regions. The search region here is actually a collection of all search points. Since a shape of the region is often not representable by a single rectangular region, in an exemplary implementation, a search may be performed within multiple rectangular regions, and then search results of different regions are taken into consideration, to obtain a final best reference block and a final best block vector.

In some embodiments, for the search process of the IBC technology, availability of the search point may be directly determined within the search region and then the matching cost value may be determined, and the vector parameter of the reference template corresponding to the minimum matching cost value is determined as the target vector parameter.

In some embodiments, for the search process of the MV technology, also valid search points within the search region are searched. The determination of whether the valid search points within the search region have been reconstructed or not will not be made, since all samples within the reference picture have been reconstructed.

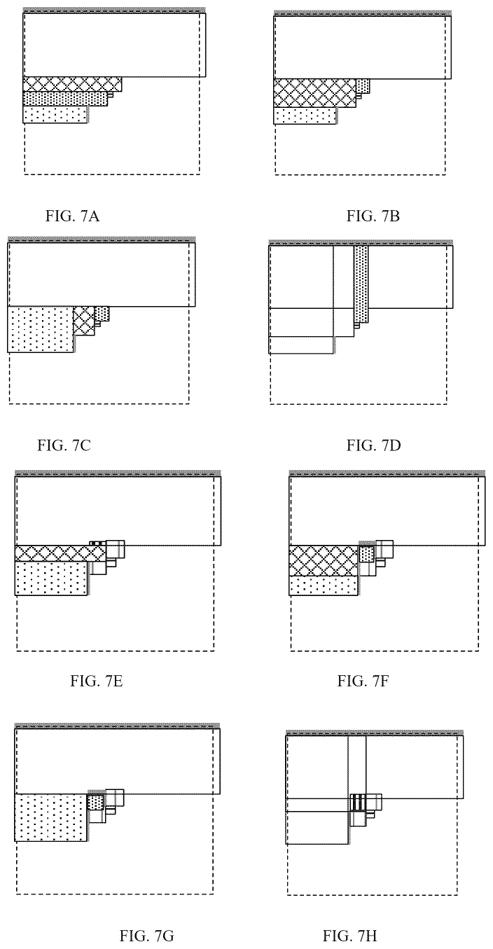

Referring to FIG. 7A to FIG. 7H, schematic diagrams of different partitioning of sub-regions of a search region provided in the embodiments of the present disclosure is illustrated. As illustrated in FIG. 7A to FIG. 7H, eight different partitioning manners of sub-regions are illustrated. The block of which the background is filled with horizontal line(s) is the current block; five partitioning manners of FIG. 7A, FIG. 7B, FIG. 7C, FIG. 7D and FIG. 7F all partition the search region into four sub-search regions, and three partitioning manners of FIG. 7E, FIG. 7G and FIG. 7H all partition the search region into three sub-search regions, where different filling patterns represent different sub-search regions. In FIG. 7A to FIG. 7H, all available search ranges are considered in FIG. 7A, FIG. 7B, FIG. 7C and FIG. 7D, and the directly top region and the directly left region are not searched in FIG. 7E, FIG. 7F, FIG. 7G, FIG. 7H.

It should also be noted that, taking FIG. 7F as an example, the search region is partitioned into four sub-search regions, each of the sub-search regions is represented by regionId, and a value of regionId may be equal to 0, 1, 2 and 3. Through a respective search point (iPosHor, iPox Ver) within each of the sub-search regions, that is, a respective block vector BV (consisting of a horizontal component and a vertical component: (pX, pY), where pX=iPosHor-xTbCmp, pY=iPos Ver-yTbCmp, then pX is between bvXMins and bvXMaxs, and pY is between bvYMins and bvYMaxs), a reference block matching the current block may be found within a reconstructed region, and neighbouring reconstructed samples of the reference block are the matching template. In this way, a matching cost value between the first template and the matching template of the current block may be calculated, and the matching cost value is recorded as pDiff.

In this way, all search points within all search ranges (regionId=0, 1, 2, 3) are traversed, and a search point with the minimum matching cost value pDiff is obtained through comparison. The matching cost value corresponding to this search point is recorded as pDiff_BEST, and a block vector corresponding to this search point is recorded as a best block vector BV_BEST (pX_BEST, pY_BEST), which is the target block vector of the embodiment; a best matching template T_BEST corresponding to this search point is the matching template finally required.

In a possible implementation, determining the reference block includes: determining the reference block according to the target vector parameter. Exemplarily, the reference block is determined according to the current block and the target vector parameter.

In yet another possible implementation, the method further includes: decoding a bitstream, to determine a value of first syntax element flag information; where the first syntax element flag information is used for indicating whether template matching is applied to the current block.

In yet another possible implementation, the method further includes: decoding a bitstream, to determine a value of third syntax element flag information; and determining the reference block of the current block according to the value of the third syntax element flag information.

In yet another possible implementation, the method further includes: the first syntax element flag information being used for indicating that the template matching is applied to the current block, decoding a bitstream, to determine a value of third syntax element flag information; and determining the reference block of the current block according to the value of the third syntax element flag information.

It should be noted that the encoding end transmits a Flag indicating which filtered reference block is used as a final prediction block. tmpFlag is used for indicating whether template matching is applied to the current coding block, and filterIdx is used for indicating a filtering model is applied to which reference block within the current search range. In a case where tmpFlag is 1, by comparing distortions between reference blocks which are applied with filter coefficients within the search range and the current original block, such as the SAD, the MSE, the SATD or sum of squared errors (SSE), the encoding end selects a best reference block and transmits an index corresponding to the best reference block to the decoding end.

In another possible implementation, the method further includes: traversing a search region to search for multiple reference templates, and determining a respective model parameter according to the first template and each of the multiple reference templates; filtering each of the multiple reference templates according to he respective model parameter, to obtain a respective filtered reference template; calculating a respective matching cost value between the respective filtered reference template and the first template; and determining a reference block of a reference template corresponding to a minimum matching cost value as the reference block of the current block. The reference block of the reference template may be understood as the reconstructed block of the reference template.

It should be noted that, for each of templates within the search range, the filter coefficients of the template are solved and the template is filtered, and Cost between the template and the current template is calculated, so as to decide which template is to be used. That is, the filter coefficients are calculated for part or all of the templates to be searched within the search range, and then the filter coefficients are applied to the template to be searched, and the Cost between the template to be searched and the current template is calculated. A best matching template after filtering is selected according to the Cost, and a reference block corresponding to the best matching template is filtered and used as a final prediction value.

In S602, a model parameter is determined according to the first template and the matching template.

It should be noted that, in the embodiments of the present disclosure, the model parameter may include coefficients of a target filter. In some embodiments, the method may further include: determining coefficients of the target filter according to sample reference values within the first template and sample reference values within the matching template.

It should also be noted that, in the embodiments of the present disclosure, the coefficients of the target filter may be determined by solving an optimization problem. Accordingly, in some embodiments, the method may further include: the coefficients of the target filter being coefficients used by the target filter when a first error between an output value of the sample reference value within the matching template after being processed by the target filter and the sample reference value within the first template meets a first condition.

It should be understood that for the first error meeting the first condition, in a possible implementation, the first condition is that the first error is minimum. Alternatively, in another possible implementation, the first condition is that the first error is within a first preset threshold range. Alternatively, in yet another possible implementation, the first condition is that a variation in the first error is within a second preset threshold range.

It should also be understood that the first preset threshold range and the second preset threshold range are both measurement criteria preset by the decoding end for determining whether the first error meets the first condition. In addition, the first error here may be the mean square error (MSE), the sum of squared errors (SSE), the sum of absolute difference (SAD), the sum of absolute transformed difference (SATD), mean absolute error (MAE), or the like, which is not limited in the embodiments of the present disclosure in detail.

In some embodiments, determining coefficients of the target filter according to the sample reference values within the first template and the sample reference values within the matching template may include:
determining autocorrelation parameters according to the sample reference values within the matching template;
determining cross-correlation parameters according to the sample reference values within the first template and the sample reference values within the matching template; and
determining the coefficients of the target filter according to the autocorrelation parameters and the cross-correlation parameters.

It should be noted that, in the embodiments of the present disclosure, each of the sample reference values includes at least one of: a sample reconstructed value, a sample gradient value, or sample position information.

That is to say, in the embodiments of the present disclosure, the target filter serves as a filter model in the embodiments of the present disclosure, and input information of the target filter is the sample reference values within the matching template. Here, the coefficients of the target filter may be represented by c_{k,l}, which may also be called filter coefficients in the embodiment. Here, the input information used for calculating the filter coefficients may be available reconstructed samples of the matching template; alternatively, the input information used for calculating the filter coefficients may be gradient of each of the reconstructed samples within the matching template, including but not limited to horizontal gradient, vertical gradient, or the like, and calculated gradient is used as the input information for calculating the filter coefficients; alternatively, the input information used for calculating the filter coefficients may be position information of each of the reconstructed samples as the input information for calculating the filter coefficients, where the position information may be absolute position information of each of the reconstructed samples within the entire picture, or relative position information of each of the reconstructed samples relative to a reference point, which is not limited here in detail.

In an exemplary implementation, a reconstruction region R used for calculating the filter coefficients is first determined, and then a set of filter coefficients may be derived by minimizing the MSE between the reconstructed samples within the region R and the reconstructed samples of the first template, that is:

$$M S E = E [ {( predTemp [ i ] [ j ] - [ i ] [ j ] )}^{2} ] = E [ {( {\sum }_{k , l = - 1 ∼ 1} {c}_{k , l} \cdot refTemp [ i + k ] [ j + l ] - recTemp [ i ] [ j ] )}^{2} ] \qquad ( 3 )$$

Here, refTemp[i][j] represents an input reconstructed sample value, recTemp[i][j] represents a reconstructed sample value of the template of the current block, (i, j) represents a coordinate position, (i, j) ∈R, k, l represent a coordinate offset of a position of a filter coefficient relative to a center position of the filter, where k and l are between −1 and 1, and values of (k, l) may include (0, 0), (0, −1), (−1, 0), (0, 1), (1, 0), c_{k,l} represents required filter coefficients. In addition, E represents an operation of calculating the mean, and a calculation formula in this case is as follows:

$$M S E = \frac{1}{{N}_{pos}} {\sum }_{i} {\sum }_{j} {\vert predTemp [ i ] [ j ] - recTemp [ i ] [ j ] \vert}^{2} \qquad ( 4 )$$

Here, Nₚₒₛ refers to the number of (i, j) pairs involved in calculating |predTemp[i][j]−recTemp[i][j]|². For example, in a case where there are 5 (i, j) pairs involved in the operation, a value of Nₚₒₛ is equal to 5.

Furthermore, the process of minimizing the MSE to derive the filter coefficients is as follows.

Firstly, the partial derivative of c_{k,l} is found and it is made to equal to 0, that is:

$$\frac{\partial M S E}{\partial {c}_{m}} = E [ 2 ( {\sum }_{k , l = - 1 ∼ 1} {c}_{k , l} [ i + k ] [ j + l ] - recTemp [ i ] [ j ] ) \cdot refTemp [ i + m ] [ j + n ] ] \qquad ( 5 )$$

$$E [ 2 ( {\sum }_{k , l = - 1 ∼ 1} {c}_{k , l} \cdot recTemp [ i + k ] [ j + l ] - recTemp [ i ] [ j ] ) \cdot refTemp [ i + m ] [ j + n ] ] = 0 \qquad ( 6 )$$

Here, k and l are between −1 and 1, and m and n are between −1 and 1.

Secondly, according to the formula (5) and the formula (6), following formula may sorted out:

$${\sum }_{k , l = - 1 ∼ 1} {c}_{k , l} \cdot E ( refTemp [ i + k ] [ j + l ] \cdot refTemp [ i + m ] [ j + n ] ) = E ( refTemp [ i ] [ j ] \cdot refTemp [ i + m ] [ j + n ] ) \qquad ( 7 )$$

Thirdly, after the reconstructed region R is determined, the obtained formula, i.e., the formula (7), is expanded into a matrix form, details are as follows:

$$A \times [ \begin{matrix}{c}_{0 , 0} \\ {c}_{- 1 , 0} \\ ⋮ \\ {c}_{0 , 1}\end{matrix} ] = B \qquad ( 8 )$$

Here, for A, a sample reference value within the matching template is represented by refTemp[i][j], and A represents an autocorrelation parameter of refTemp[i][j], details are as follows:

$$A = [ \begin{matrix}E ( refTemp [ i ] [ j ] \cdot refTemp [ i ] [ j ] ) & E ( refTemp [ i - 1 ] [ j ] \cdot refTemp [ i ] [ j ] ) & ⋯ & E ( refTemp [ i ] [ j + 1 ] \cdot refTemp [ i ] [ j ] ) \\ E ( refTemp [ i ] [ j ] \cdot refTemp [ i - 1 ] [ j ] ) & E ( refTemp [ i - 1 ] [ j ] \cdot refTemp [ i - 1 ] [ j ] ) & ⋯ & E ( refTemp [ i ] [ j + 1 ] \cdot refTemp [ i - 1 ] [ j ] ) \\ ⋮ & ⋮ & ⋱ & ⋮ \\ E ( refTemp [ i ] [ j ] \cdot refTemp [ i ] [ j + 1 ] ) & E ( refTemp [ i - 1 ] [ j ] \cdot refTemp [ i ] [ j + 1 ] ) & ⋯ & E ( refTemp [ i ] [ j + 1 ] \cdot refTemp [ i ] [ j + 1 ] )\end{matrix} ] \qquad ( 9 )$$

For B, a sample reference value within the first template is represented by recTemp[i][j], and B represents a cross-correlation parameter of recTemp[i][j] and refTemp[i][j], details as follows:

$$B = [ \begin{matrix}{\sum }_{i ∈ R} ( recTemp [ i ] [ j ] \cdot recTemp [ i ] [ j ] ) \\ {\sum }_{i ∈ R} ( recTemp [ i ] [ j ] \cdot recTemp [ i - 1 ] [ j ] ) \\ ⋮ \\ {\sum }_{i ∈ R} ( recTemp [ i ] [ j ] \cdot recTemp [ i ] [ j + 1 ] )\end{matrix} ] \qquad ( 10 )$$

That is to say, since the autocorrelation matrix of refTemp and the cross-correlation vector of refTemp and rec Temp within the reconstructed region R are known quantities, the filter coefficient c_{k,l} may be calculated by solving the formula group shown in the formula (7), and the filter coefficient c_{k,l} may be fixed-point or not.

In the embodiments of the present disclosure, for the target filter, the number of coefficients of the target filter and the shape of the target filter further need to be determined. The number of coefficients of the target filter and the shape of the target filter may be preset fixed values or directly determined by decoding a bitstream.

In some embodiments, for the shape of the target filter, the method may further include: decoding a bitstream, to determine the shape of the target filter.

In some embodiments, for the number of coefficients of the target filter, the method may further include: the number of coefficients of the target filter is equal to a first preset value.

In some embodiments, for the number of coefficients of the target filter, the method may further include: decoding a bitstream, to determine the number of coefficients of the target filter.

It should be noted that the number of coefficients of the target filter may be represented by nTap. Exemplarily, a value of nTap may be 4, 5, 6, 7, 8, 9, or the like, but which is not limited here in detail.

It should also be noted that the number of coefficients of the target filter may also be called the number of taps of the target filter. Here, the number of coefficients of the target filter may be a preset constant value, or may be determined by decoding a bitstream, or may even be determined according to syntax element flag information of the current block.

In some embodiments, for the shape of the target filter, the method may further include: the target filter being a one-dimensional or two-dimensional filter of a preset shape.

In some embodiments, for the shape of the target filter, the method may further include: decoding a bitstream, to determine the shape of the target filter.

In some embodiments, for the shape of the target filter, the method may further include: decoding a bitstream, to determine a value of a filter shape parameter, where the filter shape parameter indicates the shape of the target filter.

It should be noted that the filter shape parameter may be represented by FilterIdx, and FilterIdx is used for indicating the shape of the target filter. Exemplarily, the shape of the target filter may be a diamond, a rectangle, a cross, a stripe, even a one-dimensional filter, a two-dimensional filter, or the like, which is not limited here in detail.

Exemplarily, in a case where a value of FilterIdx is equal to 0, the shape of the target filter is determined to be the diamond; in a case where a value of FilterIdx is equal to 1, the shape of the target filter is determined to be the cross; in a case where a value of FilterIdx is equal to 2, the shape of the target filter is determined to be the rectangle.

It should also be noted that the shape of the target filter may be a preset shape, or may be determined by decoding a bitstream, or may even be determined according to the syntax element flag information of the current block.

In S603, the reference block is filtered according to the model parameter, to determine a filtered reference block.

In S604, a prediction value of the current block is determined according to the filtered reference block.

It should be noted that, in the embodiments of the present disclosure, after the model parameter is determined, the prediction value of the current block may be determined according to the model parameter and the reference block. In some implementation, the reference block is filtered according to the model parameter, and then the prediction value of the current block is determined according to the filtered reference block.

In some embodiments, filtering the reference block according to the model parameter, to determine the filtered reference block may include: filtering the reference block according to the model parameter, to determine a first output value of the target filter; and determining the filtered reference block according to the first output value of the target filter.

In the embodiments of the present disclosure, the first output value of the target filter may be calculated according to the sample reconstructed values of the reference block and the coefficients of the target filter in the model parameter; and then the filtered reference block may be determined according to the first output value of the target filter. The target filter here may be a filter-based linear model or a filter-based nonlinear model, which is not limited here in detail.

In a possible implementation, filtering the reference block according to the model parameter, to determine the filtered reference block may include: calculating a product of a sample reconstructed value of the reference block and a coefficient of the target filter corresponding to the sample reconstructed value; setting a first output value of the target filter to be equal to a sum of n products; where n represents the number of coefficients of the target filter and n is a positive integer; and determining the filtered reference block according to the first output value of the target filter.

In a possible implementation, calculating the respective product of each of sample reconstructed values of the reference block and the respective coefficient of the target filter corresponding to each sample reconstructed value may include: calculating a product of a sample reference value of a second boundary padding region corresponding to the reference block and a coefficient of the target filter corresponding to the sample reference value of the second boundary padding region; and/or calculating a product of a sample reference value of a reference template corresponding to the reference block and a coefficient of the target filter corresponding to the sample reference value of the reference template. For padding boundary samples, it is considered that the filter may use reconstructed samples outside the reference template and the reference block, so that the boundary samples need to be padded, where depending on the filter shape, regions that need to be padded at the boundary are different. Padded boundary samples may be applied to determination of the model parameter and/or prediction of the current block.

It should be noted that the target filter in the embodiments of the present disclosure is the filter-based linear model. The first output value of the target filter may be calculated by following formula:

$${Y}^{pred} [ i ] [ j ] = {\sum }_{k} {\sum }_{l} ref [ i + k ] [ j + 1 ] \times {C}_{k , l} \qquad ( 11 )$$

Here, ref[i+k][j+l] represents the sample reconstructed value of the reference block, and c_{k,l} represents the coefficient of the target filter.

In another possible implementation, filtering the reference block according to the model parameter, to determine the first output value of the target filter may include:
determining first values of the sample reconstructed values of the reference block under a first mapping relationship;
calculating a respective product of each of the first values and a respective coefficient of the target filter corresponding to each first value; and
setting the first output value of the target filter to be equal to a sum of n products; where n represents a number of coefficients of the target filter, and n is a positive integer.

It should be noted that the target filter in the embodiments of the present disclosure is the filter-based nonlinear model. Exemplarily, in a case where minimizing the MSE of the filter coefficients, the calculation formula in this case is adjusted as follows:

$$M S E = E [ {( predTemp [ i ] [ j ] - recTemp [ i ] [ j ] )}^{2} ] = E [ {( {\sum }_{k , l = - 1 ∼ 1} {c}_{k , l} \cdot {( refTemp [ i + k ] [ j + l ] )}^{2} - recTemp [ i ] [ j ] )}^{2} ] \qquad ( 12 )$$

Then the first output value of the target filter may be calculated by following formula:

$${Y}^{pred} [ i ] [ j ] = {\sum }_{k} {\sum }_{l} {( ref [ i + k ] [ j + l ] )}^{2} \times {C}_{k , l} \qquad ( 13 )$$

Here, ref[i+k][j+l] represents the sample reconstructed value of the reference block, and C_{k,l} represents the coefficient of the target filter.

It should also be noted that, in the embodiments of the present disclosure, the filtered reference block is determined according to the first output value of the target filter. The first output value of the target filter may be directly set as the filtered reference block; or a first filtering may be performed on the first output value of the target filter, to obtain the filtered reference block; the first filtering here may be a low-pass filtering, an upsampling filtering/downsampling filtering, or the like, which is not limited here in detail.

It should also be noted that, in the embodiments of the present disclosure, after the first output value of the target filter is determined, a first offset value (expressed as bias) may be added to the first output value, to determine the filtered reference block.

In some embodiments, determining the filtered reference block according to the first output value of the target filter may include: determining a first offset value; and performing an addition operation according to the first output value and the first offset value, to determine the filtered reference block.

In a possible implementation, determining the first offset value may include: setting the first offset value to be equal to a second preset value.

In another possible implementation, determining the first offset value may include: in response to that the number of coefficients of the target filter is n, determining an (n+1)th coefficient of the target filter; and determining the first offset value according to the (n+1)th coefficient and a second offset value.

In the embodiments of the present disclosure, for the second offset value, the method may further include: setting the second offset value equal to a third preset value; or setting the second offset value equal to a value of a sample reconstructed value of the reference block under a second mapping relationship.

It should be noted that, in the embodiments of the present disclosure, the number of the calculated filter coefficients are used as the number of taps corresponding to the filter template, that is, the number of filter coefficients is equal to the number of taps nTap of the filter template. In addition, several bias terms (bias) may be added to the filter template. Exemplarily, in the embodiments of the present disclosure, in a case where nTap=5, the filter coefficients are the tap coefficients c₀ to c₄ corresponding to the filter template, and a prediction value of a position (i, j) in the filtered reference block is calculated as follows:

$${Y}^{pred} [ i ] [ j ] = {\sum }_{n = 0}^{4} ref [ k ] [ l ] \times {C}_{n} \qquad ( 14 )$$

In this case, the bias term may be added, as shown in following formula:

$${Y}^{pred} [ i ] [ j ] = {\sum }_{n = 0}^{4} ref [ k ] [ l ] \times {C}_{n} + {C}_{5} \times Constant \qquad ( 15 )$$

In the embodiments of the present disclosure, cₙ=c_{i,j,k,l}. Here, Constant may be a fixed constant, such as Constant=1<<(BitDepth-1), or a number related to the reconstructed sample value at the position (i, j) within the reference block, such as Constant=f (ref[i][j]), or a number related to a reconstructed sample value corresponding to a tap within the filter template other than the position (i, j), such as Constant=f (ref[k][l]). Here, Constant=f (ref[i][j]) or Constant=f (ref[k][l]) may be a linear mapping relationship or a nonlinear mapping relationship. One or more bias items may be added, which is not limited here in detail.

Furthermore, in some embodiments, determining the prediction value of the current block according to the filtered reference block may include: performing a first process on the filtered reference block, to obtain the prediction value of the current block.

In the embodiments of the present disclosure, for the first process, the first process may be to set the prediction value of the current block to be equal to the filtered reference block; alternatively, the first process may be a clip operation that limits the filtered reference block to a preset value range, alternatively, the first process may be other operations, which are not limited here in detail.

Here, for the clip operation, the preset value range may be between 0 and (1<<BitDepth)-1, where BitDepth represents bit depth. In response to that the value of the filtered reference block exceeds the preset value range, a corresponding correction operation needs to be performed on the filtered reference block. Exemplarily, the filtered reference block may also be represented by Y^{pred}[i][j], and in this case, a correction operation may be performed on Y^{pred}[i][j], details are as follows:
in a case where the value of Y^{pred}[i][j] is less than 0, setting the value to 0;
in a case where the value of Y^{pred}[i][j] is greater than or equal to 0 and less than or equal to (1<<BitDepth)-1, setting the value equal to Y^{pred}[i][j];
in a case where the value of Y^{pred}[i][j] is greater than (1<<BitDepth)-1, setting the value to (1<<BitDepth)-1.

In this way, after the correction operation is performed on Y^{pred}[i][j], it may be ensured that all sample values in the filtered reference block are between 0 and (1<<BitDepth)-1.

Furthermore, the number of filter models may be expanded. In addition to establishing only one filter model, multiple filter models may also be established. Therefore, in some embodiments, the method may further include:
determining multiple groups of model parameters according to the first template and the matching template;
constructing multiple filter models according to multiple groups of model parameters, filtering the reference blocks according to the multiple filter models respectively, and determining multiple filtered reference blocks; and
determining the prediction value of the current block according to the multiple filtered reference blocks.

In some embodiments, determining the multiple groups of model parameters according to the first template and the matching template may include: classifying the reconstructed samples within the first template and the reconstructed samples within the matching template in a preset manner, to obtain multiple groups of sub-templates and multiple groups of sub-matching templates; determining multiple groups of model parameters according to the multiple groups of sub-templates and the multiple groups of sub-matching templates.

It should be noted that in the embodiments of the present disclosure, the preset manner here may be a size of a reconstructed sample value, or may be position information of a reconstructed sample, or may be a filter shape, or the like, which is not limited here. After performing classifying according to a preset manner, each group of the sub-templates and respective sub-matching templates corresponding to each group of the sub-templates may be used to calculate a respective group of model parameters, and each group of the model parameters may be used to determine a filter model, so that multiple filter models may be constructed.

In a possible implementation, the method may further include: decoding a bitstream, to determine an index value of a target model; determining a target filter corresponding to the index value of the target model from multiple filter models according to the index value of the target model; filtering the reference block according to the target filter, to determine the prediction value of the current block.

In another possible implementation, the reference block is filtered according to multiple filter models respectively, and the multiple filtered reference blocks may be determined. In some embodiments, determining the prediction value of the current block according to multiple filtered reference blocks may include: performing weighting calculation on the multiple filtered reference blocks, to determine the prediction value of the current block.

It should also be noted that in a case where a respective weighting factor of each filtered reference block is equal and equal to a reciprocal of the number of reference blocks; the weighting calculation here may also be regarded as an average calculation. In other words, an average value of multiple filtered reference blocks is calculated, to determine the prediction value of the current block.

Exemplarily, multiple pieces of input information for calculating the filter coefficients are classified, and a respective filter model is established for each type of input information. For example, in a case where a filter model is established by using reconstruction information, a possible implementation is to classify by a mean of the reconstruction information, a filter model is established for reconstruction information greater than the mean, and a filter model is established for reconstruction information less than the mean. Another possible implementation is to classify by using a position of the reconstruction information. For example, a filter model may be established by using the available reconstruction information on the left side and the top side, and a second model may be established by using the available reconstruction information on the left side and the top-left side, and so on. The encoding end decides which model to use. One possible decision-making manner is that the encoding end decides which model to use through rate-distortion optimization and transmits the corresponding decoding parameters to the decoding end, so that the decoding end may be clear about which filter model to select. Another possible implementation is to classify filters by their shapes. Multiple filters of different shapes may be used, and a filter model is established for filter of each shape. The encoding end decides a filter of which shape to use. One possible decision-making manner is that the encoding end decides which filter to use by rate-distortion optimization and transmits the corresponding decoding parameter to the decoding end, so that the decoding end may be clear about which filter model to select.

In S605, a reconstructed value of the current block is determined according to the prediction value of the current block.

It should be noted that in the embodiments of the present disclosure, after the prediction value of the current block is determined, the reconstructed value of the current block may further be restored. In some embodiments, determining the reconstructed value of the current block according to the prediction value of the current block may include: decoding a bitstream, to determine a prediction residual value (residual) of the current block; determining the reconstructed value of the current block according to the prediction value of the current block and the prediction residual value of the current block.

In an exemplary implementation, determining the reconstructed value of the current block according to the prediction value of the current block and the prediction residual value of the current block may include: performing an add operation on the prediction value of the current block and the prediction residual value of the current block, to determine the reconstructed value of the current block.

It should also be noted that, in the embodiments of the present disclosure, whether intra template matching is applied to the current block or whether the filter model is used to the current block may be determined by different syntax element flag information. In some embodiments, the method may further include: decoding a bitstream, and determining a value of first syntax element flag information; the first syntax element flag information is used for indicating whether template matching is applied to the current block. It should be noted that in some embodiments, whether the template matching is applied may be understood as whether searching is performed within the search region based on the template matching, to determine a best vector parameter, that is, the first syntax element flag information is used for indicating whether searching is performed within the search region for the current block based on template matching, to determine the best vector parameter.

In an exemplary implementation, the method further includes: decoding the bitstream, to determine a value of second syntax element flag information; in response to that the second syntax element flag information is used for indicating that a filter model is applied to the current block, filtering the reference block according to the model parameters, to determine the filtered reference block; and determining the prediction value of the current block according to the filtered reference block.

Furthermore, in some embodiments, the method may further include: in response to that the second syntax element flag information is used for indicating that the filter model is not applied to the current block, using the reconstructed sample value within the reference block as the prediction value of the current block.

In an exemplary implementation, the method further includes: the first syntax element flag information being used for indicating whether the template matching is applied to the current block, decoding a bitstream, to determining the value of the second syntax element flag information.

In the embodiments of the present disclosure, for the first syntax element flag information, in response to that the value of the first syntax element flag information is a first value, it is determined that the first syntax element flag information is used for indicating that intra template matching is applied to the current block; alternatively, in response to that the value of the first syntax element flag information is a second value, it is determined that the first syntax element flag information is used for indicating that intra template matching is not applied to the current block.

In the embodiments of the present disclosure, for the second syntax element flag information, in response to that the value of the second syntax element flag information is a first value, it is determined that the second syntax element flag information is used for indicating that the filter model is applied to the current block; alternatively, in response to that the value of the second syntax element flag information is a second value, it is determined that the second syntax element flag information is used for indicating that the filter model is not applied to the current block.

It should be noted that, in the embodiments of the present disclosure, the first value is different from the second value, and the first value and the second value may be in form of parameter or in form of digital. In some implementation, the first syntax element flag information or the second syntax element flag information may be a parameter written into the profile, or may be a value of a flag, which is not limited here in detail.

Exemplarily, for the first value and the second value, the first value may be set to 1, and the second value may be set to 0; alternatively, the first value may be set to true, and the second value may be set to false; which is not limited here in detail.

It should also be noted that in the embodiments of the present disclosure, whether the current block uses the filtered reference block as the final prediction value is determined by certain conditions, but it is not limited to following three manners. Exemplarily, the three manners may be as follows.

Manner 1: whether to filter the matching template is determined by comparing a distortion of the matching template and the template of the current block, such as the SAD, the MSE, the SATD or the SSE, with a threshold T_Distortion1.

Manner 2: on the basis that Manner 1 meets using the filter model, whether to filter the reference block is determined by using a distortion between the filtered matching template and the template of the current block, such as the SAD, the MSE, the SATD or the SSE, and a threshold T_Distortion2.

Manner 3: the encoding end transmits a Flag to indicate whether to apply the filter model. The tmpFlag indicates whether intra template matching is applied to the current block, and filterFlag indicates whether the filter model is applied to the current block. In a case where tmpFlag is 1, the encoding end determines whether to filter the reference block by comparing distortions between the reference block and the current block before and after filtering, such as the SAD, the MSE, the SATD or the SSE. In response to that the distortion after filtering is less than the distortion before filtering, filterFlag is 1, and the filtered reference block is used as the prediction block for the current block; otherwise, filterFlag is 0, and the reference block before filtering is used as the prediction block for the current block. The encoding end transmits filterFlag to the decoding end.

It should be noted that, the filter coefficients are calculated for the best matching template after searching, the filter coefficients are applied to the best matching reference block, the filter coefficients may further be applied to all or part of the reference blocks within the search region, and which filtered reference block is used as the final prediction block is determined by using certain conditions, such as following manners.

Manner 1: the filter coefficients for the templates within the search range are solved, the templates are filtered, and Costs between the templates within the search range and the current template are calculated to determine which template is used. That is, the filter coefficients for part or all of the templates to be searched within the search range are calculated, and then the filter coefficients are applied to the templates to be searched, Costs between the templates to be searched and the current template are calculated, a best matching template after filtering is selected according to the Costs, the reference block corresponding to the best matching template is filtered and as the final prediction value.

Manner 2: the encoding end transmits a Flag to indicate which filtered reference block is used as the final prediction block. The tmpFlag indicates whether template matching is applied to the current coding block, and filterIdx indicates the filtering model applied to which reference block within the current search range. In a case where tmpFlag is 1, the encoding end selects a best reference block and transmits an index corresponding to the best reference block, to the decoding end by comparing distortions between the reference blocks to which filter coefficients are applied within the search range and the current original block, such as the SAD, the MSE, the SATD or the SSE.

This embodiment provides a decoding method, which includes: determining a first template of a current block, and determining a matching template and a reference block; determining a model parameter according to the first template and the matching template; filtering the reference block according to the model parameter, to determine a filtered reference block; determining a prediction value of the current block according to the filtered reference block; and determining a reconstructed value of the current block according to the prediction value of the current block. In this way, the model parameter is determined according to the first template and the matching template, where the model parameter fully reflects a correlation between the matching template and the first template of the current block. The correlation is applied to the reference block, reconstructed samples of the reference block are filtered and corrected, and then the filtered reconstructed samples are used as predicted samples of the current block, which improves prediction accuracy and save bit rate, further improves efficiency of encoding and decoding at the same time, thereby improving performance of the encoding and decoding.

In another embodiment of the present disclosure, based on the decoding method of the above embodiment, in the prediction process of the template matching technology, it is proposed to correct the best matching reconstructed block (i.e., the reference block) and use the corrected reconstructed samples as the predicted samples of the current block. In some implementation, a filter-based linear model is established by using samples of the matching template and the template of the current block, and the filter-based linear model is applied to the reference block, and the filtered samples are used as the final predicted samples. The technical solution of the embodiments of the present disclosure may be called a template matching prediction method based on filter-based linear model (TM-FLM), which is used for intra prediction and inter prediction. In some implementation, the method may be an intra prediction method based on an intra template matching prediction based on filter-based linear model (Intra TMP-FLM), an intra prediction method based on an intra block copy based on filter-based linear model (IBC-FLM), or a template matching technique based on filter-based linear model.

The prediction process of the TM-FLM technology will be introduced in detail below.

Input of the TM-FLM: a position of the current block (xTbCmp, yTbCmp), a width of the current block nTbW, a height of the current block nTbH; a reconstructed sample position and sample information of the reference region.

Output of the TM-FLM: a prediction value of the current block predSamples[x][y], where x=0 . . . nTbW-1 and y=0 . . . nTbH-1.

In some implementation, the prediction process of the TM-FLM technology may be partitioned into six steps: determining an initial MV/BV, determining a current template type, obtaining reconstructed samples of the current template, refining an MV/BV within a predefined search range near the initial vector, establishing a filter-based linear model and generating a prediction value, as illustrated in FIG. 3A to FIG. 3F. Through the above process, the prediction value of the current prediction block may be obtained. The TM may be used to predict a luma component or a chroma component, which is not limited here in detail.

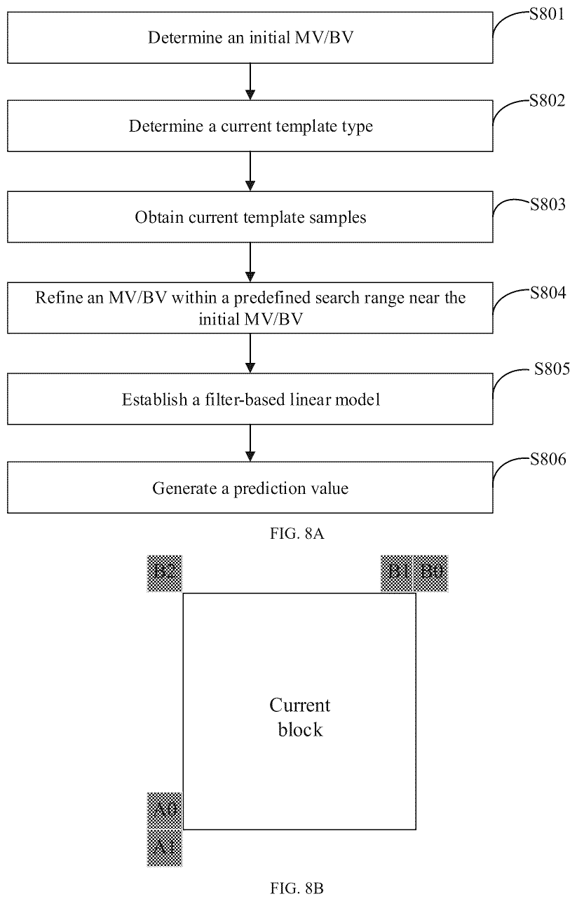

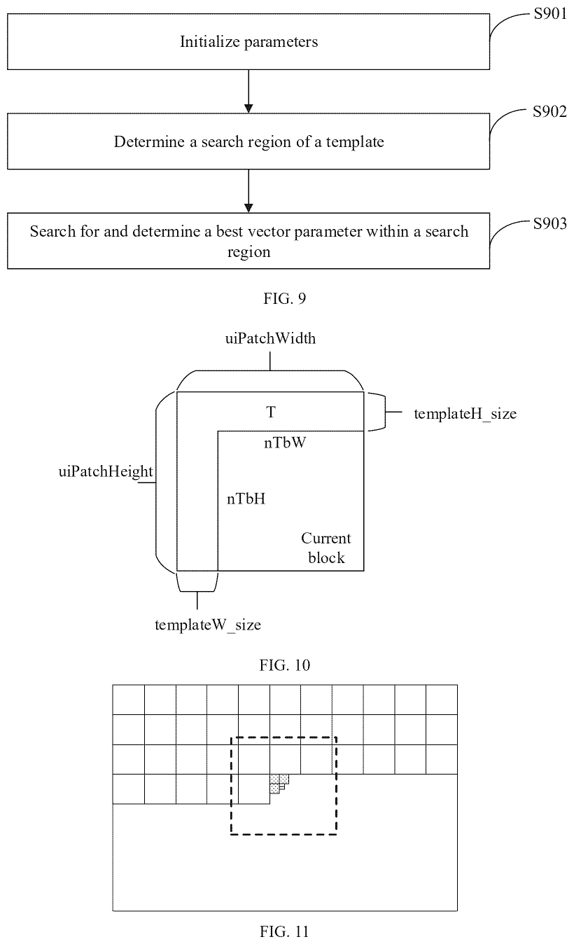

Referring to FIG. 8A, a schematic diagram of a prediction process based on the TM-FLM technology provided in the embodiments of the present disclosure is illustrated. As illustrated in FIG. 8A, the process may include following steps.

In S801, an initial MV/BV is determined.

The initial MV may be an MV of inter Merge or an MV of inter AMVP, and the initial BV may be a BV in a candidate list of IBC Merge or IBC AMVP. In the IntraTMP technology, the initial BV may be regarded as 0 or non-existent.

It should be noted that the decoding end may determine whether to construct a Merge candidate list or an AMVP candidate list according to a prediction mode indicated by a prediction mode parameter.

The candidate lists (MV candidate lists) of inter Merge and inter AMVP of the MV are determined by spatially neighbouring coding units (as illustrated in FIG. 8B), temporally neighbouring coding units, or the like. For each MV in the candidate lists, a template matching method may be used to perform a refined search.

The candidate lists of IBC intra Merge and intra AMVP of BV are constructed by the spatially neighbouring coding units (as illustrated in FIG. 8B), historical information, or the like. For each BV in the candidate lists, a template matching method may also be used to perform a refined search.

The embodiment takes a first MV/BV in the Merge candidate list as the initial MV/BV as an example, and the horizontal initial MV mvXInit (/BV bvXInit) and the vertical initial MV mvYInit (/BV bvYInit) are initialized by using the first MV/BV in the Merge candidate list.

In S802, a current template type is determined.

It should be noted that the TM-FLM technology uses neighbouring reconstructed samples of the current block as a matching template searched within a predefined search region via the template, where the neighbouring reconstructed samples may be top reference samples, top-left reference samples, top-right reference samples, left reference samples and bottom-left reference samples of the current block, and the like. Therefore, based on availability of the neighbouring reconstructed samples, the template type may be classified and the corresponding template type may be determined.

It should also be noted that refTemplateType may be used to represent the template type. As illustrated in FIG. 3A to FIG. 3F, a block filled with grids is the current block, and the neighbouring region of the current block is the template T, where six template types are illustrated.

Exemplarily, the six template types are as follows:
in a case where the top-left reference sample, the top reference sample, and the left reference sample are all available, a value of refTemplateType is 1, and a template shape is as illustrated in FIG. 3A;
in a case where only the left reference sample is available, a value of refTemplateType is 2, and a template shape is illustrated in FIG. 3B;
in a case where only the top reference sample is available, a value of refTemplateType is 3, and a template shape is illustrated in FIG. 3C;
in a case where only the left reference sample and the top-left reference sample are available, a value of refTemplateType is 4, and a template shape is illustrated in FIG. 3D;
in a case where only the left reference sample and the bottom-left reference sample are available, a value of refTemplateType is 5, and a template shape is illustrated in FIG. 3E;
in a case where only the top reference sample and the top-right reference sample are available, a value of refTemplateType is 6 and a template shape is illustrated in FIG. 3F.

In S803, current template samples are obtained.

It should be noted that the template of the TM-FLM technology may be composed of reconstructed samples in one or more regions of the top side, the top-right side, the left side, the bottom-left side and the top-left side of the current block. In addition, the size of the template may be preset. For example, in a case where a left template is obtained, the template width templateW_size may be set to 4, and in a case where a top template is obtained, the template height templateH_size may be set to 4.

It should also be noted that the value of refTemplateType may be used to determine the reconstructed samples of which part to obtain. Exemplarily, in a case where the value of refTemplateType is 1, the reconstructed samples on the left side, the top-left side and the top side of the current block are obtained; alternatively, in a case where the value of refTemplateType is 2, only the reconstructed samples on the left four columns of the current block are obtained; alternatively, in a case where the value of refTemplateType is 3, only the reconstructed samples on the top four rows of the current block are obtained.

In S804, an MV/BV within a predefined search range near the initial MV/BV is refined, to determine a target MV/BV.

It should be noted that the search process of the TM-FLM technology is mainly partitioned into an initialization process, determining the search region of the template, and performing a search to determine a best block vector within the search region. The search region of the template is within the current picture for intra prediction and within the reference picture for inter prediction.

It should also be noted that in a case where a best matching template is searched within the search region, a search strategy of first coarse search and then fine search may be adopted, or only fine search may be performed, or only coarse search may be performed, which is not limited here in detail.

In the embodiments of the present disclosure, the coarse search here may be that: a best coarse matching template within the search region with a first preset step (e.g., 2) is determined, or a best coarse matching template within the search region is determined by using a downsampling template (e.g., a downsampling factor is 2).

In the embodiments of the present disclosure, the fine search here may be that: a best fine matching template within the search region with a second preset step (e.g., 1) is determined, or a best fine matching template near the best coarse matching template is determined after the coarse search is performed.

Referring to FIG. 9, a schematic diagram of a search process based on the TM technology provided in the embodiments of the present disclosure is illustrated. As illustrated in FIG. 9, the process may include following steps.

In S901, parameters are initialized.

It should be noted that uiPatch Width is initialized to nTbW+templateW_size, and uiPatchHeight is initialized to nTbH+templateH_size. Here, templateW_size and templateH_size may be fixed constants, or may be dynamically adjusted according to the size of the current block; in addition, templateW_size and templateH_size may be equal or unequal. For example, templateW_size=4, templateH_size=4; alternatively, in a case where the width of the current block is greater than 8, templateW_size=4 is set; in a case where the width of the current block is less than or equal to 8, templateW_size=2 is set; in a case where the height of the current block is greater than 8, templateH_size=4 is set; in a case where the height of the current block is less than or equal to 8, templateH_size=2 is set.

Exemplarily, FIG. 10 illustrates a schematic diagram of parameter definition of a current block and a template of the current block provided in the embodiments of the present disclosure. As illustrated in FIG. 10, specific meanings of the parameters are as follows: nTbW and nTbH represent the size of the current block, templateW_size and templateH_size represent the size of the template, and uiPatch Width and uiPatchHeight represent the size of a block including the current block and the template of the current block.

Furthermore, a cost threshold between the initialization templates is represented by diffThreshold. For example, in a case where a cost function is SAD, the threshold may be: diffThreshold=((1<<bitDepth)>>2)×(uiPatchHeight×uiPatchWidth−nTbH×nTbW). In a case where the picture bit depth bitDepth is 10, diffThreshold indicates that the maximum distortion of each sample within the template region is 256.

Furthermore, a position of the coding tree block CTB where the current block CB is located is initialized: ctbRsX, ctbRsY.

Furthermore, a position offset of the current block CB in the current CTB is initialized: offsetLCBY=yTbCmp−ctbRsY, offsetLCBX=xTbCmp−ctbRsX.

Furthermore, iTemplateSizeH=templateH_size, iTemplateSizeW=templateW_size are initialized.

Furthermore, precision of the vector parameters is initialized. For example, iMvShift is initialized, where iMvShift is the precision of the motion vector MV/block vector BV. Here, initialize iBvShift may also be defined, where iBvShift is the precision of the block vector BV. For example, the precision of the vector parameter may be integer sample precision, in which case the precision of the vector parameter is 0; the precision of the vector parameter may also be sub-sample precision, for example, in a case where the precision of the vector parameter is 1, it represents ½ sample precision, and in a case where the precision of the vector parameter is 2, it represents ¼ sample precision, which is not limited here in detail.

Furthermore, the preset search range of the template is initialized. The preset search range of the template may be set to a fixed size, or may be determined by a value of a syntax element in the bitstream, or may be dynamically adjusted according to a coding block size. For example, searchRange Width=TMP_SEARCH_RANGE_MULT_FACTORxnTbW, searchRangeHeight=TMP_SEARCH_RANGE_MULT_FACTORxnTbH; where a value of TMP_SEARCH_RANGE_MULT_FACTOR may be a preset value, for example, the value is set to 5.

In S902, a search region of the template is determined.

It should be noted that the search region of the TM is the neighbouring region of the reference block pointed to by the initial MV/BV, and the neighbouring region is limited by the size of the search range.

In the inter related technologies, the reference block pointed to by the MV is different from the current coding block. In this case, the reference picture has been completely reconstructed. The search region may be any position within the reference picture. The specific search region is determined by the initial MV. As illustrated in FIG. 1A, the left section is the reconstructed reference picture, the dotted box is the search region, and the grid region on the right section is the current block. During the search process, availability of the reference blocks needs to be determined. Since the reference picture is a reconstructed picture, in response to that the search range does not exceed the picture boundary, it means that all reference blocks within the search range are available. In response to that the search range exceeds the picture boundary, the reference blocks in the search range that exceed the picture boundary are unavailable. In some implementations, in a case where the reference block is available, the template corresponding to the reference block is also available, and in a case where the reference block is unavailable, the template corresponding to the reference block is also unavailable.

In the IBC related technologies, the reference block pointed to by the BV is the same picture as the current coding block. The search region may be the reconstructed part of the CTB where the current coding block is located, or the search region may be other reconstructed CTB regions. The specific search region is determined by the initial BV. During the search process, whether the samples within the search range have been reconstructed needs to be determined. As illustrated in FIG. 1B, the dark-filled background region is the reconstructed region of the current picture, the dotted box is the search region, and the grid region is the current block. During the search process, the availability of reference blocks needs to be determined. In some embodiments, for each reference block within the search range, it is first determined whether the top-left corner sample of the reference block has been reconstructed, if the top-left corner sample is not unavailable, it means that the reconstructed block is unavailable, otherwise, it is further determined whether the bottom-right corner sample of the reference block has been reconstructed, if the bottom-right corner sample is not unavailable, it means that the reconstructed block is unavailable, if the bottom-right corner sample has also been reconstructed, it means that the reconstructed block is available.

The search region of the Intra TMP technology is the reconstructed part of the current picture and is limited by the size of the search range. As illustrated in FIG. 11, the background region filled with dark color is the reconstructed region of the current picture, the block of which the background is filled with horizontal line(s) is the current block, and the dotted box is the search range window. The reference block pointed to by BV is the same picture as the current coding block. In a case where the initial BV is 0, the search region is a search window centered on the current block. The reconstructed samples within the search region may include the current CTB and multiple CTBs on the left side, the top-left side, top side, and all or part of the CTB region. Therefore, the search region of the IntraTMP technology is no greater than overlap between the reconstructed region represented by the dark background and the region marked by the dotted box.

It may be seen that the search region of the template of the current block may be a reconstructed part of the CTB where the current block is located, or may be other reconstructed CTB regions. The search region here is actually a collection of all search points. Since a shape of the region is often not representable by a single rectangular region, in an exemplary implementation, a search may be performed within multiple rectangular regions, and then search results of different regions are taken into consideration, to obtain a final best matching block and a best block vector.

Exemplarily, taking the FIG. 7A to FIG. 7H as an example, eight different partitioning manners of sub-regions are illustrated. Block of which the background is filled with horizontal line(s) is the current block; five partitioning manners of FIG. 7A, FIG. 7B, FIG. 7C, FIG. 7D and FIG. 7F all partition the search region into four sub-search regions, and three partitioning manners of FIG. 7E, FIG. 7G and FIG. 7H all partition the search region into three sub-search regions, where different filling patterns represent different sub-search regions.

In FIG. 7A to FIG. 7H, all available search ranges are considered in FIG. 7A, FIG. 7B, FIG. 7C and FIG. 7D, and the directly top region and the directly left region are not searched in FIG. 7E, FIG. 7F, FIG. 7G, FIG. 7H.

Exemplarily, it is assumed that different sub-search regions are represented by regionId, considering that the template samples of the current block need to be obtained within the reconstructed region of the picture and samples of the reconstructed block corresponding to the template also need to be obtained within the reconstructed region, it is necessary to further determine the position that may be searched in the sub-search regions represented by different regionIds according to a position of the current block (xTbCmp, yTbCmp), a size of the current block (nTbW, nTbH), a size of the current picture (picWidth, picHeight), a size of the CTB where the current block is located (CtbSizeW, CtbSizeH), a preset search range of the template (search RangeWidth, searchRangeHeight) and a position offset of the current block in the current CTB (offsetLCBY, offsetLCBX), thereby determining the block vector BV. In some implementation, iVerMin and iVerMax represent absolute coordinate positions that may be searched at least and at most in a vertical direction, respectively, and iHorMin and iHorMax represent absolute coordinate positions that may be searched at least and at most in a horizontal direction, respectively. Values of iVerMin, iVerMax, iHorMin, and iHorMax are different within the search regions represented by different regionIds.

Taking FIG. 7F as an example, the search region is partitioned into four sub-search regions, and the implementation method thereof is as follows.

In a case where regionId is equal to 0, iVerMin, iVerMax, iHorMin and iHorMax may be calculated as follows:

$${iHorMax}_{0} = min ( ( xTbCmp + searchRangeWidth ) << iBvShift , ( ( picWidth - nTbW ) << iBvShift ) ) ; \\ {iHorMin}_{0} = max ( ( iTemplateSizeW ) << iBvShift , ( xTbCmp - searchRangeWidth ) << iBvShift ) ; \\ {iVerMax}_{0} = ( yTbCmp - nTbH - offsetLCBY ) << iBvShift ; \\ {iVerMin}_{0} = max ( ( ( iTemplateSizeH ) << iBvShift ) , ( ( yTbCmp - searchRangeHeight ) << iBvShift ) ) .$$

In a case where regionId is equal to 1, iVerMin, iVerMax, iHorMin and iHorMax may be calculated as follows:

$${iHorMin}_{1} = max ( ( iTemplateSizeW ) << iBvShift , ( xTbCmp - searchRangeWidth ) << iBvShift ) ; \\ {iHorMax}_{1} = ( xTbCmp - offsetLCBX - nTbW ) << iBvShift ; \\ {iVerMin}_{1} = ( yTbCmp + 1 ) << iBvShift ; \\ {iVerMax}_{1} = min ( picHeight - nTbH , ( yTbCmp - offsetLCBY + CtbSizeH - nTbH ) << iBvShift ) .$$

In a case where regionId is equal to 2, iVerMin, iVerMax, iHorMin and iHorMax may be calculated as follows:

$${iHorMax}_{2} = ( xTbCmp - offsetLCBX - nTbW ) << iBvShift ; \\ {iHorMin}_{2} = max ( ( iTemplateSizeW ) << iBvShift , ( xTbCmp - searchRangeWidth ) << iBvShift ) ; \\ {iVerMin}_{2} = max ( ( iTemplateSizeH ) << iBvShift , ( yTbCmp - nTbH - offsetLCBY ) << iBvShift ) ; \\ {iVerMax}_{2} = ( yTbCmp ) << iBvShift .$$

In a case where regionId is equal to 3, iVerMin, iVerMax, iHorMin and iHorMax may be calculated as follows:

$${iHorMin}_{3} = max ( ( iTemplateSizeW ) << iBvShift , ( xTbCmp - offsetLCBX - nTbW + 1 ) << iBvShift ) ; \\ {iHorMax}_{3} = ( xTbCmp - nTbW ) << iBvShift ; \\ {iVerMin}_{3} = max ( ( ( iTemplateSizeH ) << iBvShift ) , ( yTbCmp - offsetLCBY - nTbH + 1 ) << iBvShift ) ; \\ {iVerMax}_{3} = ( yTbCmp - nTbH ) << iBvShift .$$

In practical applications, iHorMin_{regionId}, iHorMax_{regionId}, iVerMin_{regionId} and iVerMax_{regionId} here represent a left edge, a right edge, a top edge, and a bottom edge for different sub-search regions, respectively.

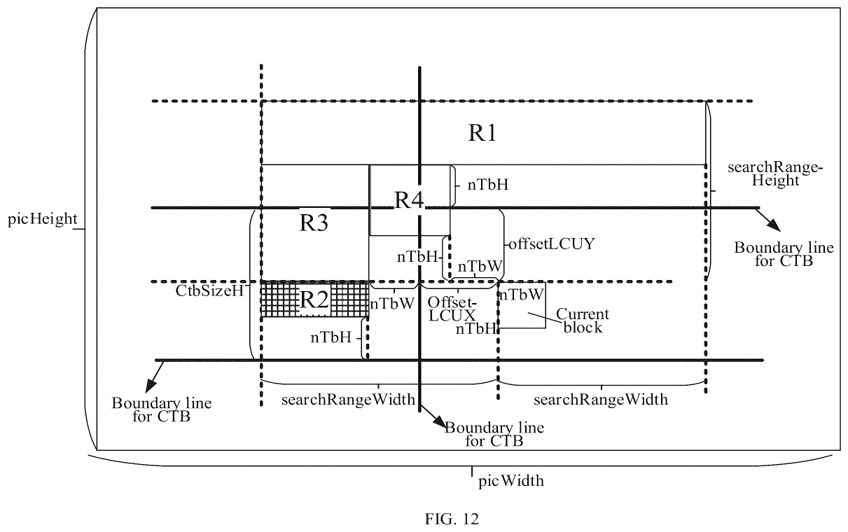

In order to intuitively describe the different sub-search regions corresponding to different regionIds, referring to FIG. 12, a schematic diagram of a determining process of a specific search region provided in the embodiments of the present disclosure is illustrated. As illustrated in FIGS. 12, R1, R2, R3, and R4 represent four different sub-search regions. It should be noted that FIG. 12 is expressed in terms of a sample range within which top-left corner samples of blocks may be aligned.

In S903, the best vector parameter within the search region is searched for and determined.

It should be noted that, taking determination of the best MV as an example:
mvXMins and mvXMaxs represent the minimum offset and maximum offset of the motion vector in the horizontal direction respectively; mvYMins and mvYMaxs represent the minimum offset and maximum offset of the motion vector in the vertical direction respectively.

Here, mvXMins, mvXMaxs, mvYMins and mvYMaxs may be determined from the initial MV/BV and the search range searchRangeWidth and searchRangeHeight:

$$mvXMins = ( mvXInt - searchRangeWidth ) << iMvShift ;$$

$$mvXMaxs = ( mvXInt + searchRangeWidth ) << iMvShift ;$$

$$mvYMins = ( mvYInt - searchRangeHeight ) << iMvShift ;$$

$$mvYMaxs = ( mvYInt + searchRangeHeight ) << iMvShift .$$

Here, mvXMins, mvXMaxs, mvYMins and mvYMaxs determine a horizontal offset range and a vertical offset range of the search point relative to the current block, that is, the range of the motion vector.

Through the respective search point (iPosHor, iPox Ver) within each search region, that is, each motion vector MV (consisting of the horizontal component and vertical component: (pX, pY), where pX=iPosHor-xTbCmp, pY=iPos Ver-yTbCmp, then pX is between mvXMins and mvXMaxs, pY is between mvYMins and mvYMaxs), a matching reconstructed block of the current block may be found within the reconstructed region, and the neighbouring reconstructed samples of the matching reconstructed block are the matching template (i.e., the second template mentioned above). In this way, a matching cost value between the neighbouring template of the current block and the neighbouring template of the reconstructed block (i.e., the reference block) may be calculated, which is represented as pDiff.

Furthermore, all search points within all search ranges are traversed, and a search point with the minimum matching cost value pDiff is obtained through comparison, a matching cost value corresponding to the search point is recorded as pDiff_BEST, and a vector parameter corresponding to the search point is recorded as a best vector parameter, MV_BEST or BV_BEST, in some implementation, including (pX_BEST, pY_BEST), and a matching template corresponding to the search point is a best matching template T_BEST.

All search points within the search range are traversed, availability of all the search points are determined, and the search point with the minimum matching cost value pDiff is obtained through comparison. The matching cost value corresponding to the search point is recorded as pDiff_BEST, a motion vector MV is recorded corresponding to the search point as the best vector parameter MV_BEST (pX_BEST, pY_BEST), and the matching template corresponding to the search point is the best matching template T_BEST.

It should be noted that determining the availability of the search point may be understood as determining the availability of the reference block and the template.

In some embodiments, availability determination includes but is not limited to one or more of following conditions being met simultaneously:
each sample within the template not exceeding a valid coordinate range limited by the picture sample boundary;
each sample within a reconstruction block corresponding to the template not exceeding a valid coordinate range limited by the picture sample boundary;
both each sample within the template and each sample within a reconstruction block corresponding to the template not exceeding a specified range of the search window;
whether each sample within the template being within a same sub-picture (e.g., Tile) as a current coding region;
whether each sample within a reconstructed block corresponding to the template being within a same sub-picture (e.g., Tile) as a current coding region (also called the current block);
each sample within the template having been reconstructed;
each sample within a reconstructed block corresponding to the template being not within a current coding region; for limited conditions of intra prediction, inter prediction being not involved;
each sample within a reconstruction block corresponding to the template having been reconstructed.

After completing the above operations, the best vector parameter (pX_BEST, pY_BEST) may be obtained, where pX_BEST and pY_BEST are a horizontal offset and a vertical offset of the best matching template relative to the template of the current coding block within the current picture or the reference picture, respectively, and pX_BEST and pY_BEST are also a horizontal offset and a vertical offset of the best matching reconstructed block relative to the current coding block.

It should be noted that, in the above one or more determination conditions for availability, “each sample within the template” is replaced by “identification sample within the template”; in the above one or more determination conditions for availability, “each sample within reconstructed block corresponding to the template” is replaced by “identification sample within the reconstructed block corresponding to the template”.

It should be noted that the identification sample may be a sample at a preset specific position within the template or within a reconstructed block corresponding to the template. In some embodiments, the identification sample within the template refers to one or more samples located within a corner position of the template region. For example, in a case where there is only a top template, the identification sample refers to a sample at a top-left corner and a sample at a bottom-right corner of the top template region; or the identification sample refers to only the sample of the bottom-right corner. The identification sample within the reconstructed block corresponding to the template refers to one or more samples located within a corner position of a reconstructed block region. For example, the identification sample refers to a sample at a top-left corner and a sample at a bottom-right corner of the reconstructed block region; or the identification sample refers to only the sample at the bottom-right corner of the reconstructed block region.

Taking the Intra-TMP technology to determine the best BV as an example: bvXMins and bvXMaxs represent the minimum offset and the maximum offset of the block vector in the horizontal direction respectively; bvYMins and bvYMaxs represent the minimum offset and the maximum offset of the block vector in the vertical direction respectively.

Here, bvXMins_{regionId}, bvXMaxS_{regionId}, bvYMins_{regionId} and bvYMaxS_{regionId} may be calculated by iVerMin_{regionId}, iVerMax_{regionId}, iHorMin_{regionId}, iHorMax_{regionId} determined in step S902:

$${bvXMins}_{regionId} = {iHorMin}_{regionId} - xTbCmp ; \\ {bvXMaxs}_{regionId} = {iHorMax}_{regionId} - xTbCmp ; \\ {bvYMins}_{regionId} = {iVerMin}_{regionId} - yTbCmp ; \\ {bvYMaxs}_{regionId} = {iVerMax}_{regionId} - yTbCmp .$$

Here, bvXMins_{regionId}, bvXMaxS_{regionId}, bvYMins_{regionId} and bvYMaxS_{regionId} determine the horizontal range and the vertical offset range of the search point relative to the current block, that is, the range of the block vector BV.

Through search points (iPosHor, iPox Ver) in each search region, that is, each motion vector MV (consisting of the horizontal component and the vertical component: (pX, pY), where pX=iPosHor−xTbCmp, pY=iPosVer−yTbCmp, then pX is between mvXMins and mvXMaxs, pY is between mvYMins and mvYMaxs), a matching reconstructed block of the current block may be found within the reconstructed region, and the neighbouring reconstructed samples of the matching reconstructed block are the matching template (i.e., the second template mentioned above). In this way, the matching cost value between the neighbouring template of the current block and the neighbouring template of the reconstructed block (i.e., the reference block) may be calculated, which is represented as pDiff.

Furthermore, all search points within all search ranges (regionId=0, 1, 2, 3) are traversed, and a search point with the minimum matching cost value pDiff is obtained through comparison, a matching cost value corresponding to the search point is recorded as pDiff_BEST, a block vector BV corresponding to the search point is recorded as a best block vector BV_BEST (pX_BEST, pY_BEST), and a matching template corresponding to the search point is a best matching template T_BEST.

In a possible implementation, in response to that a search strategy is that: only a coarse search is performed, the exemplary implementation is as follows.

In each region, within a search range where pX is between bvXMins_{regionId} and bvXMaxS_{regionId}, and pY is between bvYMins_{regionId} and bvYMaxS_{regionId}, a coarse search is performed with a step greater than 1. For example, a coarse search is performed with a step of 2, and the best matching cost value obtained by template matching is recorded as pDiff_BEST, and the block vector BV corresponding to the best matching cost value is recorded as the best block vector BV_BEST (pX_BEST, pY_BEST).

In another possible implementation, in response to that a search strategy is that: only a fine search is performed, the exemplary implementation is as follows.

In each region, within a search range where pX is between bvXMins_{regionId} and bvXMaxS_{regionId}, and pY is between bvYMins_{regionId} and bvYMaxS_{regionId}, for example, a fine search is performed with a step of 1, the best matching cost value obtained by template matching is recorded as pDiff_BEST, and the block vector BV corresponding to the best matching cost value is recorded as the best block vector BV_BEST (pX_BEST, pY_BEST).

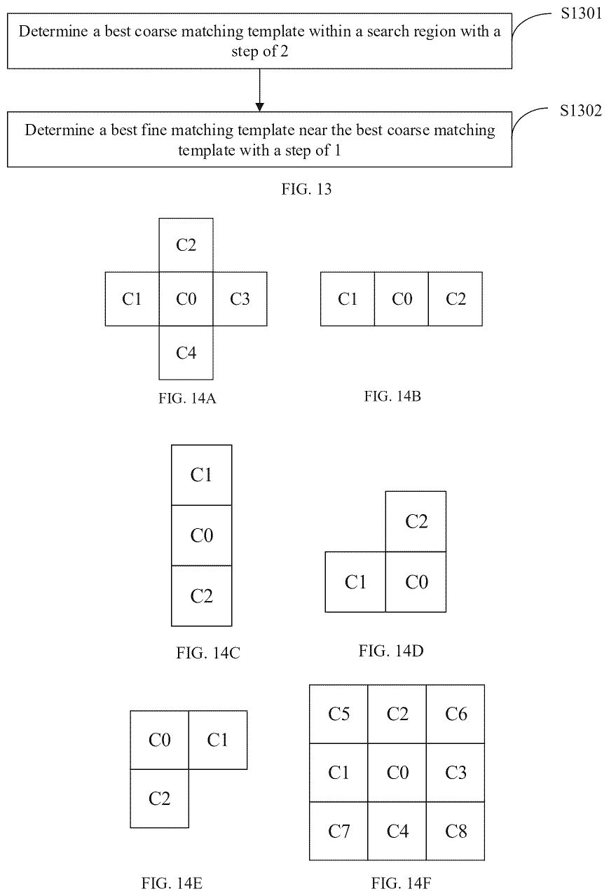

In yet another possible implementation, in response to that the search strategy is that: a coarse search is performed first and a fine search is performed later; as illustrated in FIG. 13, the specific process is as follows:
S1301, a best coarse matching template is determined within a search region with a step of 2.
S1302, a best fine matching template is determined near the best coarse matching template with a step of 1.

It should be noted that, for step S1301, following steps are performed in the coarse search stage.

In each region, within a search range where pX is between bvXMins_{regionId} and bvXMaxS_{regionId} and pY is between bvYMins_{regionId} and bvYMaxS_{regionId}, a coarse search is performed with a step greater than 1. For example, a coarse search is performed with a step of 2, the best matching cost value obtained by template matching is recorded as pDiff1_BEST, and the block vector BV corresponding to the best matching cost value is recorded as the best block vector BV1_BEST (pX1_BEST, pY1_BEST), and the search region where the best matching search point is located is bestRegionId.

It should also be noted that, for step S1302, following steps are performed in the fine search phase.

Furthermore, searching is performed near the best block vector BV1_BEST obtained by the coarse search. In some implementation, a refine search range TmpRefineRange is first determined, which may be a fixed size or related to the current block size, for example, it may be set to min (nTbW, nTbH)/2; a position of the best matching reconstructed block obtained by the coarse search is calculated as a reference position of the fine search region: BestPosX=xTbCmp+pX1_BEST, BestPosY=yTbCmp+pY1_BEST.

Firstly, values of iVerMinbest_{regionId} and iVerMaxbest_{regionId}, iHorMinbest_{regionId} and iHorMaxbest_{regionId} calculated in step S902 are obtained according to the value of bestRegionId, and then new search ranges iVerMin_{refine}, iVerMax_{refine}, iHorMin_{refine} and iHorMax_{refine} are obtained according to the position of the best matching block obtained by the coarse search. The obtaining method is as follows:

$${iHorMin}_{refine} = max ( {iHorMin}_{bestRegionId} , BestPosX - TmpRefineRange ) ; \\ {iHorMax}_{refine} = min ( {iHorMax}_{bestRegionId} , BestPosX + TmpRefineRange ) ; \\ {iVerMin}_{refine} = max ( {iVerMin}_{bestRegionId} , BestPosY - TmpRefineRange ) ; \\ {iVerMax}_{refine} = min ( {iVerMax}_{bestRegionId} , BestPosY + TmpRefineRange ) ;$$

Then, the adjusted block vectors BVs bvXMins, bvXMaxs, bvYMins and bvYMaxs may be calculated by iVerMin_{refine}, iVerMax_{refine}, iHorMin_{refine} and iHorMax_{refine}:

$$bvXMins = {iHorMin}_{refine} - xTbCmp ; \\ bvXMaxs = {iHorMax}_{refine} - xTbCmp ; \\ bvYMins = {iVerMin}_{refine} - yTbCmp ; \\ bvYMaxs = {iVerMax}_{refine} - yTbCmp ;$$

In this way, the refined search is performed within the block vector range where pX is between bvXMins_{regionId} and bvXMaxS_{regionId}, and pY is between bvYMins_{regionId} and bvYMaxS_{regionId}. For example, the search is performed with a step of 1, and the best matching cost value obtained by template matching is recorded as pDiff_BEST, and the block vector BV corresponding to the best matching cost value is recorded as the best block vector BV_BEST (pX_BEST, pY_BEST).

After completing the above operations, the best block vector BV_BEST (pX_BEST, pY_BEST) may be obtained, where pX_BEST and pY_BEST are a horizontal offset and a vertical offset of the best matching template relative to the template of the current block, and pX_BEST and pY_BEST are also a horizontal offset and a vertical offset of the best matching reconstructed block relative to the current block.

In S805, a filter-based linear model is established.

It should be noted that the filter-based linear model is established by using the best matching template obtained by performing the search in step S804 and the template of the current block. It mainly includes following two processes: determining the reconstructed region for calculating the filter coefficients and calculating the filter coefficients.

It should also be noted that the number of taps of the filter is defined as nTap. The nTap may be a constant or a variable. For example, the number of filter taps may be dynamically adjusted according to the size of the current block. In the embodiments of the present disclosure, filters of various shapes may be selected. Exemplarily, six fixed-shape filters illustrated in FIG. 14A to FIG. 14F may be selected, where the number of filter taps nTap in FIG. 14A is 5, and the filter coefficients are C0, C1, C2, C3 and C4, respectively. The number of filter taps nTap in FIG. 14B is 3, and the filter coefficients are: C0, C1 and C2. The number of filter taps nTap in FIG. 14C is 3, and the filter coefficients are: C0, C1 and C2. The number of filter taps nTap in FIG. 14D is 3, and the filter coefficients are: C0, C1 and C2. The number of filter taps nTap in FIG. 14E is 3, and the filter coefficients are: C0, C1 and C2. The number of filter taps nTap in FIG. 14F is 9, and the filter coefficients are: C0, C1, C2, C3, C4, C5, C6, C7 and C8. The shape and coefficients of the filter in FIG. 14A to FIG. 14F are for example only and are not intended to limit the embodiments of the present disclosure.

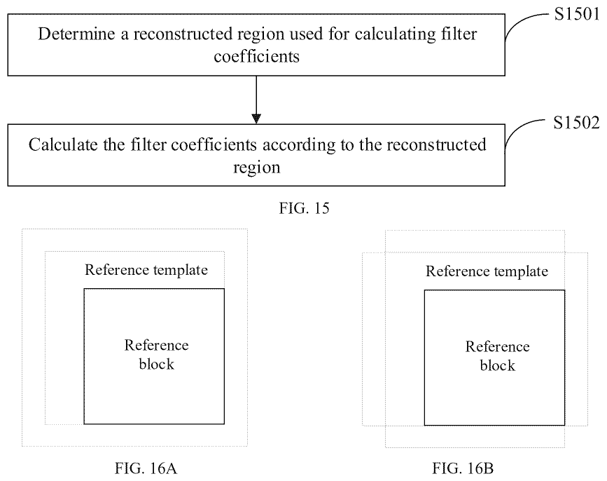

Referring to FIG. 15, a schematic flowchart of calculating filter coefficients provided in the embodiments of the present disclosure is illustrated. As illustrated in FIG. 15, the process may include following steps.

In S1501, a reconstructed region used for calculating filter coefficients is determined.

It should be noted that in the embodiments of the present disclosure, available reconstructed samples are determined according to a template type refTemplateType. For example, in a case where the template type refTemplateType is 1, as illustrated in the FIG. 10, it indicates that the neighbouring left side reconstructed samples, the top-left side reconstructed samples and the top side reconstructed samples are all available, in this case, the number of the available reconstructed samples on the left side is templateW_size×nTbH, the number of the available reconstructed samples on the top side is templateH_size×nTbW, and the number of the available reconstructed samples on the top-left side is templateW_size×templateH_size.

It should also be noted that in the embodiments of the present disclosure, after the number of available reconstructed samples are determined, a reconstructed region for calculating filter coefficients is determined according to the available reconstructed samples. This region may be referred to as R, and R generally includes all available reconstructed samples within the template. For example, in a case where refTemplateType is 1, R may include all available reconstructed samples on the left side, the top-left side and the top side.

In S1502, the filter coefficients are calculated according to the reconstructed region.

It should be noted that, in the embodiments of the present disclosure, after the reconstructed region R for calculating the filter coefficients are determined, a set of filter coefficients may be derived by minimizing the MSE between the reconstructed samples within the reconstructed region R and the reconstructed samples within the template of the current block, that is:

$$M S E = E [ {( predTemp [ i ] [ j ] - recTemp [ i ] [ j ] )}^{2} ] = E [ {( {\sum }_{k , l = - 1 ∼ 1} {c}_{k , l} \cdot refTemp [ i + k ] [ j + l ] - recTemp [ i ] [ j ] )}^{2} ] \qquad ( 16 )$$

Here, refTemp[i][j] represents an input reconstructed sample value, recTemp[i][j] represents a reconstructed sample value of the template of the current block, (i, j) represents a coordinate position, (i, j), (i, j) ∈R, k, l represent a coordinate offset of a position of a filter coefficient relative to a center position of the filter, where k and l are between −1 and 1. Taking FIG. 14A as an example, values of (k, l) may include (0, 0), (0, −1), (−1, 0), (0, 1), (1, 0), c_{k,l} represents required filter coefficient. In addition, E represents an operation of calculating the mean, and a calculation formula in this case is as follows:

$$M S E = \frac{1}{{N}_{pos}} {\sum }_{i} {\sum }_{j} {\vert predTemp [ i ] [ j ] - recTemp [ i ] [ j ] \vert}^{2} \qquad ( 17 )$$

Here, Nₚₒₛ refers to the number of (i, j) pairs involved in calculating |predTemp[i][j]−recTemp[i][j]|². For example, still taking FIG. 14A to FIG. 14F as an example, in a case where there are 5 (i, j) pairs involved in the operation, a value of Nₚₒₛ is equal to 5.

Furthermore, the process of minimizing the MSE to derive the filter coefficients is as follows.

Firstly, the partial derivative of c_{k,l} is found and it is made to equal to 0, that is:

$$\frac{\partial M S E}{\partial {c}_{m}} = E [ 2 ( {\sum }_{k , l = - 1 ∼ 1} {c}_{k , l} \cdot refTemp [ i + k ] [ j + l ] - recTemp [ i ] [ j ] ) \cdot refTemp [ i + m ] [ j + n ] ] \qquad ( 18$$

$$E [ 2 ( {\sum }_{k , l = - 1 ∼ 1} {c}_{k , l} \cdot refTemp [ i + k ] [ j + l ] - recTemp [ i ] [ j ] ) \cdot refTemp [ i + m ] [ j + n ] ] = 0 \qquad ( 19 )$$

Here, k and l are between −1 and 1, and m and n are between −1 and 1.

Secondly, according to the formula (18) and the formula (19), following formula may sorted out:

$${\sum }_{k , l = - 1 ∼ 1} {c}_{k , l} \cdot E ( refTemp [ i + k ] [ j + l ] \cdot refTemp [ i + m ] [ j + n ] ) = E ( recTemp [ i ] [ j ] \cdot refTemp [ i + m ] [ j + n ] ) \qquad ( 20 )$$

Secondly, after the reconstructed region R is determined, the obtained formula is expanded into a matrix form, as follows:

$$[ \begin{matrix}E ( refTemp [ i ] [ j ] \cdot refTemp [ i ] [ j ] ) & E ( refTemp [ i - 1 ] [ j ] \cdot refTemp [ i ] [ j ] ) & ⋯ & E ( refTemp [ i ] [ j + 1 ] \cdot refTemp [ i ] [ j ] ) \\ E ( refTemp [ i ] [ j ] \cdot refTemp [ i - 1 ] [ j ] ) & E ( refTemp [ i - 1 ] [ j ] \cdot refTemp [ i - 1 ] [ j ] ) & ⋯ & E ( refTemp [ i ] [ j + 1 ] \cdot refTemp [ i - 1 ] [ j ] ) \\ ⋮ & ⋮ & ⋱ & ⋮ \\ E ( refTemp [ i ] [ j ] \cdot refTemp [ i ] [ j + 1 ] ) & E ( refTemp [ i - 1 ] [ j ] \cdot refTemp [ i ] [ j + 1 ] ) & ⋯ & E ( refTemp [ i ] [ j + 1 ] \cdot refTemp [ i ] [ j + 1 ] )\end{matrix} ] \qquad ( 21 )$$

$$[ \begin{matrix}{c}_{0 , 0} \\ {c}_{- 1 , 0} \\ ⋮ \\ {c}_{0 , 1}\end{matrix} ] = [ \begin{matrix}{\sum }_{i ∈ R} ( recTemp [ i ] [ j ] \cdot refTemp [ i ] [ j ] ) \\ {\sum }_{i ∈ R} ( recTemp [ i ] [ j ] \cdot refTemp [ i - 1 ] [ j ] ) \\ ⋮ \\ {\sum }_{i ∈ R} ( recTemp [ i ] [ j ] \cdot refTemp [ i ] [ j + 1 ] )\end{matrix} ]$$

Thirdly, since the autocorrelation matrix of refTemp and the cross-correlation vector of refTemp and recTemp within the reconstructed region R are known quantities, the filter coefficient c_{k,l} may be calculated by solving the formula group in the formula (20), and the filter coefficient c_{k,l} may be fixed-point or not.

It should also be noted that in the process of solving the formula group, the autocorrelation matrix of the reconstructed sample refTemp within the reconstructed region R is first calculated, and then the cross-correlation vector between refTemp and the reconstructed sample recTemp of the current template is calculated. Then, the autocorrelation matrix is subjected to Cholesky decomposition or LDL decomposition, and finally, each filter coefficient cₙ is calculated in sequence by reverse recursion. This set of filter coefficients may be fixed-point or not.

In some embodiments, it is also necessary to pad the boundary samples. Considering that the filter may use reconstructed samples outside the reference template and the reference block, so that the boundary samples need to be padded, where depending on the different filter shape, regions that need to be padded at the boundary are different. It mainly includes following two processes: determining the boundary padding region of the reference block corresponding to the reference template and the reference template; and padding the boundary samples of the boundary padding region.

In some embodiments, the boundary padding region includes at least one of: an edge neighbouring region of the matching template, a point neighbouring region of the matching template, an edge neighbouring region of the reference block, or a point neighbouring region of the reference block.

In some embodiments, performing the boundary sample padding on the boundary padding region includes: performing the boundary sample padding on a first boundary padding region corresponding to the matching template by using neighbouring sample reconstructed values within the matching template; and/or performing the boundary sample padding on a second boundary padding region corresponding to the reference template by using neighbouring sample reconstructed values within the reference block.

In some embodiments, it is determined that a sample at a first position within the boundary padding region is unavailable, and boundary sample padding is performed on the first position within the boundary padding region.

In some embodiments, a determination condition for availability of the sample includes at least one of: the sample at the first position having been reconstructed; the first position being located within a search region; the first position being located within a picture where the reference block is located; the first position being located within a sub-picture where the reference block is located.

In some embodiments, performing the boundary sample padding on the boundary padding region includes: performing the boundary sample padding on the boundary padding region by using a preset sample value. Exemplarily, the preset sample value is 0, or the preset sample value is a sample value determined by the encoding end through decision.

In some embodiments, the boundary padding region is determined according to a filter shape. FIG. 16A is a schematic diagram illustrating a boundary padding region, in which an outer boundary region of the reference block and reference template of the reference block as a whole is padded, and the outer boundary region includes an edge neighbouring region and a point neighbouring region. FIG. 16B is a schematic diagram of a boundary padding region, in which an outer boundary region that is adjacent to the edge of the reference block and reference template of the reference block is padded.

It should be noted that a width of the outer boundary region is a preset width. Exemplarily, the width of the outer boundary region is measured in units of samples or sub-samples, and may be any number from 1 to N.

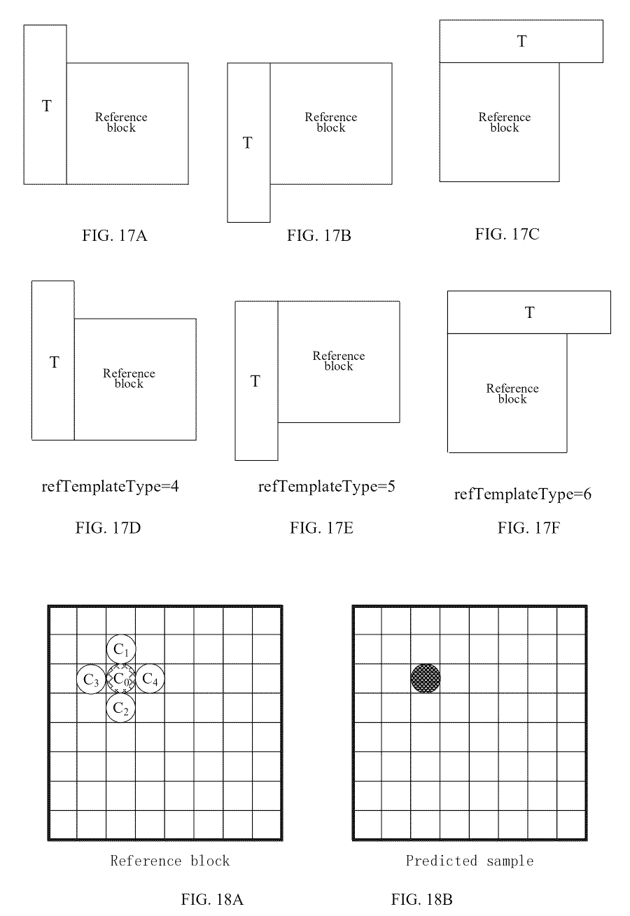

FIG. 17A to FIG. 17F are schematic diagrams of boundary padding regions of template types. In a case where a value of refTemplateType is 4, the boundary padding region is illustrated in FIG. 17A and FIG. 17D; in a case where a value of refTemplateType is 5, the boundary padding region is illustrated in FIG. 17B and FIG. 17E; in a case where a value of refTemplateType is 6, the boundary padding region is illustrated in FIG. 17C and FIG. 17F.

There are also different ways to pad.

One padding manner is to determine whether the samples within the outer boundary padding region are available, if available, the reconstructed samples are directly used, if not available, the reconstructed samples of the neighbouring reference template or the reference block are copied to pad the corresponding positions.

Another padding manner is to determine whether the search sample is within the search range, if it is within the search range, the reconstructed samples are used directly, if it exceeds the search region, the reconstructed samples of the neighbouring reference template or the reference block are copied according to the direction beyond the search region to pad the corresponding position.

Another padding manner is to directly copy the reconstructed samples of the neighbouring reference template or the reference block, to pad the boundary padding region.

Alternatively, no padding is also a choice, but instead give up using the corresponding data in the calculation when encountering a boundary position. The availability determination of the samples within the outer boundary padding region includes but is not limited to one or more of following conditions: the sample at the position having been reconstructed; the position not exceeding the search range of MV/BV; the position not exceeding the picture boundary; or the position not exceeding the boundary of the Tile.

In S806, a prediction value is generated.

It should be noted that, for each current block, a set of filter coefficients may be obtained in the above manner, and the set of filter coefficients is c₀, c₁, c₂ . . . c_{nTap-1}. Then, the best matching reconstructed block is filtered according to the filter shape and filter coefficients, that is, the filter coefficients and the reference samples at the corresponding positions are weighted and summed, to obtain the current sample to be predicted. ref is recorded as the best matching reconstruction block, which is defined as follows:

$$ref [ i ] [ j ] = recSamples [ i + pX\_BEST ] [ j + pY\_BEST ] \qquad ( 22 )$$

Here, i=0, . . . , nTbW-1, j-0, . . . , nTbH-1, recSamples are the reconstructed samples of the current picture or the reference picture, and pX_BEST and pY_BEST are the horizontal component and the vertical component of the best vector parameter.

It should also be noted that specific calculation process of the prediction value is as follows.

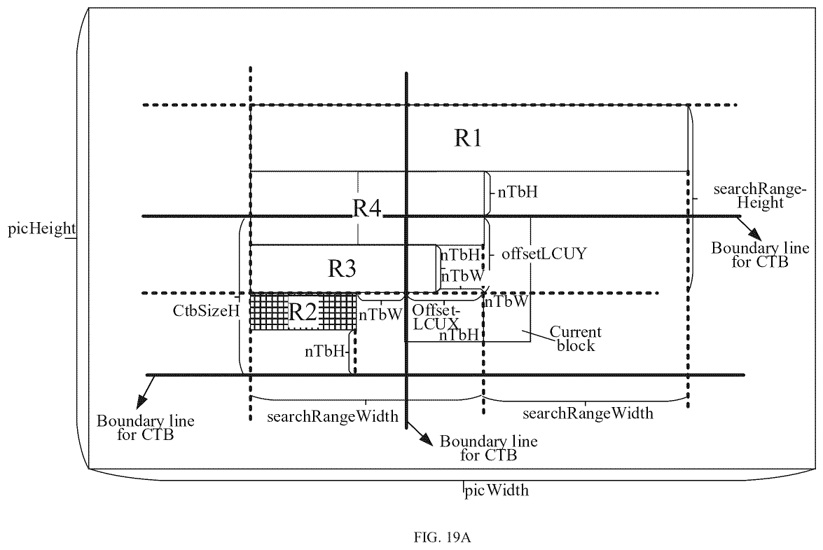

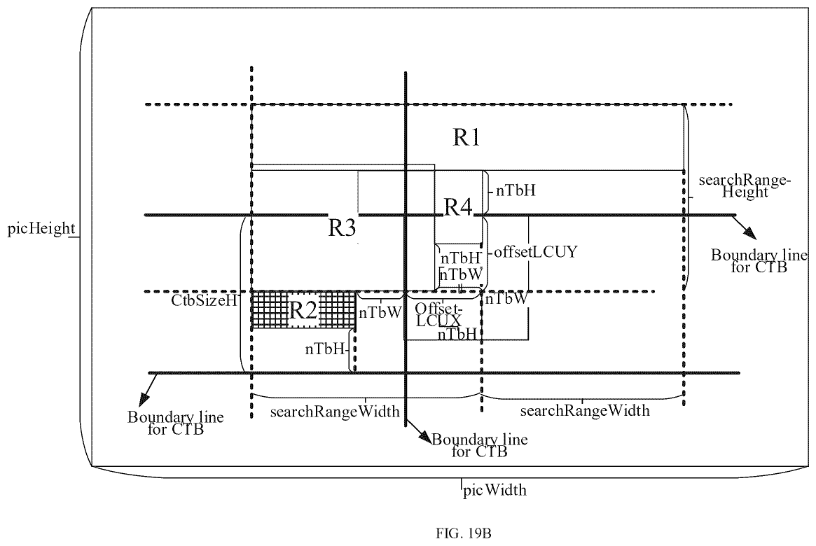

It is assumed that the number of filter taps nTap is 5, the shape of the filter (or called “filter template”) is illustrated in FIG. 18A, where c₀ and c₄ are tap coefficients of the filter respectively. A dot filled with grids corresponding to the tap coefficient c₀ is the reconstructed sample at the corresponding position of the current sample to be predicted Y^{pred}[i][j] in the best matching block (i.e., the reference block); the other dots filled with white color are the reconstructed samples neighbouring to a current sample to be predicted in the spatial position in the best matching block. In this way, according to the filter of FIG. 18A, the predicted samples finally obtained are illustrated as a dot filled with black color in FIG. 18B. The specific prediction value calculation process is as follows.

For each current sample to be predicted (i, j), a sample position within the filter template is defined as (k, l), then the corresponding reconstructed sample within the best matching block during filtering is defined as ref[i+k][j+l], and each filter coefficient at the position (k, l) within the filter template is defined as c_{k,l}:

$${c}_{k , l} = {c}_{n} \qquad ( 23 )$$

Here, n=0, . . . , nTap-1, k and l are between −1 and 1.

For i=0, . . . , nTbW-1, j=0, . . . , nTbH-1:

$${Y}^{pred} [ i ] [ j ] = {\sum }_{k} {\sum }_{l} ref [ i + k ] [ j + l ] \times {c}_{k , l} \qquad ( 24 )$$

Furthermore, a clip operation is performed to limit Y^{pred}[i][j] to a preset value range, to obtain a final predicted sample. The details are as follows:

$$predSamples [ i ] [ j ] = Clip3 ( 0 , ( 1 ≪ BitDepth ) - 1 , {Y}^{pred} [ i ] [ j ] ) \qquad ( 25 )$$

Here, for the clip function, the details are as follows:

$$Clip3 ( x , y , z ) = \{ \begin{matrix}x ; z < x \\ y ; z > y \\ z ; otherwise\end{matrix} \qquad ( 26 )$$

It may be understood that in the embodiments of the present disclosure, a filter-based linear model is established between the best matching template obtained by performing a search near the initial vector parameter and the template of the current block, the filter coefficients are calculated by minimizing the MSE between the predicted template (predicted template=filter coefficient×matching template) and the template of the current block, the best matching block is filtered and corrected, and the filtered reconstructed samples are used as the final predicted samples.

In some embodiments, the input information for calculating the filter coefficients in the above embodiments may be expanded. Here, the input information used for calculating the filter coefficients may be the available reconstructed samples of the matching template; alternatively, a gradient of each sample within the matching template may be calculated, including but not limited to a horizontal gradient, a vertical gradient, or the like, and the calculated gradient is used as the input information for calculating the filter coefficients; alternatively, position information of each sample may be used as the input information for calculating the filter, and the position information may be absolute position information of each sample within the entire picture, or relative position information of each sample relative to a reference point.

In some embodiments, the implementations of calculating the filter coefficients in the above embodiments may be expanded. The filter coefficients finally calculated are the tap coefficients corresponding to the filter template, that is, the number of filter coefficients is equal to the number of taps nTap of the filter template. In addition, several bias items may be added to the filter template. For example, in the above embodiments, in a case where nTap=5, the filter coefficients are the tap coefficients c₀ to c₄ corresponding to the filter template, and the prediction value obtained at the position (i, j) is calculated as:

$${Y}^{pred} [ i ] [ j ] = {\sum }_{n = 0}^{4} ref [ k ] [ l ] \times {c}_{n} \qquad ( 27 )$$

In this case, the bias term may be added, as shown in following formula:

$${Y}^{pred} [ i ] [ j ] = {\sum }_{n = 0}^{4} ref [ k ] [ l ] \times {C}_{n} + {C}_{5} \times Constant \qquad ( 28 )$$

Here, cₙ=c_{i,j,k,l}. In addition, Constant may be a fixed constant, such as Constant=1<< (BitDepth-1); Constant may also be a number related to the reconstructed sample value at the position (i, j) within the reference block, such as Constant=f (ref[i][j]); Constant may also be a number related to the reconstructed sample value corresponding to a tap within the filter template other than the position (i, j), such as Constant=f (ref[k][l]). Here, Constant=f (ref[i][j]) or Constant=f (ref[k][l]) may be a linear mapping relationship or a nonlinear mapping relationship. One or more bias terms may be added.

In some embodiments, the number of filtering models in the above embodiments may be expanded. where only one filter-based linear model may be established, or multiple filter-based linear models may be established. Here, the input information for calculating the filter coefficients is classified, and a filter model is established for each type of the input information. For example, in a case where reconstruction information is used to establish the filter model, one possible implementation is to classify the reconstruction information by the mean of the reconstruction information, a filter model is established for reconstruction information greater than the mean, and a filter model is established for reconstruction information less than the mean.

Another possible implementation is to use the position of the reconstruction information for classification. For example, a model may be established by using the available reconstruction information on the left side and the top side, and a second model may be established by using the available reconstruction information on the left side and the top-left side, and so on. The encoding end decides which model to use. One possible decision-making manner is that the encoding end determines which model to use through rate-distortion optimization and transmits the corresponding decoding parameters (e.g., Flag) to the decoding end.

Another possible implementation is to classify filters by their shapes. Multiple filters of different shapes may be used, and different filter models are established for filters of different shapes. The encoding end decides filter of which shape to use. One possible decision-making manner is that the encoding end determines which filter to use by rate-distortion optimization and transmits corresponding decoding parameters (e.g., Flag) to the decoder.

In some embodiments, the type of filtering model in the above embodiments may be expanded. The filter-based linear model may be established, and the filter-based nonlinear model may also be established for filtering. One possible implementation is to introduce a quadratic term to establish a filter-based nonlinear model. For example, in a case where minimizing the MSE of the filter coefficients, the calculation formula is changed as follows:

$$M S E = E [ {( predTemp [ i ] [ j ] - recTemp [ i ] [ j ] )}^{2} ] = E [ {( {\sum }_{k , l = - 1 ∼ 1} {c}_{k , l} \cdot {( refTemp [ i + k ] [ j + l ] )}^{2} - recTemp [ i ] [ j ] )}^{2} ] \qquad ( 29 )$$

In this case, the calculation formula for calculating the prediction value is modified as follows:

$${Y}^{pred} [ i ] [ j ] = {\sum }_{k} {\sum }_{l} {( ref [ i + k ] [ j + l ] )}^{2} \times {C}_{k , l} \qquad ( 30 )$$

In some embodiments, the portion for calculating the prediction value in the above embodiment may be expanded. It is determined by certain conditions whether the current block uses the filtered reference block as the final prediction value. For example, there are several manners:

Manner 1: whether to filter the matching template is determined by comparing a distortion of the matching template and the template of the current block, such as the SAD, the MSE, the SATD or the SSE, with a threshold T_Distortion1.

Manner 2: on the basis that Manner 1 meets using the filter model, whether to filter the reference block is determined by using a distortion between the filtered matching template and the template of the current block, such as the SAD, the MSE, the SATD or the SSE, and a threshold T_Distortion2.

Manner 3: the encoding end transmits a Flag to indicate whether to apply the filter model. The tmpFlag indicates whether intra template matching is applied to the current coding block, and filterFlag indicates whether the filter model is applied to the current block. In a case where tmpFlag is 1, the encoding end determines whether to filter the reference block by comparing distortions between the reference block and the original block before and after filtering, such as the SAD, the MSE, the SATD or the SSE. In response to that the distortion after filtering is less than the distortion before filtering, filterFlag is 1, and the filtered reference block is used as the prediction block for the current block; otherwise, filterFlag is 0, and the reference block before filtering is used as the prediction block for the current block. The encoding end transmits filterFlag to the decoding end.

In some embodiments, an implementation in FIG. 7A is performed, where the implementation is performed via four sub-search regions after partition:

In a case where regionId is equal to 0, iVerMin, iVerMax, iHorMin, iHorMax may be calculated as follows:

$$iHorMax = min ( ( xTbCmp + searchRangeWidth ) << iBvShift , ( ( picWidth - nTbW ) << iBvShift ) ) ; \\ iHorMin = max ( ( iTemplateSizeW ) << iBvShift , ( xTbCmp - searchRangeWidth ) << iBvShift ) ; \\ iVerMax = ( yTbCmp - nTbH - offsetLCBY ) << iBvShift ; \\ iVerMin = max ( ( ( iTemplateSizeH ) << iBvShift ) , ( ( yTbCmp - searchRangeHeight ) << iBvShift ) ) .$$

In a case where regionId is equal to 1, iVerMin, iVerMax, iHorMin and iHorMax may be calculated as follows:

$$iHorMin = max ( ( iTemplateSizeW ) << iBvShift , ( xTbCmp - searchRangeWidth ) << iBvShift ) ; \\ iHorMax = ( xTbCmp - offsetLCBX - nTbW ) << iBvShift ; \\ iVerMin = ( yTbCmp + 1 ) << iBvShift ; \\ iVerMax = min ( picHeight - nTbH , ( yTbCmp - offsetLCBY + CtbSizeH - nTbH ) << iBvShift ) .$$

In a case where regionId is equal to 2, iVerMin, iVerMax, iHorMin and iHorMax may be calculated as follows:

$$iHorMax = ( x TbCmp - nTbW ) << iBvShift ; \\ iHorMin = max ( ( iTemplateSizeW ) << iBvShift , ( xTbCmp - searchRangeWidth ) << iBvShift ) ; \\ iVerMin = max ( ( iTemplateSizeH ) << iBvShift , ( yTbCmp - nTbH ) << iBvShift ) ; \\ iVerMax = ( yTbCmp ) << iBvShift .$$

In a case where regionId is equal to 3, iVerMin, iVerMax, iHorMin and iHorMax may be calculated as follows:

$$iHorMin = max ( iTemplateSizeW ) << iBvShift , ( xTbCmp - searchRangeWidth ) << iBvShift ) ; \\ iHorMax = ( xTbCmp ) << iBvShift ; \\ iVerMin = max ( ( ( iTemplateSizeH ) << iBvShift ) , ( yTbCmp - offsetLCBY - nTbH + 1 ) << iBvShift ) ; \\ iVerMax = ( yTbCmp - nTbH ) << iBvShift .$$

In practical applications, iHorMin, iHorMax, iVerMin and iVerMax here represent the left edge, the right edge, the top edge, and the bottom edge of different search regions respectively.

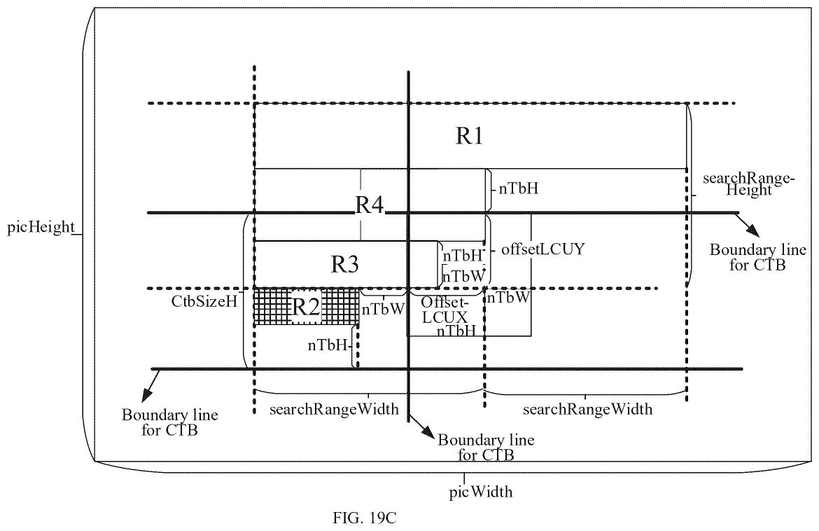

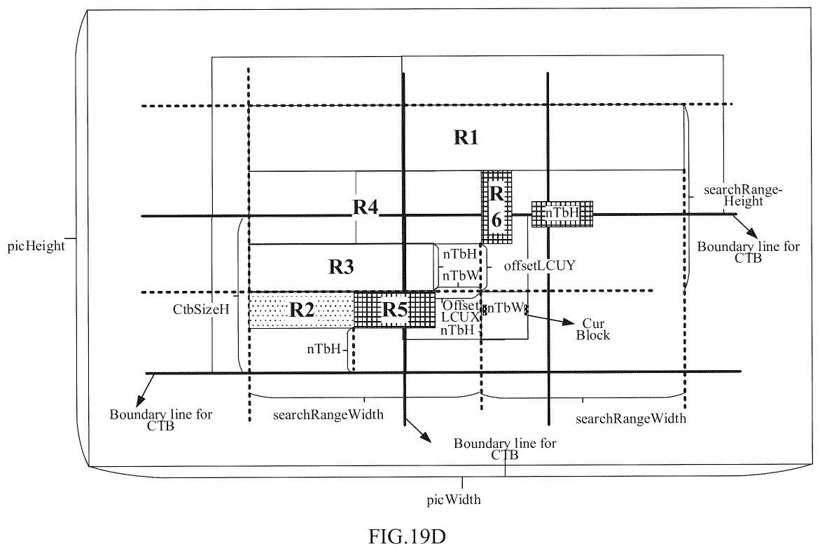

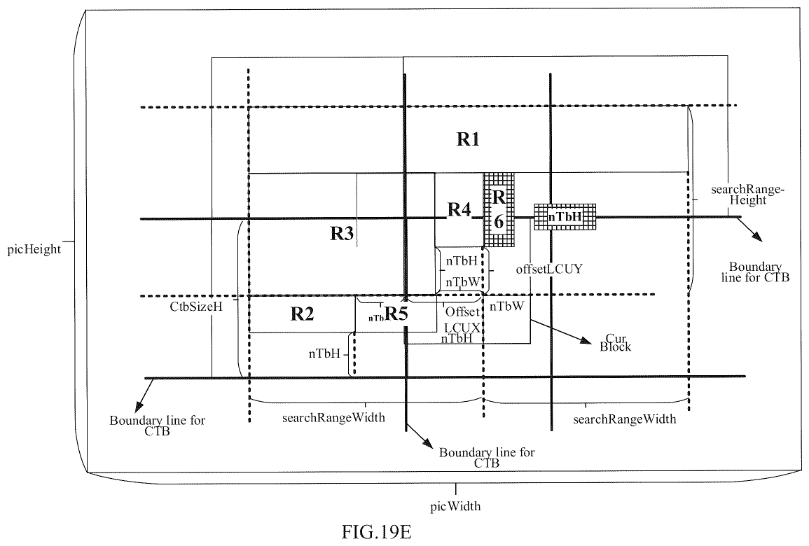

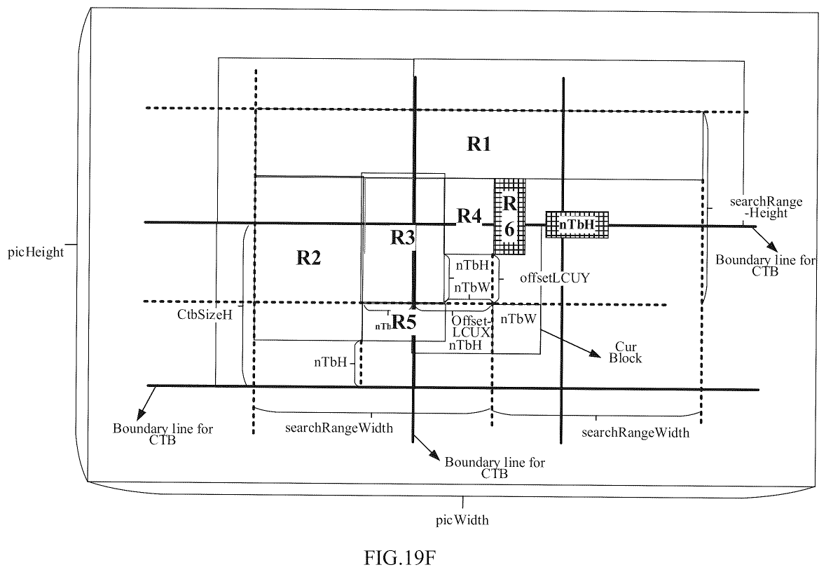

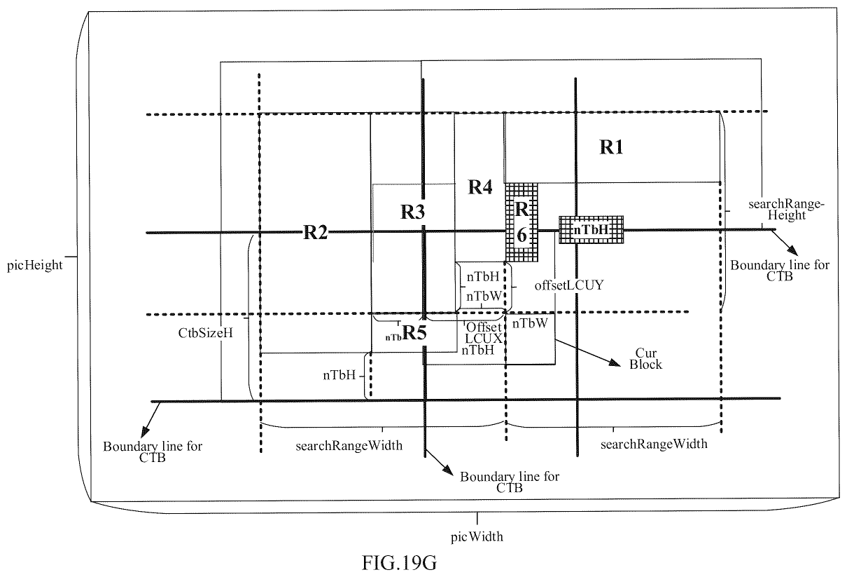

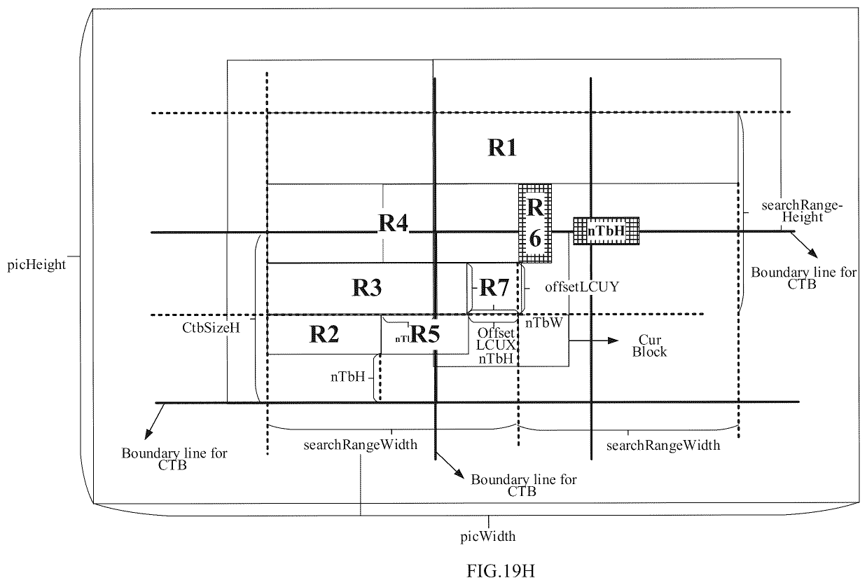

In order to intuitively describe the different sub-search regions corresponding to different regionIds, referring to FIG. 19A, a schematic diagram of a determining process of another specific search region provided in the embodiments of the present disclosure is illustrated. As illustrated in FIG. 19A, R1, R2, R3, and R4 represent four different sub-search regions. It should be noted that FIG. 19A is expressed in terms of a sample range with which the top-left corner sample of the block may be aligned.

In some embodiments, the search region of the template within the picture provided here may be different from the search region of the template within the picture determined in the existing TM technology. Another implementation in FIG. 7B is performed, which is implemented via four sub-regions after parition:

In a case where regionId is equal to 0, iVerMin, iVerMax, iHorMin and iHorMax may be calculated as follows:

$$iHorMax = min ( ( xTbCmp + searchRangeWidth ) << iBvShift , ( ( picWidth - nTbW ) << iBvShift ) ) ; \\ iHorMin = max ( ( iTemplateSizeW ) << iBvShift , ( xTbCmp - searchRangeWidth ) << iBvShift ) ; \\ iVerMax = ( yTbCmp - nTbH - offsetLCBY ) << iBvShift ; \\ iVerMin = max ( ( ( iTemplateSizeH ) << iBvShift ) , ( ( yTbCmp - searchRangeHeight ) << iBvShift ) ) .$$

In a case where regionId is equal to 1, iVerMin, iVerMax, iHorMin and iHorMax may be calculated as follows:

$$iHorMin = max ( ( iTemplateSizeW ) << iBvShift , ( xTbCmp - searchRangeWidth ) << iBvShift ) ; \\ iHorMax = ( xTbCmp - offsetLCBX - nTbW ) << iBvShift ; \\ iVerMin = ( yTbCmp + 1 ) << iBvShift ; \\ iVerMax = min ( picHeight - nTbH , ( yTbCmp - offsetLCBY + CtbSizeH - nTbH ) << iBvShift ) .$$

In a case where regionId is equal to 2, iVerMin, iVerMax, iHorMin and iHorMax may be calculated as follows:

$$iHorMax = ( xTbCmp - nTbW ) << iBvShift ;$$

$$iHorMin = max ( ( iTemplateSizeW ) << iBvShift , ( xTbCmp - searchRange Width ) << iBvShift ) ;$$

$$iVerMin = max ( ( iTemplateSizeH ) << iBvShift , ( yTbCmp - nTbH - offsetLCBY ) << iBvShift ) ;$$

$$iVerMax = ( yTbCmp ) << iBvShift .$$

In a case where regionId is equal to 3, iVerMin, iVerMax, iHorMin and iHorMax may be calculated as follows:

$$iHorMin = max ( ( iTemplateSizeW ) << iBvShift , ( xTbCmp - nTbW + 1 ) << iBvShift ) ;$$

$$iHorMax = ( xTbCmp ) << iBvShift ;$$

$$iVerMin = max ( ( ( iTemplateSizeH ) << iBvShift ) , ( yTbCmp - offsetLCBY - nTbH + 1 ) << iBvShift ) ;$$

$$iVerMax = ( yTbCmp - nTbH ) << iBvShift .$$

In practical applications, iHorMin, iHorMax, iVerMin and iVerMax here represent the left edge, the right edge, the top edge, and the bottom edge of different search regions respectively.

In order to intuitively describe the different sub-search regions corresponding to different regionIds, referring to FIG. 19B, a schematic diagram of a determining process of another specific search region provided in the embodiments of the present disclosure is illustrated. As illustrated in FIG. 19B, R1, R2, R3 and R4 represent four different sub-search regions. It should be noted that FIG. 19B is expressed in terms of a sample range with which the top-left corner sample of the block may be aligned.

In some embodiments, the coarse search process may be consistent with the above embodiments, and in the fine search process, the method may be performed across various region boundaries, that is, the technical solution is expanded to perform the fine search across boundaries between the search regions here. In the embodiments of the present disclosure, the method may further include:
performing a first search within each of the at least one sub-search region respectively, to determine a respective best block vector of each sub-search region and a respective second search region corresponding to each best block vector;
performing region determination according to the respective best block vector corresponding to each sub-search region and the respective second search region corresponding to each best block vector, to determine at least two target sub-search regions participating in a second search;
performing the second search within the at least two target sub-search regions, to determine a best block vector corresponding to the at least two target sub-search regions; and
using the best block vector corresponding to the at least two target sub-search regions as the target block vector.

For example, taking FIG. 7A as an example, another implementation is provided here, which is implemented via four sub-search regions after partition:

In a case where regionId is equal to 0, iVerMin, iVerMax, iHorMin and iHorMax may be calculated as follows:

$${iHorMax}_{0} = min ( ( xTbCmp + searchRangeWidth ) << iBvShift , ( ( picWidth - nTbW ) << iBvShift ) ) ;$$

$${iHorMin}_{0} = max ( ( iTemplateSizeW ) << iBvShift , ( xTbCmp - searchRange Width ) << iBvShift ) ;$$

$${iVerMax}_{0} = ( yTbCmp - nTbH - offsetLCBY ) << iBvShift ;$$

$${iVerMin}_{0} = max ( ( ( iTemplateSizeH ) << iBvShift ) , ( ( yTbCmp - searchRangeHeight ) << iBvShift ) ) .$$

In a case where regionId is equal to 1, iVerMin, iVerMax, iHorMin and iHorMax may be calculated as follows:

$${iHorMin}_{1} = max ( ( iTemplateSizeW ) << iBvShift , ( xTbCmp - searchRange Width ) << iBvShift ) ;$$

$${iHorMax}_{1} = ( xTbCmp - offsetLCBX - nTbW ) << iBvShift ;$$

$${iVerMin}_{1} = ( yTbCmp + 1 ) << iBvShift ;$$

$${iVerMax}_{1} = min ( picHeight - nTbH , ( yTbCmp - offsetLCBY + CtbSizeH - nTbH ) << iBvShift ) .$$

In a case where regionId is equal to 2, iVerMin, iVerMax, iHorMin and iHorMax may be calculated as follows:

$${iHorMax}_{2} = ( xTbCmp - nTbW ) << iBvShift ;$$

$${iHorMin}_{2} = max ( ( iTemplateSizeW ) << iBvShift , ( xTbCmp - searchRange Width ) << iBvShift ) ;$$

$${iVerMin}_{2} = max ( ( iTemplateSizeH ) << iBvShift , ( yTbCmp - nTbH ) << iBvShift ) ;$$

$${iVerMax}_{2} = ( yTbCmp ) << iBvShift .$$

In a case where regionId is equal to 3, iVerMin, iVerMax, iHorMin and iHorMax may be calculated as follows:

$${iHorMin}_{3} = max ( ( iTemplateSizeW ) << iBvShift , ( xTbCmp - searchRange Width ) << iBvShift ) ;$$

$${iHorMax}_{3} = ( xTbCmp ) << iBvShift ;$$

$${iVerMin}_{3} = max ( ( ( iTemplateSizeH ) << iBvShift ) , ( yTbCmp - offsetLCBY - nTbH + 1 ) << iBvShift ) ;$$

$${iVerMax}_{3} = ( yTbCmp - nTbH ) << iBvShift .$$

In practical applications, iHorMin, iHorMax, iVerMin and iVerMax here represent the left edge, the right edge, the top edge, and the bottom edge of different search regions respectively.

In order to intuitively describe the different sub-search regions corresponding to different regionIds, referring to FIG. 19C, a schematic diagram of a determining process of another specific search region provided in the embodiments of the present disclosure is illustrated. As illustrated in FIG. 19C, R1, R2, R3 and R4 represent four different sub-search regions, and fine searches are performed across boundaries between the sub-search regions. It should be noted that FIG. 19C is expressed in terms of a sample range with which the top-left corner sample of the block may be aligned.

In some embodiments, based on considerations of the full reconstruction search region and the pending reconstruction search region, taking FIG. 7A as an example, the search region is partitioned into six sub-search regions, which are implemented as follows.

In a case where regionId is equal to 0, iVerMin, iVerMax, iHorMin and iHorMax may be calculated as follows:

$${iHorMax}_{0} = min ( ( xTbCmp + searchRangeWidth ) << iBvShift , ( ( picWidth - nTbW ) << iBvShift ) ) ;$$

$${iHorMin}_{0} = max ( ( iTemplateSizeW ) << iBvShift , ( xTbCmp - searchRange Width ) << iBvShift ) ;$$

$${iVerMax}_{0} = ( yTbCmp - nTbH - offsetLCBY ) << iBvShift ;$$

$${iVerMin}_{0} = max ( ( ( iTemplateSizeH ) << iBvShift ) , ( ( yTbCmp - searchRangeHeight ) << iBvShift ) ) .$$

In a case where regionId is equal to 1, iVerMin, iVerMax, iHorMin and iHorMax may be calculated as follows:

$${iHorMin}_{1} = max ( ( iTemplateSizeW ) << iBvShift , ( xTbCmp - searchRange Width ) << iBvShift ) ;$$

$${iHorMax}_{1} = ( xTbCmp - offsetLCBX - nTbW ) << iBvShift ;$$

$${iVerMin}_{1} = ( yTbCmp + 1 ) << iBvShift ;$$

$${iVerMax}_{1} = min ( ( picHeight - nTbH ) << iBvShift , ( yTbCmp - offsetLCBY + CtbSizeH - nTbH ) << iBvShift ) .$$

In a case where regionId is equal to 2, iVerMin, iVerMax, iHorMin and iHorMax may be calculated as follows:

$${iHorMax}_{2} = ( xTbCmp - offsetLCBX - nTbW ) << iBvShift ;$$

$${iHorMin}_{2} = max ( ( iTemplateSizeW ) << iBvShift , ( xTbCmp - searchRange Width ) << iBvShift ) ;$$

$${iVerMin}_{2} = max ( ( iTemplateSizeH ) << iBvShift , ( yTbCmp - nTbH - offsetLCBY ) << iBvShift ) ;$$

$${iVerMax}_{2} = ( yTbCmp ) << iBvShift .$$

In a case where regionId is equal to 3, iVerMin, iVerMax, iHorMin and iHorMax may be calculated as follows:

$${iHorMin}_{3} = max ( ( iTemplateSizeW ) << iBvShift , ( xTbCmp - offsetLCBX - nTbW + 1 ) << iBvShift ) ;$$

$${iHorMax}_{3} = ( xTbCmp - nTbW ) << iBvShift ;$$

$${iVerMin}_{3} = max ( ( ( iTemplateSizeH ) << iBvShift ) , ( yTbCmp - offsetLCBY - nTbH + 1 ) << iBvShift ) ;$$

$${iVerMax}_{3} = ( yTbCmp - nTbH ) << iBvShift .$$

In a case where regionId is equal to 4, iVerMin, iVerMax, iHorMin and iHorMax may be calculated as follows:

$$iHorMin = ( xTbCmp - offsetLCBX - nTbW ) << iBvShift ;$$

$$iHorMax = ( xTbCmp - nTbW ) << iBvShift ;$$

$$iVerMin = ( yTbCmp + 1 ) << iBvShift ;$$

$$iVerMax = min ( ( picHeight - nTbH ) << iBvShift , ( yTbCmp - offsetLCBY + CtbSizeH - nTbH ) << iBvShift ) .$$

In a case where regionId is equal to 5, iVerMin, iVerMax, iHorMin and iHorMax may be calculated as follows:

$$iHorMin = ( xTbCmp ) << iBvShift ;$$

$$iHorMax = min ( ( xTbCmp + CtbSizeW - nTbW ) << iBvShift , min ( ( xTbCmp + searchRange Width ) << iBvShift , ( ( picWidth - nTbW ) << iBvShift ) ) ) ;$$

$$iVerMin = max ( ( ( iTemplateSizeH ) << iBvShift ) , ( yTbCmp - offsetLCBY - nTbH + 1 ) << iBvShift ) ;$$

$$iVerMax = ( yTbCmp - nTbH ) << iBvShift .$$

In practical applications, iHorMin_{regionId}, iHorMax_{regionId}, iVerMin_{regionId} and iVerMax_{regionId} here represent the left edge, the right the edge, top edge, and the bottom edge of different sub-search regions respectively.

In order to intuitively describe the different sub-search regions corresponding to different regionIds, FIG. 19D is a fourth schematic diagram of a determining process of the search region. As illustrated in FIG. 19D, R1, R2, R3, R4, R5 and R6 represent six different sub-search regions, in which R1, R2, R3 and R4 are full reconstruction search regions, and R5 and R6 are pending reconstruction search regions. It should be noted that FIG. 19D is expressed in terms of a sample range with which the top-left corner sample of the block may be aligned.

That is to say, in some embodiments, the search region may be partitioned into two types, one is a region in which all samples have been reconstructed (called a full reconstruction search region), for example, including the four regions R1, R2, R3, and R4 in FIG. 19D; the other is a region in which it is uncertain whether all samples have been reconstructed (called a pending reconstruction search region), for example, including the two regions R5 and R6 in FIG. 19D.

In some embodiments, based on considerations of the full reconstruction search region and the pending reconstruction search region, taking FIG. 7B as an example, the search region is partitioned into six sub-search regions, which are implemented as follows.

In a case where regionId is equal to 0, iVerMin, iVerMax, iHorMin and iHorMax may be calculated as follows:

$$iHorMax = min ( ( xTbCmp + search Range Width ) << iBvShift , ( ( pic Width - nTbW ) << iBvShift ) )$$

$$iHorMin = max ( ( iTemplateSizeW ) << iBvShift , ( xTbCmp - searchRange Width ) << iBvShift )$$

$$iVerMax = ( yTbCmp - nTbH - offsetLCBY ) << iBvShift$$

$$iVerMin = max ( ( ( iTemplateSizeH ) << iBvShift ) , ( ( yTbCmp - searchRangeHeight ) << iBvShift ) ) .$$

In a case where regionId is equal to 1, iVerMin, iVerMax, iHorMin and iHorMax may be calculated as follows:

$$iHorMin = max ( ( iTemplateSizeW ) << iBvShift , ( xTbCmp - searchRange Width ) << iBvShift )$$

$$iHorMax = ( xTbCmp - offsetLCBX - nTbW ) << iBvShift ;$$

$$iVerMin = ( yTbCmp + 1 ) << iBvShift ;$$

$$iVerMax = min ( picHeight - nTbH , ( yTbCmp - offsetLCBY + CtbSizeH - nTbH ) << iBvShift ) .$$

In a case where regionId is equal to 2, iVerMin, iVerMax, iHorMin and iHorMax may be calculated as follows:

$$iHorMax = ( xTbCmp - nTbW ) << iBvShift ;$$

$$iHorMin = max ( ( iTemplateSizeW ) << iBvShift , ( xTbCmp - searchRange Width ) << iBvShift ) ;$$

$$iVerMin = max ( ( iTemplateSizeH ) << iBvShift , ( yTbCmp - nTbH - offsetLCBY ) << iBvShift ) ;$$

$$iVerMax = ( yTbCmp ) << iBvShift .$$

In a case where regionId is equal to 3, iVerMin, iVerMax, iHorMin and iHorMax may be calculated as follows:

$$iHorMin = max ( ( iTemplateSizeW ) << iBvShift , ( xTbCmp - nTbW + 1 ) << iBvShift ) ; \\ iHorMax = ( xTbCmp ) << iBvShift ; \\ iVerMin = max ( ( ( iTemplateSizeH ) << iBvShift ) , ( yTbCmp - offsetLCBY - nTbH + 1 ) << iBvShift ) ; \\ iVerMax = ( yTbCmp - nTbH ) << iBvShift .$$

In a case where regionId is equal to 4, iVerMin, iVerMax, iHorMin and iHorMax may be calculated as follows:

$$iHorMin = ( xTbCmp - offsetLCBX - nTbW ) << iBvShift ; \\ iHorMax = ( xTbCmp - nTbW ) << iBvShift ; \\ iVerMin = ( yTbCmp + 1 ) << iBvShift ; \\ iVerMax = min ( picHeight - nTbH , ( yTbCmp - offsetLCBY + CtbSizeH - nTbH ) << iBvShift ) .$$

In a case where regionId is equal to 5, iVerMin, iVerMax, iHorMin and iHorMax may be calculated as follows:

$$iHorMin = ( xTbCmp ) << iBvShift ; \\ iHorMax = min ( ( xTbCmp + CtbSizeW - nTbW ) << iBvShift , min ( ( xTbCmp + searchRangeWidth ) << iBvShift , ( ( picWidth - nTbW ) << iBvShift ) ) ) ; \\ iVerMin = max ( ( ( iTemplateSizeH ) << iBvShift ) , ( yTbCmp - offsetLCBY - nTbH + 1 ) << iBvShift ) ; \\ iVerMax = ( yTbCmp - nTbH ) << iBvShift .$$

In practical applications, iHorMin_{regionId}, iHorMaX_{regionId}, iVerMin_{regionId} and iVerMax_{regionId} here represent the left edge, right edge, the top edge, and the bottom edge of different sub-search regions respectively.

In order to intuitively describe the different sub-search regions corresponding to different regionIds, FIG. 19E is fifth a schematic diagram of a determining process of the search region. As illustrated in FIG. 19E, R1, R2, R3, R4, R5, and R6 represent six different sub-search regions, in which R1, R2, R3, and R4 are full reconstruction search regions, and R5 and R6 are pending reconstruction search regions. It should be noted that FIG. 19E is expressed in terms of a sample range with which the top-left corner sample of the block may be aligned.

That is to say, in some embodiments, the search region may be partitioned into two types, one is a region in which all samples have been reconstructed (called the full reconstruction search region), for example, including the four regions R1, R2, R3, and R4 in FIG. 19E; the other is a region in which it is uncertain whether all samples have been reconstructed (called the pending reconstruction search region), for example, including the two regions R5 and R6 in FIG. 19E.

In some embodiments, based on considerations of the full reconstruction search region and the pending reconstruction search region, taking FIG. 7C as an example, the search region is partitioned into six sub-search regions. In order to intuitively describe the different sub-search regions corresponding to different regionIds, FIG. 19F is a sixth schematic diagram of a determining process of the search region. As illustrated in FIG. 19F, R1, R2, R3, R4, R5, and R6 represent six different sub-search regions, in which R1, R2, R3 and R4 are full reconstruction search regions, and R5 and R6 are pending reconstruction search regions. It should be noted that FIG. 19F is expressed in terms of a sample range with which the top-left corner sample of the block may be aligned.

That is to say, in some embodiments, the search region may be partitioned into two types, one is a region in which all samples have been reconstructed (called the full reconstruction search region), for example, including the four regions R1, R2, R3, and R4 in FIG. 19F; the other is a region in which it is uncertain whether all samples have been reconstructed (called the pending reconstruction search region), for example, including the two regions R5 and R6 in FIG. 19F.

In some embodiments, based on considerations of the full reconstruction search region and the pending reconstruction search region, taking FIG. 7D as an example, the search region is partitioned into six sub-search regions. In order to intuitively describe the different sub-search regions corresponding to different regionIds, FIG. 19G is a seventh schematic diagram of a determining process of the search region. As illustrated in FIG. 19G, R1, R2, R3, R4, R5 and R6 represent six different sub-search regions, in which R1, R2, R3, and R4 are full reconstruction search regions, and R5 and R6 are pending reconstruction search regions. It should be noted that FIG. 19G is expressed in terms of a sample range with which the top-left corner sample of the block may be aligned.

That is to say, in some embodiments, the search region may be partitioned into two types, one is a region in which all samples have been reconstructed (called the full reconstruction search region), for example, including the four regions R1, R2, R3 and R4 in FIG. 19F; the other is a region in which it is uncertain whether all samples have been reconstructed (called the pending reconstruction search region), for example, including the two regions R5 and R6 in FIG. 19G.

Furthermore, in the embodiments of the present disclosure, in order to achieve a smaller number of search regions and reduce the amount of code, a part of the full reconstruction search region and a part of the pending reconstruction search region may be selectively merged to form a new pending reconstruction search region, thereby reducing the number of search regions.

In some embodiments, based on considerations of the full reconstruction search region and the pending reconstruction search region, taking FIG. 7A as an example, the search region is partitioned into seven sub-search regions, which are implemented as follows.

In a case where regionId is equal to 0, iVerMin, iVerMax, iHorMin and iHorMax may be calculated as follows:

$$iHorMax = min ( ( xTbCmp + searchRangeWidth ) << iBvShift , ( ( picWidth - nTbW ) << iBvShift ) ) \\ iHorMin = max ( ( iTemplateSizeW ) << iBvShift , ( xTbCmp - searchRangeWidth ) << iBvShift ) \\ iVerMax = ( yTbCmp - nTbH - offsetLCBY ) << iBvShift \\ iVerMin = max ( ( ( iTemplateSizeH ) << iBvShift ) , ( ( yTbCmp - searchRangeHeight ) << iBvShift ) ) .$$

In a case where regionId is equal to 1, iVerMin, iVerMax, iHorMin, iHorMax may be calculated as follows:

$$iHorMin = max ( ( iTemplateSizeW ) << iBvShift , ( xTbCmp - searchRangeWidth ) << iBvShift ) \\ iHorMax = ( xTbCmp - offsetLCBX - nTbW ) << iBvShift ; \\ iVerMin = ( yTbCmp + 1 ) << iBvShift ; \\ iVerMax = min ( picHeight - nTbH , ( yTbCmp - offsetLCBY + CtbSizeH - nTbH ) << iBvShift ) .$$

In a case where regionId is equal to 2, iVerMin, iVerMax, iHorMin and iHorMax may be calculated as follows:

$$iHorMax = ( xTbCmp - nTbW ) << iBvShift ; \\ iHorMin = max ( ( iTemplateSizeW ) << iBvShift , ( xTbCmp - searchRangeWidth ) << iBvShift ) ; \\ iVerMin = max ( ( iTemplateSizeH ) << iBvShift , ( yTbCmp - nTbH ) << iBvShift ) ; \\ iVerMax = ( yTbCmp ) << iBvShift .$$

In a case where regionId is equal to 3, iVerMin, iVerMax, iHorMin, iHorMax may be calculated as follows:

$$iHorMin = max ( ( iTemplateSizeW ) << iBvShift , ( xTbCmp - searchRangeWidth ) << iBvShift ) ; \\ iHorMax = ( xTbCmp ) << iBvShift ; \\ iVerMin = max ( ( ( iTemplateSizeH ) << iBvShift ) , ( yTbCmp - offsetLCBY - nTbH + 1 ) << iBvShift ) ; \\ iVerMax = ( yTbCmp - nTbH ) << iBvShift .$$

In a case where regionId is equal to 4, iVerMin, iVerMax, iHorMin and iHorMax may be calculated as follows:

$$iHorMin = ( xTbCmp - offsetLCBX - nTbW ) << iBvShift ; \\ iHorMax = ( xTbCmp - nTbW ) << iBvShift ; \\ iVerMin = ( yTbCmp + 1 ) << iBvShift ; \\ iVerMax = min ( picHeight - nTbH , ( yTbCmp - offsetLCBY + CtbSizeH - nTbH ) << iBvShift ) .$$

In a case where regionId is equal to 5, iVerMin, iVerMax, iHorMin and iHorMax may be calculated as follows:

$$iHorMin = ( xTbCmp ) << iBvShift ; \\ iHorMax = min ( ( xTbCmp + CtbSizeW - nTbW ) << iBvShift , min ( ( xTbCmp + searchRangeWidth ) << iBvShift , ( ( picWidth - nTbW ) << iBvShift ) ) ) ; \\ iVerMin = max ( ( ( iTemplateSizeH ) << iBvShift ) , ( yTbCmp - offsetLCBY - nTbH + 1 ) << iBvShift ) ;$$

iVerMax=(yTbCmp−nTbH)<<iBvShift.

In a case where regionId is equal to 6, iVerMin, iVerMax, iHorMin and iHorMax may be calculated as follows:

$$iHorMax = ( x TbCmp ) << iBvShift ; \\ iHorMin = ( xTbCmp - nTbW ) << iBvShift ; \\ iVerMin = max ( ( iTemplateSizeH ) << iBvShift , ( yTbCmp - nTbH ) << iBvShift ) ; \\ iVerMax = ( yTbCmp ) << iBvShift .$$

In practical applications, iHorMin_{regionId}, iHorMax_{regionId}, iVerMin_{regionId} and iVerMax_{regionId} here represent the left edge, the right edge, the top edge, and the bottom edge of different sub-search regions, respectively.

In order to intuitively describe the different sub-search regions corresponding to different regionIds, FIG. 19H is an eighth schematic diagram of a determining process of the search region. As illustrated in FIG. 19H, R1, R2, R3, R4, R5, R6 and R7 represent seven different sub-search regions, in which R1, R2, R3, R4, and R7 are full reconstruction search regions, and R5 and R6 are pending reconstruction search regions. It should be noted that FIG. 19H is expressed in terms of a sample range with which the top-left corner sample of the block may be aligned.

It should be noted that, in the embodiments of the present disclosure, for the search region R7, that is, in a case where regionId is equal to 6, the search point at the bottom-right corner of R7 is skipped during the search process because this point coincides with the top-left corner of the current block.

Exemplarily, in the present disclosure, in a case where the prediction value of the current block is determined, for R1 to R6 that do not have an overlapping region with the current block, a simple translation copy may be used for implementation. The specific operations are as follows.

For x=0 . . . nTbW-1, y=0 . . . nTbH-1,

$$predSamples [ x ] [ y ] = recSamples [ x + pX\_BEST ] [ y + pY\_BEST ]$$

Here, recSamples represents the reconstructed samples of the current picture.

Exemplarily, in an embodiment of the present disclosure, in a case where the prediction value of the current block is determined, for R7 that has an overlapping region with the current block, repeated copy and padding may be used for implementation. The BV of this region meets the requirements of pX_BEST=−nTbW+1 . . . 0 and pY_BEST=−nTbH+1 . . . 0, and pX_BEST and pY_BEST are not 0 at the same time. The specific operations are as follows.

For x=0 . . . pX_BEST-1, y=0 . . . pY_BEST-1,

$$predSamples [ x ] [ y ] = recSamples [ x + pX\_BEST ] [ y + pY\_BEST ]$$

Here, recSamples represents the reconstructed samples of the current picture.

For x=pX_BEST-1 . . . nTbW-1, y=pY_BEST-1 . . . nTbH-1,

$$predSamples [ x ] [ y ] = predSamples [ x + pX\_BEST ] [ y + pY\_BEST ] .$$

In the fine search stage, a search is performed near each block vector obtained by the coarse search.

Furthermore, a search is performed near the best block vector BV1_BESTk obtained by the coarse search. In some implementation, the refined search range TmpRefineRange is determined first, which may be a fixed size or related to the size of the current block, for example, it may be set to min (nTbW, nTbH)/2, and then the position of the best matching reconstructed block obtained by the coarse search is calculated and serves as the reference position of the fine search region: BestPosXk=xTbCmp+pX1_BESTk, BestPos Yk=yTbCmp+pY1_BESTk.

Furthermore, the fine search performed according to each BestPosXk may be performed across multiple regions.

The value of bestRegionId involved in the operation is determined: For regionId=0, 1, 2, 3, determinations are made in turn:
in a case where BestPosYₖ-TmpRefineRange>=iVerMin_{regionId}, and BestPosYₖ-TmpRefineRange<=iVerMax_{regionId}, Or
BestPosYₖ+TmpRefineRange>=iVerMin_{regionId}, and BestPosYₖ+TmpRefineRange<=iVerMax_{regionId}, Or
BestPosYₖ− TmpRefineRange<=iVerMin_{regionId}, and BestPosYₖ+ TmpRefineRange>=iVerMax_{regionId}.

Then the regionId sets the corresponding bestSearchFlagregionId to 1.

For each search region with the value of bestSearchFlagregionId being 1, bestRegionId is set as the regionId of the region in turn, and following fine searches are performed, as follows.

Firstly, according to the value of bestRegionId, the values of iHorMin_{bestRegionId}, iHorMax_{bestRegionId}, iVerMin_{bestRegionId} and iVerMax_{bestRegionId} calculated above are obtained first, and then the new search ranges iHorMin_{refine}, iHorMax_{refine}, iVerMin_{refine} and iVerMax_{refine} are obtained according to the best matching block position obtained by the coarse search. The acquisition method is as follows:

$${iHorMin}_{refine} = max ( {iHorMin}_{bestRegionId} , BestPosX - TmpRefineRange ) ; \\ {iHorMax}_{refine} = min ( {iHorMax}_{bestRegionId} , BestPosX + TmpRefineRange ) ; \\ {iVerMin}_{refine} = max ( {iVerMin}_{bestRegionId} , BestPosY - TmpRefineRange ) ; \\ {iVerMax}_{refine} = min ( {iVerMax}_{bestRegionId} , BestPosY + TmpRefineRange ) .$$

Then, the adjusted block vectors BVs bvXMins, bvXMaxs, bvYMins and bvYMaxs may be calculated by iVerMin_{refine}, iVerMax_{refine}, iHorMin_{refine}, and iHorMax_{refine}:

$$bvXMins = {iHorMin}_{refine} - xTbCmp ; \\ bvXMaxs = {iHorMax}_{refine} - xTbCmp ; \\ bvYMins = {iVerMin}_{refine} - yTbCmp ; \\ bvYMaxs = {iVerMax}_{refine} - yTbCmp ;$$

In this way, the fine search is performed within the block vector range where pX is between bvXMins_{regionId} and bvXMaxS_{regionId} and pY is between bvYMins_{regionId} and bvYMaxS_{regionId}. For example, the search is performed with a step of 1, the best matching cost value obtained by template matching is recorded as pDiff_BEST, and the block vector BV corresponding to the best matching cost value is recorded as the best block vector BV_BEST (pX_BEST, pY_BEST); so as to obtain a total of best block vectors of multiple regions participating in the search.

After completing the above operations, the component block vector BV_BEST (pX_BEST, pY_BEST) may be obtained, where pX_BEST and pY_BEST are the horizontal offset and the vertical offset of the best matching template relative to the template of the current block, and pX_BEST and pY_BEST are also the horizontal offset and the vertical offset of the best matching block relative to the current block.

In summary, a technology of intra template matching prediction based on filter-based linear model (Intra TMP-FLM) is proposed in the embodiments of the present disclosure, the filter-based linear model established by using the template information of the matching template and the current block, the correlation between the matching template and the template of the current coding block is full used, and the reconstructed samples of the best matching block (i.e., the reference block) are filtered and corrected, and the filtered reconstructed samples are used as predicted samples, thereby improving the prediction accuracy to a certain extent; and effectively solving the problem of linear changes existing between the best matching block and the current block.

In the embodiments of the present disclosure, the exemplary implementation of the above embodiments is described in detail through the above embodiments, from which it may be seen that according to the technical solution of the above embodiments, the prediction value of the template matching technology may be effectively corrected, thereby improving the prediction accuracy. In some implementation, the filter-based linear model is established between the best matching template obtained by performing a search via the initial vector parameter and the template of the current block. The filter coefficient is calculated by minimizing the MSE between the predicted template (predicted template=filter coefficient×matching template) and the template of the current coding block. The filter coefficient fully reflects the correlation between the matching template and the template of the current block, and this correlation is applied to the best matching block, and the reconstructed samples of the best matching block are filtered and corrected. Finally, the filtered reconstructed samples are used as predicted samples, thereby improving the prediction accuracy.

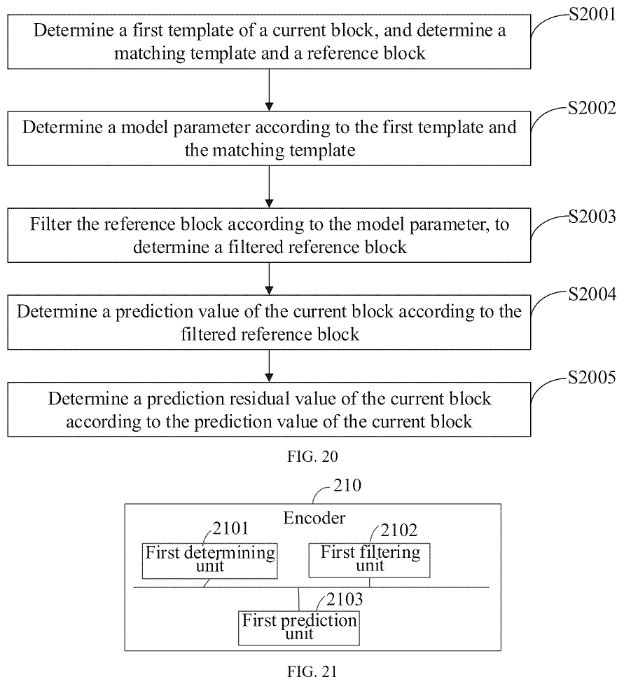

In another embodiment of the present disclosure, referring to FIG. 20, a schematic flowchart of an encoding method provided in the embodiments of the present disclosure is illustrated. As illustrated in FIG. 20, the method may include following steps.

In S2001, a first template of a current block is determined, and a matching template and a reference block are determined.

It should be noted that the encoding method in the embodiments of the present disclosure is applied to the encoder. In addition, the encoding method may be called a prediction method of template matching based on a filter-based linear model (TM-FLM). In some embodiments, the encoding method may refer to an intra prediction method, in some implementation, an intra prediction method based on a technology of intra template matching prediction based on filter-based linear model (Intra TMP-FLM), or an intra prediction method based on an intra block copy based on filter-based linear model (IBC-FLM). A video picture may be partitioned into multiple coding blocks, and the current block in the embodiments of the present disclosure refers to a coding block that is currently to be intra predicted in the video picture, and the reference block is a reconstructed block within a current picture. In addition, the encoding method in the embodiments of the present disclosure may be used to predict both the luma component and the chroma component, which is not limited here in detail.

It should also be noted that, in the embodiments of the present disclosure, the first template of the current block needs to be determined first. In some embodiments, determining the first template of the current block may include: determining a template type of the current block; and determining the first template of the current block according to the template type of the current block.

Here, the template type may be represented by refTemplateType. In some embodiments, determining the template type of the current block may include: determining the template type of the current block according to reference samples of the current block; or decoding a bitstream, to determine the template type of the current block; or determining the template type of the current block according to a size of the current block.

Here, the reference samples of the current block include at least one of: left neighbouring reference samples of the current block, top neighbouring reference samples of the current block, top-left neighbouring reference samples of the current block, bottom-left neighbouring reference samples of the current block, and top-right neighbouring reference samples of the current block.

Furthermore, according to whether the neighbouring reference samples are available, the template type may be classified and the template type of the current block may be determined. In some embodiments, determining the template type of the current block may include:
in response to that the left neighbouring reference samples of the current block, the top neighbouring reference samples of the current block, and the top-left neighbouring reference samples of the current block are all available, determining that the template type of the current block is a first value;
in response to that the left neighbouring reference samples of the current block are available, determining that the template type of the current block is a second value;
in response to that the top neighbouring reference samples of the current block are available, determining that the template type of the current block is a third value;
in response to that the left neighbouring reference samples of the current block and the top-left neighbouring reference samples of the current block are both available, determining that the template type of the current block is a fourth value;
in response to that the left neighbouring reference samples of the current block and the bottom-left neighbouring reference samples of the current block are both available, determining that the template type of the current block is a fifth value; or
in response to that the top neighbouring reference samples of the current block and the top-right neighbouring reference samples of the current block are both available, determining that the template type of the current block is a sixth value.

In the embodiments of the present disclosure, the first value, the second value, the third value, the fourth value, the fifth value and the sixth value may be different. Exemplarily, the first value may be set to 1, the second value may be set to 2, the third value may be set to 3, the fourth value may be set to 4, the fifth value may be set to 5, and the sixth value may be set to 6. In addition, for the six template types, refer to FIG. 3A to FIG. 3F for details.

In some embodiments, determining the first template of the current block according to the template type of the current block may include: obtaining template samples of the current block according to the template type of the current block and a corresponding size of the template; and determining the template samples of the current block as the first template of the current block.

In the embodiments of the present disclosure, the size of the template may be preset, or may be determined according to the size of the current block, or may even be related to the template type of the current block, which is not limited here in detail. Exemplarily, in response to that the template type indicates that only the left template is obtained, the template width templateW_size may be set to 4; in response to that the template type indicates that only the top template is obtained, the template height templateH_size may be set to 4.

In the embodiments of the present disclosure, the reconstructed samples of which part the first template obtains may be determined based on a value of the template type. For example, in a case where the value of refTemplateType is 1, the left reconstructed samples, the top-left reconstructed samples and the top reconstructed samples of the current block are obtained; in a case where the value of refTemplate Type is 2, only the left 4 columns of reconstructed samples of the current block are obtained; and in a case where the value of refTemplateType is 3, only the top 4 rows of reconstructed samples of the current block are obtained.

For the matching template and the reference block, in a possible implementation, determining the matching template and the reference block may include: determining a vector parameter and a reference block corresponding to the vector parameter; and determining the matching template according to the first template and the reference block.

Accordingly, in some embodiments, the method may further include: encoding the vector parameter, and signalling an obtained encoded bit into a bitstream. That is to say, after determining the vector parameter (e.g., a BV), the encoding end may signal the vector parameter into the bitstream; subsequently, the decoding end may directly determine the vector parameter according to the decoded bitstream, and then determine the reference block of the current block, and then determine the matching template from the reference block according to the first template of the current block.

For the matching template and the reference block, in another possible implementation, determining the matching template and the reference block may include: performing template matching within a search region according to the first template, to determine the matching template; and determining the reference block according to the matching template.

In some embodiments, performing template matching in the search region according to the first template, to determine the matching template may include: performing the search within the search region according to the first template, to determine a target vector parameter, and determining the matching template according to the target vector parameter.

In another possible implementation, determining the matching template may include: performing template matching within the search region according to the first template, to determine the matching template, including: determining an initial vector parameter of a current block; determining a search region according to the initial vector parameter; performing the search within the search region based on the template matching, to determine the target vector parameter; and determining the matching template according to the target vector parameter and the first template.

In a possible implementation, determining the initial vector parameter of the current block includes: determining to construct a vector parameter candidate list of the current block according to a prediction mode parameter of the current block; and determining the initial vector parameter according to the vector parameter candidate list. The prediction mode parameter is used for indicating a relevant parameter of the prediction mode of the current block. In a possible implementation, determining the initial vector parameter according to the vector parameter candidate list includes: obtaining a vector parameter at a preset position (e.g., a first vector parameter) from the vector parameter candidate list as the initial vector parameter.

In a possible implementation, determining to construct the vector parameter candidate list of the current block according to the prediction mode parameter of the current block includes: determining to construct a merge vector parameter candidate list of the current block according to the prediction mode parameter of the current block; or determining to construct an AMVP vector parameter candidate list of the current block according to the prediction mode parameter of the current block.

In a possible implementation, the initial vector parameter of the current block is determined as a preset vector parameter according to the prediction mode parameter of the current block. In some embodiments, an initial block vector of the Intra TMP is 0. In yet another embodiment, an initial block vector parameter of the Intra TMP is a vector parameter obtained by performing a coarse search within the search region, and correspondingly, the target vector parameter is a vector parameter obtained by performing a fine search within the search region.

In a possible implementation, determining the search region according to the initial vector parameter includes: determining the search region according to the initial vector parameter and a preset search range. Exemplarily, the reference block is determined according to the initial vector parameter and the current block; and the search region is determined according to the reference block and the preset search range. The search region includes reconstructed samples.

It should be noted that the search range may be preset, or may be transmitted via a bitstream, or may be adaptively selected according to information such as a block size.

In a possible implementation, the determining method of the preset search range includes at least one of: using a preset horizontal component search range as a horizontal component search range of the preset search range; using a preset vertical component search range as a vertical component search range of the preset search range; or determining, according to a size of the current block, a horizontal component search range of the preset search range and/or a vertical component search range of the preset search range.

In a possible implementation, determining the search region according to the initial vector parameter includes: in response to that an inter prediction mode is determined according to a prediction mode parameter of the current block, determining the search region within a reference picture according to the initial vector parameter; or in response to that an intra prediction mode is determined according to a prediction mode parameter of the current block, determining the search region within a current picture according to the initial vector parameter.

In a possible implementation, in response to that an intra prediction mode is determined according to a prediction mode parameter of the current block, the search region includes at least one of: a partial region of a reconstructed coding tree block of a current picture, an entire region of a reconstructed coding tree block of a current picture, an entire reconstructed region of a current coding tree block where the current block is located, or a partial reconstructed region of a current coding tree block where the current block is located.

In a possible implementation, performing the search within the search region based on the template matching, to determine the target vector parameter includes: performing the search within the search region, to determine reference templates, and calculating a respective matching cost value between each of the reference templates and the first template; and determining a vector parameter of a reference template corresponding to a minimum matching cost value as the target vector parameter. Exemplarily, available reference templates are determined by performing the search within the search region.

In a possible implementation, a determination condition for availability of the reference templates includes at least one of: a first sample within a template not exceeding a boundary of a picture where the first sample is located; a second sample within a reference block corresponding to a template not exceeding a boundary of a picture where the second sample is located; a first sample within a template not exceeding the search region; a second sample within a reference block corresponding to a template not exceeding the search region; a first sample within a template having been reconstructed; or a second sample within a reference block corresponding to a template having been reconstructed.

In a possible implementation, the determination condition for availability of the reference templates includes at least one of: a first sample within a template and the current block being within a same sub-picture; a second sample within a reference block corresponding to a template and the current block being within a same sub-picture; or a second sample within a reference block corresponding to a template not being within the current block. Exemplarily, the sub-picture may include a plurality of coding tree units. Exemplarily, the sub-picture may be a Tile.

In a possible implementation, the first sample is each sample within the template, or a first identification sample which is preset. The first identification sample includes a sample in at least one corner position within the template.

In a possible implementation, the second sample is each sample within the reference block corresponding to the template, or a second identification sample which is preset. The second identification sample includes a sample in at least one corner position within the reference block corresponding to the template. In some implementation, whether the sample is located within the preset picture may be determined by whether coordinates of the sample are within a valid coordinate range of a preset picture region.

It should be noted that the sample may be each of the samples within the template or within a reconstructed block corresponding to the template or a sample at a preset specific position. In some embodiments, the identification sample within the template refers to one or more samples located within a corner position of a template region. For example, in a case where there is only a top template, the identification sample refers to a sample at a top-left corner of the top template region and a sample at a bottom-right corner of the top template region; or the identification sample refers to only the sample at the bottom-right corner. The identification sample within the reconstructed block corresponding to the template refers to one or more samples located within a corner position of a reconstructed block region. For example, the identification sample refers to a sample at a top-left corner of the reconstructed block region and a sample at a bottom-right corner of the reconstructed block region; or the identification sample refers to only the sample at the bottom-right corner of the reconstructed block region.

That is to say, searching may be performed within a search region according to the first template, and a matching template with a minimum cost value relative to the first template is searched out according to a preset cost function. Here, one or more candidate vector parameters may be obtained by traversing all search points within the search region, where the one or more candidate vector parameters may indicate one or more candidate matching templates; cost calculation is respectively performed on each of the one or more candidate matching templates with the first template of the current block, and a search point with a minimum cost value is obtained through comparison, and a candidate vector parameter corresponding to the minimum cost value is a best vector parameter (i.e., the target vector parameter, BV_BEST); a candidate matching template corresponding to the minimum cost value is a best matching template (i.e., the matching template in the embodiment, T_BEST); and the reference block may be determined according to the best matching template. In the embodiments of the present disclosure, the target vector parameter may be understood as the best vector parameter or a matching vector parameter. Exemplarily, the vector parameter for the inter prediction mode may be the MV, and the vector parameter for the intra prediction mode may be the BV.

In embodiments of the present disclosure, the preset cost function may be the sum of absolute difference (SAD), the sum of absolute transformed difference (SATD), the mean square error (MSE), the sum of squared differences (SSD), the mean absolute deviation (MAD), the mean square differences (MSD), the normalized correlation coefficient (NCC), or the like, which is not limited here in detail.

It may be understood that the search process within the search region may be a coarse search, or a fine search, or a coarse search first and then a fine search; the details are as follows.

In a possible implementation, performing the search within the search region based on the template matching, to determine the target vector parameter may include: performing a first search within the search region, to determine the target vector parameter; or performing a second search within the search region, to determine the target vector parameter; where a search step corresponding to the first search is greater than a search step corresponding to the second search.

In another possible implementation, performing the searching within the search region based on the template matching, to determine the target vector parameter includes: performing a first search within the search region, to determine a first vector parameter, and determining an initial matching template according to the first vector parameter; determining a first search region according to the initial matching template, and performing a second search within the first search region, to determine the target vector parameter; where a search step corresponding to the first search is greater than a search step corresponding to the second search, and the first search region is smaller than the search region.

It should be noted that, in the embodiments of the present disclosure, the search step corresponding to the first search is greater than the search step corresponding to the second search. Exemplarily, the search step corresponding to the first search is 2, and the search step corresponding to the second search is 1. Alternatively, a downsampling factor corresponding to the first search is greater than a downsampling factor corresponding to the second search. Exemplarily, the downsampling factor corresponding to the first search is 4, and the downsampling factor corresponding to the second search is 2. That is to say, the first search is the coarse search, and the second search is the fine search, which is not limited in detail as long as it may reflect a feature that the first search is coarser than the second search.

It should also be noted that in a case where the first search is performed first and then the second search is performed, not only the search step corresponding to the first search is greater than the search step corresponding to the second search, but also the first search region is smaller than the search region. The first search region is a search region near the initial matching template. Exemplarily, a best coarse matching template may be first determined within the search region with a step of 2; and then a best fine matching template (i.e., a final matching template) may be determined near the best coarse matching template with a step of 1.

In yet another possible implementation, the search region includes at least one sub-search region; performing the search within the search region based on the template matching, to determine the target vector parameter includes: performing the search within each of the at least one sub-search region respectively, to determine a respective best vector parameter corresponding to each sub-search region and a respective matching cost value corresponding to each best vector parameter; determining a best vector parameter corresponding to a minimum matching cost value according to the respective best vector parameter corresponding to each sub-search region and the matching cost value corresponding to the respective best vector parameter; and using the best vector parameter corresponding to the minimum matching cost value as the target vector parameter.

In a possible implementation, performing the search within the search region based on the template matching, to determine the target vector parameter includes: performing a first search within each of the at least one sub-search region respectively, to determine a respective best vector parameter corresponding to each sub-search region and a respective second search region corresponding to each best vector parameter; performing region determination according to the respective best vector parameter corresponding to each sub-search region and the respective second search region corresponding to each best vector parameter, to determine at least two target sub-search regions participating in a second search; performing the second search within the at least two target sub-search regions, to determine a best vector parameter corresponding to the at least two target sub-search regions; and using the best vector parameter corresponding to the at least two target sub-search regions as the target vector parameter.

It should be noted that, in the embodiments of the present disclosure, for the intra prediction technology, the search region of the template of the current block may be a reconstructed part of the CTB where the current block is located, or may be other reconstructed CTB regions. The search region here is actually a collection of all search points. Since a shape of the region is often not representable by a single rectangular region, in an exemplary implementation, a search may be performed within multiple rectangular regions, and then search results of different regions are taken into consideration, to obtain a final best reference block and a final best block vector.

It should also be noted that in the embodiments of the present disclosure, still taking FIG. 7F as an example, the search region is partitioned into four sub-search regions, each of the sub-search regions is represented by regionId, and a value of regionId may be equal to 0, 1, 2 and 3. Through a respective search point (iPosHor, iPox Ver) within each of the sub-search regions, that is, a respective block vector BV (consisting of a horizontal component and a vertical component: (pX, pY), where pX=iPosHor-xTbCmp, pY=iPosVer-yTbCmp, then pX is between bvXMins and bvXMaxs, and pY is between bvYMins and bvYMaxs), a reference block matching the current block may be found within a reconstructed region, and neighbouring reconstructed samples of the reference block are the matching template. In this way, a matching cost value between the first template and the matching template of the current block may be calculated, and the matching cost value is recorded as pDiff.

In this way, all search points within all search ranges (regionId=0, 1, 2, 3) are traversed, and a search point with the minimum matching cost value pDiff is obtained through comparison. The matching cost value corresponding to this search point is recorded as pDiff_BEST, and a block vector corresponding to this search point is recorded as a best block vector BV_BEST (pX_BEST, pY_BEST), which is the target block vector of the embodiment; a best matching template T_BEST corresponding to this search point is the matching template finally required.

In a possible implementation, determining the reference block includes: determining the reference block according to the target vector parameter. Exemplarily, the reference block is determined according to the current block and the target vector parameter.

In another possible implementation, the method further includes: determining a value of first syntax element flag information; where the first syntax element flag information is used for indicating whether template matching is applied to the current block; encoding the value of the first syntax element flag information, and signalling the obtained encoded bits into a bitstream.

In yet another possible implementation, the method further includes: determining a value of third syntax element flag information; where the third syntax element flag information is used for indicating the reference block of the current block; encoding the value of the third syntax element flag information, and signalling the obtained encoded bits into a bitstream.

In yet another possible implementation, the method further includes: the first syntax element flag information being used for indicating that the template matching is applied to the current block (or determining that the template matching is applied to the current block), to determine a value of third syntax element flag information; and determining the reference block of the current block according to the value of the third syntax element flag information.

It should be noted that the encoding end transmits a Flag indicating which filtered reference block is used as a final prediction block. tmpFlag is used for indicating whether template matching is applied to the current coding block, and filterIdx is used for indicating a filtering model is applied to which reference block within the current search range. In a case where tmpFlag is 1, by comparing distortions between reference blocks which are applied with filter coefficients within the search range and the current original block, such as the SAD, the MSE, the SATD or sum of squared errors (SSE), the encoding end selects a best reference block and transmits an index corresponding to the best reference block to the decoding end.

In another possible implementation, in a case where template matching being applied to the current block is determined, traversing a search region to search for multiple reference blocks, and filtering each of the multiple reference blocks according to a respective model parameter, to determine a respective filtered reference block; calculating a respective distortion parameter between the respective filtered reference block and a current original block; determining a reference block corresponding to a minimum distortion parameter; and determining the value of the third syntax element flag information according to the reference block corresponding to the minimum distortion parameter.

It should be noted that, for each of templates within the search range, the filter coefficients of the template are solved and the template is filtered, and Cost between the template and the current template is calculated, so as to decide which template is to be used. That is, the filter coefficients are calculated for part or all of the templates to be searched within the search range, and then the filter coefficients are applied to the template to be searched, and the Cost between the template to be searched and the current template is calculated. A best matching template after filtering is selected according to the Cost, and a reference block corresponding to the best matching template is filtered and used as a final prediction value.

In another possible implementation, the method further includes: traversing a search region to search for multiple reference templates, and determining a respective model parameter according to the first template and each of the multiple reference templates; filtering each of the multiple reference templates according to the respective model parameter, to obtain a respective filtered reference template; calculating a respective matching cost value between the respective filtered reference template and the first template; and determining a reference block of a reference template corresponding to a minimum matching cost value as the reference block of the current block.

In S2002, a model parameter is determined according to the first template and the matching template.

It should be noted that, in the embodiments of the present disclosure, the model parameter may include coefficients of a target filter. In some embodiments, the method may further include: determining coefficients of the target filter according to sample reference values within the first template and sample reference values within the matching template.

It should also be noted that, in the embodiments of the present disclosure, the coefficients of the target filter may be determined by solving an optimization problem. Accordingly, in some embodiments, the method may further include: the coefficients of the target filter being coefficients used by the target filter when a first error between an output value of the sample reference value within the matching template after being processed by the target filter and the sample reference value within the first template meets a first condition.

It should be understood that for the first error meeting the first condition, in a possible implementation, the first condition is that the first error is minimum. Alternatively, in another possible implementation, the first condition is that the first error is within a first preset threshold range. Alternatively, in yet another possible implementation, the first condition is that a variation in the first error is within a second preset threshold range.

It should also be understood that the first preset threshold range and the second preset threshold range are both measurement criteria preset by the decoding end for determining whether the first error meets the first condition. In addition, the first error here may be the mean square error (MSE), the sum of squared errors (SSE), the sum of absolute difference (SAD), the sum of absolute transformed difference (SATD), mean absolute error (MAE), or the like, which is not limited in the embodiments of the present disclosure in detail.

In some embodiments, determining coefficients of the target filter according to the sample reference values within the first template and the sample reference values within the matching template may include:
determining autocorrelation parameters according to the sample reference values within the matching template;
determining cross-correlation parameters according to the sample reference values within the first template and the sample reference values within the matching template;
determining the coefficients of the target filter according to the autocorrelation parameters and the cross-correlation parameters.

It should be noted that, in the embodiments of the present disclosure, each of the sample reference values includes at least one of: a sample reconstructed value, a sample gradient value, or sample position information.

That is to say, in the embodiments of the present disclosure, the target filter serves as a filter model in the embodiments of the present disclosure, and input information of the target filter is the sample reference values within the matching template. Here, the coefficients of the target filter may be represented by c_{k,l}, which may also be called filter coefficients in the embodiment. Here, the input information used for calculating the filter coefficients may be available reconstructed samples of the matching template; alternatively, it may be gradient of each of the reconstructed samples within the matching template, including but not limited to horizontal gradient, vertical gradient, or the like, and calculated gradient is used as the input information for calculating the filter coefficients; alternatively, it may be position information of each of the reconstructed samples as the input information for calculating the filter coefficients, where the position information may be absolute position information of each of the reconstructed samples within the entire picture, or relative position information of each of the reconstructed samples relative to a reference point, which is not limited here in detail.

In an exemplary implementation, a reconstruction region R used for calculating the filter coefficients is first determined, and then a set of filter coefficients may be derived by minimizing the MSE between the reconstructed samples within the region R and the reconstructed samples of the first template, as shown in the above formulas (3) and (4).

Furthermore, the process of minimizing the MSE to derive the filter coefficients is as follows.

Firstly, the partial derivative of c_{k,l} is found and it is made to equal to 0, which is shown in the above formulas (5) and (6); where k and l are between −1 and 1, and m and n are between −1 and 1.

Secondly, according to the formulas (5) and (6), a formula shown in the formula (7) may be sorted out.

Thirdly, after the reconstructed region R is determined, formula (7) is expanded into a matrix form, as shown in the formulas (8) to (10).

In this way, since the autocorrelation matrix of refTemp and the cross-correlation vector of refTemp and rec Temp within the reconstructed region R are known quantities, the filter coefficient C_{k,l} may be calculated by solving the formula group shown in the formula (7), and the filter coefficient C_{k,l} may be fixed-point or not.

In addition, in the embodiments of the present disclosure, for the target filter, the number of coefficients of the target filter and the shape of the target filter further need to be determined. The number of coefficients of the target filter and the shape of the target filter may be preset fixed values, or may be associated with the size of the current block.

In some embodiments, for the number of coefficients of the target filter, the method may further include: the number of coefficients of the target filter is equal to a first preset value.

In some embodiments, for the number of coefficients of the target filter, the method may further include: determining the number of coefficients of the target filter; encoding the number of coefficients of the target filter, and signalling the obtained encoded bits into a bitstream.

It should be noted that the number of coefficients of the target filter may be represented by nTap. Exemplarily, a value of nTap may be 4, 5, 6, 7, 8, 9, or the like, but which is not limited here in detail.

It should also be noted that the number of coefficients of the target filter may also be called the number of taps of the target filter. Here, the number of coefficients of the target filter may be a preset constant value, or may be determined according to the size of the current block, which is not limited here in detail.

In some embodiments, for the shape of the target filter, the method may further include: the target filter being a one-dimensional or two-dimensional filter of a preset shape.

In some embodiments, for the shape of the target filter, the method may further include: determining the shape of the target filter; encoding the shape of the target filter, and signalling the obtained encoded bits into a bitstream.

In some embodiments, the method may further include: determining a value of a filter shape parameter, where the filter shape parameter indicates a shape of the target filter. Furthermore, the method may further include: encoding the values of the filter shape parameter, and signalling the obtained encoded bits into a bitstream.

It should be noted that the filter shape parameter may be represented by FilterIdx, and FilterIdx is used for indicating the shape of the target filter. Exemplarily, the shape of the target filter may be a diamond, a rectangle, a cross, a stripe, even a one-dimensional filter, a two-dimensional filter, or the like, but which is not limited here in detail.

Exemplarily, in a case where a value of FilterIdx is equal to 0, the shape of the target filter is determined to be the diamond; in a case where a value of FilterIdx is equal to 1, the shape of the target filter is determined to be the cross; in a case where a value of FilterIdx is equal to 2, the shape of the target filter is determined to be the rectangle.

It should also be noted that the shape of the target filter may be a preset shape, or may be determined by the value of the filter shape parameter, or may even be determined according to the size of the current block, which is not limited here in detail.

In S2003, the reference block is filtered according to the model parameter, to determine a filtered reference block.

In S2004, a prediction value of the current block is determined according to the filtered reference block.

It should be noted that, in the embodiments of the present disclosure, after the model parameter is determined, the prediction value of the current block may be determined according to the model parameter and the reference block. In some implementation, the reference block is filtered according to the model parameter, and then the prediction value of the current block is determined according to the filtered reference block.

In some embodiments, filtering the reference block according to the model parameter, to determine the filtered reference block may include: filtering the reference block according to the model parameter, to determine a first output value of the target filter; and determining the filtered reference block according to the first output value of the target filter.

In the embodiments of the present disclosure, the first output value of the target filter may be calculated according to the sample reconstructed values of the reference block and the coefficients of the target filter in the model parameter; and then the filtered reference block may be determined according to the first output value of the target filter. The target filter here may be a filter-based linear model or a filter-based nonlinear model, which is not limited here in detail.

In a possible implementation, filtering the reference block according to the model parameter, to determine the filtered reference block may include: calculating a product of a sample reconstructed value of the reference block and a coefficient of the target filter corresponding to the sample reconstructed value; setting a first output value of the target filter to be equal to a sum of n products; where n represents the number of coefficients of the target filter and n is a positive integer; and determining the filtered reference block according to the first output value of the target filter.

In a possible implementation, calculating the respective product of each of sample reconstructed values of the reference block and the respective coefficient of the target filter corresponding to each sample reconstructed value may include: calculating a product of a sample reference value of a second boundary padding region corresponding to the reference block and a coefficient of the target filter corresponding to the sample reference value of the second boundary padding region; and/or calculating a product of a sample reference value of a reference template corresponding to the reference block and a coefficient of the target filter corresponding to the sample reference value of the reference template. For padding boundary samples, it is considered that the filter may use reconstructed samples outside the reference template and the reference block, so that the boundary samples need to be padded, where depending on the filter shape, regions that need to be padded at the boundary are different. Padded boundary samples may be applied to determination of the model parameter and/or prediction of the current block.

It should be noted that the target filter in the embodiments of the present disclosure is the filter-based linear model. The first output value of the target filter may be calculated via the formula (11).

In another possible implementation, filtering the reference block according to the model parameter, to determine the first output value of the target filter may include:
determining first values of the sample reconstructed values of the reference block under a first mapping relationship;
calculating a respective product of each of the first values and a respective coefficient of the target filter corresponding to each first values; and
setting the first output value of the target filter to be equal to a sum of n products; where n represents a number of coefficients of the target filter, and n is a positive integer.

It should be noted that the target filter in the embodiments of the present disclosure is the filter-based nonlinear model. Exemplarily, in a case where minimizing the MSE of the filter coefficients, it may be calculated by the formulas (12) and (13).

It should also be noted that, in the embodiments of the present disclosure, the filtered reference block is determined according to the first output value of the target filter. The first output value of the target filter may be directly set as the filtered reference block; or a first filtering may be performed on the first output value of the target filter, to obtain the filtered reference block; the first filtering here may be a low-pass filtering, an upsampling filtering/downsampling filtering, or the like, which is not limited here in detail.

It should also be noted that, in the embodiments of the present disclosure, after the first output value of the target filter is determined, a first offset value (expressed as bias) may be added to the first output value, to determine the filtered reference block.

In some embodiments, determining the filtered reference block according to the first output value of the target filter may include: determining a first offset value; and performing an addition operation according to the first output value and the first offset value, to determine the filtered reference block.

In a possible implementation, determining the first offset value may include: setting the first offset value to be equal to a second preset value.

In another possible implementation, determining the first offset value may include: in response to that the number of coefficients of the target filter is n, determining an (n+1)th coefficient of the target filter; and determining the first offset value according to the (n+1)th coefficient and a second offset value.

In the embodiments of the present disclosure, for the second offset value, the method may further include: setting the second offset value equal to a third preset value; or setting the second offset value equal to a value of a sample reconstructed value of the reference block under a second mapping relationship.

It should be noted that, in the embodiments of the present disclosure, the number of the calculated filter coefficients are used as the number of taps corresponding to the filter template, that is, the number of filter coefficients is equal to the number of taps nTap of the filter template. In addition, several bias terms (bias) may be added to the filter template. Exemplarily, in the embodiments of the present disclosure, in a case where nTap=5, the filter coefficients are the tap coefficient c₀ to c₄ corresponding to the filter template, and a prediction value of a position (i, j) in the filtered reference block is calculated as shown in the formulas (14) and (15).

Furthermore, in some embodiments, determining the prediction value of the current block according to the filtered reference block may include: performing a first process on the filtered reference block, to obtain the prediction value of the current block.

In the embodiments of the present disclosure, for the first process, the first process may be to set the prediction value of the current block to be equal to the filtered reference block; alternatively, the first process may be a clip operation that limits the filtered reference block to a preset value range, alternatively, the first process may be other operations, which are not limited here in detail.

Here, for the clip operation, the preset value range may be between 0 and (1<<BitDepth)-1, where BitDepth represents bit depth. In response to that the value of the filtered reference block exceeds the preset value range, a corresponding correction operation needs to be performed on the filtered reference block. Exemplarily, the filtered reference block may also be represented by Y^{pred}[i][j], and in this case, a correction operation may be performed on Y^{pred}[i][j], details are as follows:
in a case where the value of Y^{pred}[i][j] is less than 0, setting the value to 0;
in a case where the value of Y^{pred}[i][j] is greater than or equal to 0 and less than or equal to (1<<BitDepth)-1, setting the value equal to Y^{pred}[i][j];
in a case where the value of Y^{pred}[i][j] is greater than (1<<BitDepth)-1, setting the value to (1<<BitDepth)-1.

In this way, after the correction operation is performed on Y^{pred}[i][j], it may be ensured that all sample values in the filtered reference block are between 0 and (1<<BitDepth)-1.

Furthermore, the number of filter models may be expanded. In addition to establishing only one filter model, multiple filter models may also be established. Therefore, in some embodiments, the method may further include:
determining multiple groups of model parameters according to the first template and the matching template;
constructing multiple filter models according to multiple groups of model parameters, filtering the reference blocks according to the multiple filter models respectively, and determining multiple filtered reference blocks; and
determining the prediction value of the current block according to the multiple filtered reference blocks.

In some embodiments, determining the multiple groups of model parameters according to the first template and the matching template may include: classifying the reconstructed samples within the first template and the reconstructed samples within the matching template in a preset manner, to obtain multiple groups of sub-templates and multiple groups of sub-matching templates; determining multiple groups of model parameters according to the multiple groups of sub-templates and the multiple groups of sub-matching templates.

It should be noted that in the embodiments of the present disclosure, the preset manner here may be a size of a reconstructed sample value, or may be position information of a reconstructed sample, or may be a filter shape, or the like, which is not limited here. After performing classifying according to a preset manner, each group of the sub-templates and respective sub-matching templates corresponding to each group of the sub-templates may be used to calculate a respective group of model parameters, and each group of the model parameters may be used to determine a filter model, so that multiple filter models may be constructed.

In a possible implementation, the method may further include: determining a target filter from multiple filter models; and filtering the reference block according to the target filter, to determine the prediction value of a current block.

Furthermore, in some embodiments, the method may further include: determining an index value of a target model, where the target model index value is used for indicating an index number of the target filter in the multiple filter models; encoding the index value of the target model, and signalling the obtained encoded bits into a bitstream.

Furthermore, in some embodiments, determining the target filter from the multiple filter models may include: determining an original value of the current block; performing a respective rate-distortion cost calculation according to the original value of the current block and each of multiple initial prediction values of the current block to determine a respective rate-distortion cost value of each of the multiple initial prediction values; determining a minimum rate-distortion cost value from rate-distortion cost values of the multiple initial prediction values; and using a filter model corresponding to the minimum rate-distortion cost value as the target filter.

In another possible implementation, the reference block is filtered according to multiple filter models respectively, and the multiple filtered reference blocks may be determined. In some embodiments, determining the prediction value of the current block according to multiple filtered reference blocks may include: performing weighting calculation on the multiple filtered reference blocks, to determine the prediction value of the current block.

It should also be noted that in a case where a respective weighting factor of each filtered reference block is equal and equal to a reciprocal of the number of reference blocks; the weighting calculation here may also be regarded as an average calculation. In other words, an average value of multiple filtered reference blocks is calculated, to determine the prediction value of the current block.

Exemplarily, multiple pieces of input information for calculating the filter coefficients are classified, and a respective filter model is established for each type of input information. For example, in a case where a filter model is established by using reconstruction information, a possible implementation is to classify by a mean of the reconstruction information, a filter model is established for reconstruction information greater than the mean, and a filter model is established for reconstruction information less than the mean. Another possible implementation is to classify by using a position of the reconstruction information. For example, a filter model may be established by using the available reconstruction information on the left side and the top side, and a second model may be established by using the available reconstruction information on the left side and the top-left side, and so on. The encoding end decides which model to use. One possible decision-making manner is that the encoding end decides which model to use through rate-distortion optimization and transmits the corresponding decoding parameters to the decoding end, so that it may be clear by the decoding end about which filter model to select in subsequence. Another possible implementation is to classify filters by their shapes. Multiple filters of different shapes may be used, and a filter model is established for filter of each shape. The encoding end decides a filter of which shape to use. One possible decision-making manner is that the encoding end decides which filter to use by rate-distortion optimization and transmits the corresponding decoding parameter to the decoding end, so that it may be clear by the decoding end about which filter model to select in subsequence.

For solutions that extend multiple models and the multiple filter shapes, the decoding end may sort the solutions by template prediction distortion and select the solution with the minimum template prediction distortion as the final selected solution.

Alternatively, the encoding end and decoding end sort various solutions by template prediction distortion, and specify the prediction solution to be finally used by transmitting index information in the ordered list in the bitstream.

In some embodiments, it is also necessary to pad the boundary samples. Considering that the filter may use reconstructed samples outside the reference template and the reference block, so that the boundary samples need to be padded, where depending on the different filter shape, regions that need to be padded at the boundary are different. It mainly includes following two processes: determining the boundary padding region of the reference block corresponding to the reference template and the reference template; and padding the boundary samples of the boundary padding region.

In some embodiments, the boundary padding region includes at least one of: an edge neighbouring region of the matching template, a point neighbouring region of the matching template, an edge neighbouring region of the reference block, or a point neighbouring region of the reference block.

In some embodiments, performing the boundary sample padding on the boundary padding region includes: performing the boundary sample padding on a first boundary padding region corresponding to the matching template by using neighbouring sample reconstructed values within the matching template; and/or performing the boundary sample padding on a second boundary padding region corresponding to the reference template by using neighbouring sample reconstructed values within the reference block.

In some embodiments, it is determined that a sample at a first position within the boundary padding region is unavailable, and boundary sample padding is performed on the first position within the boundary padding region.

In some embodiments, a determination condition for availability of the sample includes at least one of: the sample at the first position having been reconstructed; the first position being located within a search region; the first position being located within a picture where the reference block is located; the first position being located within a sub-picture where the reference block is located.

In some embodiments, performing the boundary sample padding on the boundary padding region includes: performing the boundary sample padding on the boundary padding region by using a preset sample value. Exemplarily, the preset sample value is 0, or the preset sample value is a sample value determined by the encoding end through decision.

In some embodiments, the boundary padding region is determined according to a filter shape, which is illustrated in FIG. 16A, FIG. 16B and FIG. 17A to FIG. 17F.

It should be noted that a width of the outer boundary region is a preset width. Exemplarily, the width of the outer boundary region is measured in units of samples or sub-samples, and may be any number from 1 to N.

There are also different ways to pad.

One padding manner is to determine whether the samples within the outer boundary padding region are available, if available, the reconstructed samples are directly used, if not available, the reconstructed samples of the neighbouring reference template or the reference block are copied to pad the corresponding positions.

Another padding manner is to directly copy the reconstructed samples of the neighbouring reference template or the reference block, to pad the boundary padding region.

Alternatively, not padding is also a choice, but instead give up using the corresponding data in the calculation when encountering a boundary position. The availability determination of the samples within the outer boundary padding region includes but is not limited to one or more of following conditions: the sample at the position having been reconstructed; the position not exceeding the search range of MV/BV; the position not exceeding the picture boundary; or the position not exceeding boundary of the Tile.

In S2005, a prediction residual value of the current block is determined according to the prediction value of the current block.

It should be noted that in the embodiments of the present disclosure, after the prediction value of the current block is determined, the prediction residual value of the current block may further be calculated. In some embodiments, determining the prediction residual value of the current block according to the prediction value of the current block may include: determining an original value of the current block; determining the prediction residual value of the current block according to the original value of the current block and the prediction value of the current block.

In an exemplary implementation, determining the prediction residual value of the current block according to the original value of the current block and the prediction value of the current block may include: performing a subtraction operation on the original value of the current block and the prediction value of the current block, to determine the reconstructed value of the current block.

It should also be noted that, in the embodiments of the present disclosure, whether intra template matching is applied to the current block or whether the filter model is used to the current block may be determined by different syntax element flag information. In some embodiments, the method may further include: determining a value of first syntax element flag information, where the first syntax element flag information is used for indicating whether intra template matching is applied to the current block; encoding the value of the first syntax element flag information, and signalling the obtained encoded bits into a bitstream.

In an embodiments of the present disclosure, determining the value of the first syntax element flag information may include: in response to that the intra template matching is applied to the current block, determining the value of the first syntax element flag information to be a first value; alternatively, in response to that the intra template matching is not applied to the current block, determining the value of the first syntax element flag information to be a second value.

In some embodiments, the method may further include: determining a value of second syntax element flag information, where the second syntax element flag information is used for indicating whether the filter model is applied to the current block; encoding the value of the second syntax element flag information, and signalling the obtained encoded bits into a bitstream.

In some embodiments, in a case where the first syntax element flag information is used for indicating that the intra template matching is applied to the current block, the method may further include: determining a value of the second syntax element flag information, where the second syntax element flag information is used for indicating whether the filter model is applied to the current block; encoding the value of the second syntax element flag information, and signalling the obtained encoded bits into a bitstream.

In the embodiments of the present disclosure, determining the value of the second syntax element flag information may include: in response to that the filter model is applied to the current block, determining the value of the second syntax element flag information to be a first value; or in response to that the filter model is not applied to the current block, determining the value of the second syntax element flag information to be a second value.

Furthermore, in some embodiments, the method may also include:
in response to that the filter model is applied to the current block, performing the steps of filtering the reference block according to the model parameter to determine the filtered reference block; and
determining the prediction value of the current block according to the filtered reference block; or in response to that the filter model is not applied to the current block, using the reconstructed sample value within the reference block as the prediction value of the current block.

It should be noted that, in the embodiments of the present disclosure, the first value is different from the second value, and the first value and the second value may be in form of parameter or in form of digital. In some implementation, the first syntax element flag information or the second syntax element flag information may be a parameter written into the profile, or may be a value of a flag, which is not limited here in detail. Exemplarily, for the first value and the second value, the first value may be set to 1, and the second value may be set to 0; alternatively, the first value may be set to true, and the second value may be set to false; which is not limited here in detail.

It should also be noted that in the embodiments of the present disclosure, whether the current block uses the filtered reference block as the final prediction value is determined by certain conditions, but it is not limited to following three manners. Exemplarily, the three manners may be as follows.

Manner 1: whether to filter the matching template is determined by comparing a distortion of the matching template and the template of the current block, such as the SAD, the MSE, the SATD or the SSE, with a threshold T_Distortion1.

Manner 2: on the basis that Manner 1 meets using the filter model, whether to filter the reference block is determined by using a distortion between the filtered matching template and the template of the current block, such as the SAD, the MSE, the SATD or the SSE, and a threshold T_Distortion2.

Manner 3: the encoding end transmits a Flag to indicate whether to apply the filter model. The tmpFlag indicates whether intra template matching is applied to the current block, and filterFlag indicates whether the filter model is applied to the current block. In a case where tmpFlag is 1, the encoding end determines whether to filter the reference block by comparing distortions between the reference block and the current block before and after filtering, such as the SAD, the MSE, the SATD or the SSE. In response to that a the distortion after filtering is less than the distortion before filtering, filterFlag is 1, and the filtered reference block is used as the prediction block for the current block; otherwise, filterFlag is 0, and the reference block before filtering is used as the prediction block for the current block. The encoding end transmits filterFlag to the decoding end.

It should be noted that, the filter coefficients are calculated for the best matching template after searching, the filter coefficients are applied to the best matching reference block, the filter coefficients may further be applied to all or part of the reference blocks within the search region, and which filtered reference block is used as the final prediction block is determined by using certain conditions, such as following manners.

Manner 1: the filter coefficients for the templates within the search range are solved, the templates are filtered, and Costs between the templates within the search range and the current template are calculated to determine which template is used. That is, the filter coefficients for part or all of the templates to be searched within the search range are calculated, and then the filter coefficients are applied to the templates to be searched, Costs between the templates to be searched and the current template are calculated, a best matching template after filtering is selected according to the Costs, the reference block corresponding to the best matching template is filtered and as the final prediction value.

Manner 2: the encoding end transmits a Flag to indicate which filtered reference block is used as the final prediction block. The tmpFlag indicates whether template matching is applied to the current coding block, and filterIdx indicates the filtering model applied to which reference block within the current search range. In a case where tmpFlag is 1, the encoding end selects a best reference block and transmits an index corresponding to the best reference block, to the decoding end by comparing distortions between the reference blocks to which filter coefficients are applied within the search range and the current original block, such as the SAD, the MSE, the SATD or the SSE.

Furthermore, a bitstream is further provided in the embodiment of the present disclosure, which is generated by bit encoding according to information to be encoded; where the information to be encoded includes at least one of: a prediction residual value of a current block, the number of coefficients of a target filter, a shape of a target filter, a value of first syntax element flag information, a value of second syntax element flag information, or a value of third syntax element flag information.

In the embodiments of the present disclosure, the first syntax element flag information is used for indicating whether template matching is applied to the current block, the second syntax element flag information is used for indicating whether a filter model is applied to the current block.

This embodiments provides an encoding method, which includes: determining a first template of a current block, and determining a matching template and a reference block; determining a model parameter according to the first template and the matching template; filtering the reference block according to the model parameter, to determine a filtered reference block; determining a prediction value of the current block according to the filtered reference block; and determining a prediction residual value of the current block according to the prediction value of the current block. In this way, the model parameter is determined according to the first template and the matching template, where the model parameter fully reflects a correlation between the matching template and the first template of the current block. The correlation is applied to the reference block, reconstructed samples of the reference block are filtered and corrected, and then the filtered reconstructed samples are used as predicted samples of the current block, which improves prediction accuracy and save bit rate, further improves efficiency of encoding and decoding at the same time, thereby improving performance of the encoding and decoding.

In yet another embodiment of the present disclosure, based on the same inventive concept as the above embodiments, refer to FIG. 21, which illustrates a schematic diagram of a composition structure of an encoder provided in the embodiments of the present disclosure. As illustrated in FIG. 21, the encoder 210 may include: a first determining unit 2101, a first filtering unit 2102, and a first prediction unit 2103; where
the first determining unit 2101 is configured to determine a first template of a current block, and determine a matching template and a reference block; and the first determining unit 2101 is further configured to determine a model parameter according to the first template and the matching template;
the first filtering unit 2102 is configured to filter the reference block according to the model parameter, to determine a filtered reference block;
the first prediction unit 2103 is configured to determine a prediction value of the current block according to the filtered reference block; and
the first determining unit 2101 is further configured to determine a prediction residual value of the current block according to the prediction value of the current block.

It may be understood that in the embodiments of the present disclosure, a “unit” may be a part of a circuit, a part of a processor, a part of a program or software, or the like, and may also be a module or a non-module. Furthermore, various components in the embodiments may be integrated into one processing unit, or various units may exist physically separately, or two or more units may be integrated into one unit. The above integrated unit may be implemented in the form of hardware or in the form of software function modules.

If the integrated units are implemented in the form of a software function module and is not sold or used as an independent product, they may be stored in a computer-readable storage medium. Based on such an understanding, the technical solution of the embodiments is essentially or the part that contributes to the prior art or all or part of the technical solution may be embodied in the form of a software product. The computer software product is stored in a storage medium and includes the number of instructions for enabling a computer device (which may be a personal computer, a server, or a network device, or the like.) or a processor to perform all or part of the steps of the methods of the embodiments. The above storage media include: an U disk, a mobile hard disk, a read only memory (ROM), a random access memory (RAM), a disk, a CD or other media that may store program code.

Therefore, a non-transitory computer-readable storage medium is provided in the embodiments of the present disclosure, which is applied to the encoder 210. The non-transitory computer-readable storage medium stores a computer program. When the computer program is executed by the first processor, the encoding method in any one of the above embodiments is implemented.

Based on the composition of the encoder 210 and the non-transitory computer-readable storage medium, refer to FIG. 22, which illustrates a specific hardware structure diagram of the encoder 210 provided in the embodiments of the present disclosure. As illustrated in FIG. 22, the encoder 210 may include: a first communication interface 2201, a first memory 2202, and a first processor 2203; various components are coupled together via a first bus system 2204. It may be understood that the first bus system 2204 is used to achieve connection and communication between the components. The first bus system 2204 includes not only a data bus but also a power bus, a control bus and a status signal bus. However, for the sake of clarity, various buses are labeled as the first bus system 2204 in FIG. 22, where
the first communication interface 2201 is configured to receive and send signals during the process of sending information to other external network elements and receiving information from other external network elements
the first memory 2202 is configured to store a computer program executable on a first processor 2103; and
the first processor 2203 is configured to, when running the computer program, perform any one of the encoding methods provided in the embodiments of the present disclosure.

It should be understood that the first memory 2202 in the embodiments of the present disclosure may be a volatile (transitory) memory or a non-volatile (non-transitory) memory, or may include both volatile and non-volatile memories. The non-volatile memory may be a read-only memory (ROM), a programmable read-only memory (Programmable ROM, PROM), an erasable programmable read-only memory (Erasable PROM, EPROM), an electrically erasable programmable read-only memory (Electrically EPROM, EEPROM) or a flash memory. The volatile memory may be a random access memory (RAM), which is used as an external cache. As an example but not limitation, a variety of forms of RAMs are available, such as a static random access memory (Static RAM, SRAM), a dynamic random access memory (Dynamic RAM, DRAM), a synchronous dynamic random access memory (Synchronous DRAM, SDRAM), a double data rate synchronous dynamic random access memory (Double Data Rate SDRAM, DDR SDRAM), an enhanced synchronous dynamic random access memory (Enhanced SDRAM, ESDRAM), a synchronous link dynamic random access memory (Synchlink DRAM, SLDRAM) and a direct memory bus random access memory (Direct Rambus RAM, DR RAM). The first memory 2202 of the systems and methods described here is intended to include, but is not limited to, these and any other suitable types of memories.

The first processor 2203 may be an integrated circuit chip with signal processing capabilities. In the implementation process, various steps in the above method embodiments may be completed by an integrated logic circuit of hardware in the first processor 2203 or by instructions in software form. The first processor 2203 mentioned above may be a a general purpose processor, a digital signal processor (DSP), an application specific integrated circuit (ASIC), a field programmable gate array (FPGA) or other programmable logic device, a discrete gate, a transistor logic device, or a discrete hardware component, which may implement or perform the disclosed methods, steps and logic block diagrams in the embodiments of the present disclosure. The general purpose processor may be a microprocessor, or the processor may be any conventional processor. The steps of the methods disclosed in conjunction with the embodiments of the present disclosure may be directly implemented as being performed by the hardware decoding processor, or may be implemented by a combination of the hardware and software modules in the decoding processor. The software module may be located in a random memory, a flash memory, a read-only memory, a programmable read-only memory, an electrically erasable programmable memory, a register or other mature storage media in the art. The storage medium is located in the first memory 2202, and the first processor 2203 reads the information in the first memory 2202 and completes the steps of the above methods in combination with its hardware.

It will be understood that the embodiments described here may be implemented by hardware, software, firmware, middleware, microcode, or a combination thereof. For hardware implementation, the processing unit may be implemented in one or more application specific integrated circuits (ASIC), digital signal processors (DSP), digital signal processing devices (DSPD), programmable logic devices (PLD), field programmable gate arrays (FPGA), general-purpose processors, controllers, microcontrollers, microprocessors, other electronic units used for performing the functions described in the present disclosure, or combinations thereof. For software implementation, the technology described in the present disclosure may be implemented through modules (e.g., procedures, functions.) that perform the functions described in the present disclosure. The software codes may be stored in a memory and performed by a processor. The memory may be implemented within the processor or external to the processor.

Optionally, as another embodiment, the first processor 2203 is further configured to perform the encoding method described in any one of the above embodiments when running the computer program.

The present embodiments provide an encoder, for the encoder, the model parameter is determined according to the first template and the matching template, where the model parameter fully reflects a correlation between the matching template and the first template of the current block. The correlation is applied to the reference block, which may effectively correct the prediction value of the template matching technology, to improve prediction accuracy and save bit rate, and further to improve efficiency of encoding and decoding at the same time, thereby improving performance of the encoding and decoding.

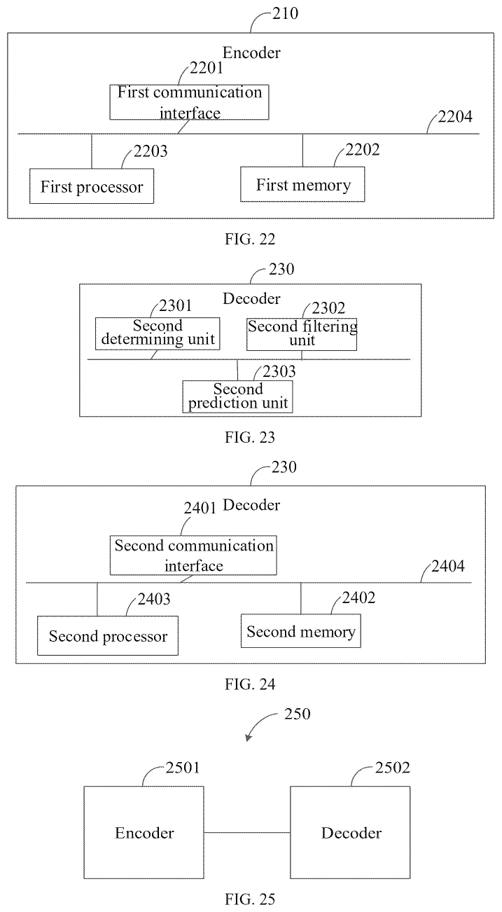

In yet another embodiment of the present disclosure, based on the same inventive concept as the above embodiments, refer to FIG. 23, which illustrates a schematic diagram of a composition structure of a decoder 230 provided in the embodiments of the present disclosure. As illustrated in FIG. 23, the decoder 230 may include: a second determining unit 2301, a second filtering unit 2302, and a second prediction unit 2303; where
the second determining unit 2301 is configured to determine a first template of a current block, and determine a matching template and a reference block; the second determining unit 2301 is further configured to determine a model parameter according to the first template and the matching template;
the second filtering unit 2302 is configured to filter the reference block according to the model parameter, to determine a filtered reference block;
the second prediction unit 2303 is configured to determine a prediction value of the current block according to the filtered reference block; and
the second determining unit 2301 is further configured to determine a reconstructed value of the current block according to the prediction value of the current block.

It may be understood that in the embodiments, a “unit” may be a part of a circuit, a part of a processor, a part of a program or software, or the like, and may also be a module or a non-module. Furthermore, various components in the embodiments may be integrated into one processing unit, or various units may exist physically separately, or two or more units may be integrated into one unit. The above integrated unit may be implemented in the form of hardware or in the form of software function modules.

If the integrated units are implemented in the form of a software function module and is not sold or used as an independent product, they may be stored in a computer-readable storage medium. Based on such an understanding, a non-transitory computer-readable storage medium is provided in the embodiments, which is applied to the decoder 230. The computer-readable storage medium stores a computer program. When the computer program is executed by the second processor, the decoding method described in any one of the above embodiments is implemented.

Based on the composition of the decoder 230 and the non-transitory computer-readable storage medium, refer to FIG. 24, which illustrates a specific hardware structure diagram of the decoder 230 provided in the embodiments of the present disclosure. As illustrated in FIG. 24, the decoder 230 may include: a second communication interface 2401, a second memory 2402, and a second processor 2403; various components are coupled together via a second bus system 2404. It may be understood that the second bus system 2404 is used to achieve connection and communication between the components. The second bus system 2404 includes not only a data bus but also a power bus, a control bus and a status signal bus. However, for the sake of clarity, various buses are labeled as the second bus system 2404 in FIG. 24, where
the second communication interface 2401, configured to receive and send signals during the process of sending to other external network elements and receiving information from other external network elements;
the second memory 2402, configured to store a computer program executable on a second processor 2403; and
the second processor 2403, configured to, when running the computer program, perform any decoding method provided in the embodiments of the present disclosure.

Optionally, as another embodiment, the second processor 2403 is further configured to perform the decoding method described in any one of the above embodiments when running the computer program.

It may be understood that the hardware functions of the second memory 2402 and the first memory 2202 are similar, and the hardware functions of the second processor 2403 and the first processor 2203 are similar, which is not described here in detail.

The present embodiment provides a decoder, for the decoder, the model parameter is determined according to the first template and the matching template, where the model parameter fully reflects a correlation between the matching template and the first template of the current block. The correlation is applied to the reference block, which may effectively correct the prediction value of the template matching technology, to improve prediction accuracy and save bit rate, and further to improve efficiency of encoding and decoding at the same time, thereby improving performance of the encoding and decoding.

In yet another embodiment of the present disclosure, referring to FIG. 25, a schematic diagram of a composition structure of an encoding and decoding system provided in the embodiments of the present disclosure is illustrated. As illustrated in FIG. 25, the encoding and decoding system 250 may include an encoder 2501 and a decoder 2502.

In the embodiments of the present disclosure, the encoder 2501 may be the encoder described in any one of the above embodiments, and the decoder 2502 may be the decoder described in any one of the above embodiments.

It should be noted that, in the present disclosure, the terms “comprises”, “includes” or any other variations thereof are intended to cover non-exclusive inclusion, so that a process, a method, an article or an apparatus including a series of elements includes not only those elements, but also other elements not explicitly listed, or also includes elements inherent to such the process, the method, the article or the apparatus. Without more constraints, an element defined by the phrase “including a . . . ” does not exclude the existence of other identical elements in the process, the method, the article or the apparatus including the element.

The serial numbers of the above embodiments of the present disclosure are for description only and do not represent the advantages or disadvantages of the embodiments.

The methods disclosed in several method embodiments provided in the present disclosure may be arbitrarily combined without conflict, to obtain new method embodiments.

The features disclosed in several product embodiments provided in present disclosure may be arbitrarily combined without conflict, to obtain new product embodiments.

The features disclosed in several method embodiments or device embodiments provided in the present disclosure may be arbitrarily combined without conflict, to obtain new method embodiments or new device embodiments.

The foregoing descriptions are merely exemplary implementations of the present disclosure, but the protection scope of the present disclosure is not limited thereto. Any person skilled in the art may readily conceive of changes or replacements within the technical scope of the present disclosure, which shall be all included within the protection scope of the present disclosure. Therefore, the protection scope of the present disclosure shall be subject to the protection scope of claims.

### INDUSTRIAL APPLICABILITY

In the embodiments of the present disclosure, whether it is an encoding end or a decoding end, following steps are performed: determining a first template of a current block, and determining a matching template and a reference block; determining a model parameter according to the first template and the matching template; filtering the reference block according to the model parameter, to determine the filtered reference block; and determining a prediction value of the current block according to the filtered reference block. In this way, the encoding end may determine the prediction residual value of the current block according to the prediction value of the current block; so that the decoding end may determine a reconstructed value of the current block according to the prediction value of the current block. That is to say, the model parameter is determined according to the first template and the matching template, where the model parameter fully reflects a correlation between the matching template and the first template of the current block. The correlation is applied to the reference block, reconstructed samples of the reference block are filtered and corrected, and then the filtered reconstructed samples are used as predicted samples of the current block, which improves prediction accuracy and save bit rate, and further improves efficiency of encoding and decoding at the same time, thereby improving performance of the encoding and decoding.

In a first clause, a decoding method is provided, which is applied to a decoder and includes:
determining a first template of a current block, and determining a matching template and a reference block;
determining a model parameter according to the first template and the matching template;
filtering the reference block according to the model parameter, to determine a filtered reference block;
determining a prediction value of the current block according to the filtered reference block; and
determining a reconstructed value of the current block according to the prediction value of the current block.

In a second clause, according to the first clause, where determining the first template of the current block includes:
determining a template type of the current block; and
determining the first template of the current block according to the template type of the current block.

In a third clause, according to the second clause, where determining the template type of the current block includes:
determining the template type of the current block according to reference samples of the current block;
where the reference samples of the current block include at least one of: left neighbouring reference samples of the current block, top neighbouring reference samples of the current block, top-left neighbouring reference samples of the current block, bottom-left neighbouring reference samples of the current block, or top-right neighbouring reference samples of the current block;
or
decoding a bitstream, to determine the template type of the current block;
or
determining the template type of the current block according to a size of the current block.

In a fourth clause, according to the third clause, where determining the template type of the current block includes:
in response to that the left neighbouring reference samples of the current block, the top neighbouring reference samples of the current block, and the top-left neighbouring reference samples of the current block are all available, determining that the template type of the current block is a first value;
in response to that the left neighbouring reference samples of the current block are available, determining that the template type of the current block is a second value;
in response to that the top neighbouring reference samples of the current block are available, determining that the template type of the current block is a third value;
in response to that the left neighbouring reference samples of the current block and the top-left neighbouring reference samples of the current block are both available, determining that the template type of the current block is a fourth value;
in response to that the left neighbouring reference samples of the current block and the bottom-left neighbouring reference samples of the current block are both available, determining that the template type of the current block is a fifth value; or
in response to that the top neighbouring reference samples of the current block and the top-right neighbouring reference samples of the current block are both available, determining that the template type of the current block is a sixth value.

In a fifth clause, according to the first clause, where determining the matching template includes: determining an initial vector parameter of the current block;
determining a search region according to the initial vector parameter;
performing a search within the search region based on template matching, to determine a target vector parameter; and
determining the matching template according to the target vector parameter and the first template.

In a sixth clause, according to the fifth clause, where determining the initial vector parameter of the current block includes:
determining to construct a vector parameter candidate list of the current block according to a prediction mode parameter of the current block; and
determining the initial vector parameter according to the vector parameter candidate list.

In a seventh clause, according to the sixth clause, where determining to construct the vector parameter candidate list of the current block according to the prediction mode parameter of the current block includes:
determining to construct a merge vector parameter candidate list of the current block according to the prediction mode parameter of the current block; or
determining to construct an advanced motion vector prediction (AMVP) vector parameter candidate list of the current block according to the prediction mode parameter of the current block.

In an eighth clause, according to the fifth clause, where determining the initial vector parameter of the current block includes:
determining that the initial vector parameter of the current block is a preset vector parameter according to a prediction mode parameter of the current block.

In a ninth clause, according to the eighth clause, where the preset vector parameter is 0.

In a tenth clause, according to the fifth clause, where determining the search region according to the initial vector parameter includes:
determining the search region according to the initial vector parameter and a preset search range.

In an eleventh clause, according to the tenth clause, where
a determining method of the preset search range includes at least one of:
using a preset horizontal component search range as a horizontal component search range of the preset search range;
using a preset vertical component search range as a vertical component search range of the preset search range;
decoding a bitstream, to determine a horizontal component search range of the preset search range and/or a vertical component search range of the preset search range; or
determining a horizontal component search range of the preset search range and/or a vertical component search range of the preset search range according to a size of the current block.

In a twelfth clause, according to the fifth clause, where determining the search region according to the initial vector parameter includes:
in response to that an inter prediction mode is determined according to a prediction mode parameter of the current block, determining the search region within a reference picture according to the initial vector parameter; or
in response to that an intra prediction mode is determined according to the prediction mode parameter of the current block, determining the search region within a current picture according to the initial vector parameter.

In a thirteenth clause, according to the fifth clause, where in response to that an intra prediction mode is determined according to a prediction mode parameter of the current block, the search region includes at least one of: a partial region of a reconstructed coding tree block of a current picture, an entire region of a reconstructed coding tree block of a current picture, an entire reconstructed region of a current coding tree block where the current block is located, or a partial reconstructed region of a current coding tree block where the current block is located.

In a fourteenth clause, according to the fifth clause, where performing the search within the search region based on the template matching, to determine the target vector parameter includes:
performing the search within the search region, to determine reference templates, and calculating a respective matching cost value between each of the reference templates and the first template; and
determining a vector parameter of a reference template corresponding to a minimum matching cost value as the target vector parameter.

In a fifteenth clause, according to the fourteenth clause, where performing the search within the search region, to determine the reference templates includes:
performing the search within the search region, to determine available reference templates.

In a sixteenth clause, according to the fifteenth clause, where
a determination condition for availability of the reference templates includes at least one of:
a first sample within a template not exceeding a boundary of a picture where the first sample is located;
a second sample within a reference block corresponding to a template not exceeding a boundary of a picture where the second sample is located;
a first sample within a template not exceeding the search region;
a second sample within a reference block corresponding to a template not exceeding the search region;
a first sample within a template having been reconstructed; or a second sample within a reference block corresponding to a template having been reconstructed.

In a seventeenth clause, according to the fifteenth clause or the sixteenth clause, where a determination condition for availability of the reference templates includes at least one of:
a first sample within a template and the current block being within a same sub-picture;
a second sample within a reference block corresponding to a template and the current block being within a same sub-picture; or
a second sample within a reference block corresponding to a template not being within the current block.

In an eighteenth clause, according to the sixteenth clause, where the first sample is each sample within the template, or the first sample is a first identification sample which is preset.

In a nineteenth clause, according to the eighteenth clause, where the first identification sample includes at least one sample located in a corner position within the template.

In a twentieth clause, according to the sixteenth clause, where the second sample is each sample within the reference block corresponding to the template, or the second sample is a second identification sample which is preset.

In a twenty-first clause, according to the twentieth clause, where the second identification sample includes at least one sample located in a corner position within the reference block corresponding to the template.

In a twenty-second clause, according to the fifth clause, where performing the search within the search region based on the template matching, to determine the target vector parameter includes:
performing a first search within the search region, to determine the target vector parameter; or
performing a second search within the search region, to determine the target vector parameter;
where a search step corresponding to the first search is greater than a search step corresponding to the second search.

In a twenty-third clause, according to the fifth clause, where performing the search within the search region based on the template matching, to determine the target vector parameter includes:
performing a first search within the search region, to determine a first vector parameter, and determining an initial matching template according to the first vector parameter; and
determining a first search region according to the initial matching template, and performing a second search within the first search region, to determine the target vector parameter;
where a search step corresponding to the first search is greater than a search step corresponding to the second search, and the first search region is smaller than the search region.

In a twenty-fourth clause, according to the fifth clause, where the search region includes at least one sub-search region; and performing the search within the search region based on the template matching, to determine the target vector parameter includes:
performing the search within each of the at least one sub-search region respectively, to determine a respective best vector parameter corresponding to each sub-search region and a respective matching cost value corresponding to each best vector parameter;
determining a best vector parameter corresponding to a minimum matching cost value according to the respective best vector parameter corresponding to each sub-search region and the respective matching cost value corresponding to each best vector parameter; and
using the best vector parameter corresponding to the minimum matching cost value as the target vector parameter.

In a twenty-fifth clause, according to the twenty-fourth clause, where performing the search within the search region based on the template matching, to determine the target vector parameter includes:
performing a first search within each of the at least one sub-search region respectively, to determine a respective best vector parameter corresponding to each sub-search region and a respective second search region corresponding to each best vector parameter;
performing region determination according to the respective best vector parameter corresponding to each sub-search region and the respective second search region corresponding to each best vector parameter, to determine at least two target sub-search regions participating in a second search;
performing the second search within the at least two target sub-search regions, to determine a best vector parameter corresponding to the at least two target sub-search regions; and
using the best vector parameter corresponding to the at least two target sub-search regions as the target vector parameter.

In a twenty-sixth clause, according to the fifth clause, where determining the reference block includes:
determining the reference block according to the target vector parameter.

In a twenty-seventh clause, according to the first clause, further including:
decoding a bitstream, to determine a value of first syntax element flag information; where the first syntax element flag information is used for indicating whether template matching is applied to the current block.

In a twenty-eighth clause, according to the first clause, where determining the reference block includes:
decoding a bitstream, to determine a value of third syntax element flag information; and
determining the reference block of the current block according to the value of the third syntax element flag information.

In a twenty-ninth clause, according to the first clause, the method further including:
traversing a search region to search for multiple reference templates, and determining a respective model parameter according to the first template and each of the multiple reference templates;
filtering each of the multiple reference templates according to the respective model parameter, to obtain a respective filtered reference template;
calculating a respective matching cost value between the respective filtered reference template and the first template; and
determining a reference block of a reference template corresponding to a minimum matching cost value as the reference block of the current block.

In a thirtieth clause, according to the first clause, where the model parameter includes coefficients of a target filter.

In a thirty-first clause, according to the thirtieth clause, where filtering the reference block according to the model parameter, to determine the filtered reference block includes:
calculating a product of a sample reconstructed value of the reference block and a coefficient of the target filter corresponding to the sample reconstructed value;
setting a first output value of the target filter to be equal to a sum of n products; where n represents a number of coefficients of the target filter, and n is a positive integer; and
determining the filtered reference block according to the first output value of the target filter.

In a thirty-second clause, according to the thirty-first clause, where calculating the product of the sample reconstructed value of the reference block and the coefficient of the target filter corresponding to the sample reconstructed value includes:
calculating a product of a sample reference value of a second boundary padding region corresponding to the reference block and a coefficient of the target filter corresponding to the sample reference value of the second boundary padding region; and/or
calculating a product of a sample reference value of a reference template corresponding to the reference block and a coefficient of the target filter corresponding to the sample reference value of the reference template.

In a thirty-third clause, according to the first clause, further including:
determining a boundary padding region of the reference block and a reference template corresponding to the reference block; and
performing boundary sample padding on the boundary padding region.

In a thirty-fourth clause, according to the thirty-third clause, where
the boundary padding region includes at least one of: an edge neighbouring region of the matching template, a point neighbouring region of the matching template, an edge neighbouring region of the reference block, or a point neighbouring region of the reference block.

In a thirty-fifth clause, according to the thirty-third clause, where performing the boundary sample padding on the boundary padding region includes:
performing the boundary sample padding on a first boundary padding region corresponding to the matching template by using neighbouring sample reconstructed values within the matching template; and
performing the boundary sample padding on a second boundary padding region corresponding to the reference template by using neighbouring sample reconstructed values within the reference block.

In a thirty-sixth clause, according to the thirty-third clause, where performing the boundary sample padding on the boundary padding region includes:
performing the boundary sample padding on the boundary padding region by using a preset sample value.

In a thirty-seventh clause, according to the thirty-third clause, further including:
determining that a sample at a first position within the boundary padding region is unavailable, and performing the boundary sample padding on the first position within the boundary padding region.

In a thirty-eighth clause, according to the thirty-seventh clause, where
a determination condition for availability of the sample includes at least one of:
the sample at the first position having been reconstructed;
the first position being located within a search region;
the first position being located within a picture where the reference block is located; or
the first position being located within a sub-picture where the reference block is located.

In a thirty-ninth clause, according to the first clause, the twenty-seventh clause or the twenty-eighth clause, the method further including:
decoding a bitstream, to determine a value of second syntax element flag information; and
in response to that the second syntax element flag information is used for indicating that a filter model is applied to the current block, performing operations of filtering the reference block according to the model parameter to determine the filtered reference block and determining the prediction value of the current block according to the filtered reference block.

In a fortieth clause, according to the thirty-ninth clause, further including:
in response that the second syntax element flag information is used for indicating that the filter model is not applied to the current block, a reconstructed sample value within the reference block is used as the prediction value of the current block.

In a forty-first clause, an encoding method is provided, which is applied to an encoder and includes:
determining a first template of a current block, and determining a matching template and a reference block;
determining a model parameter according to the first template and the matching template;
filtering the reference block according to the model parameter, to determine a filtered reference block;
determining a prediction value of the current block according to the filtered reference block; and
determining a prediction residual value of the current block according to the prediction value of the current block.

In a forty-second clause, according to the forty-first clause, where determining the first template of the current block includes:
determining a template type of the current block; and
determining the first template of the current block according to the template type of the current block.

In a forty-third clause, according to the forty-second clause, where determining the template type of the current block includes:
determining the template type of the current block according to reference samples of the current block;
where the reference samples of the current block include at least one of: left neighbouring reference samples of the current block, top neighbouring reference samples of the current block, top-left neighbouring reference samples of the current block, bottom-left neighbouring reference samples of the current block, and top-right neighbouring reference samples of the current block;
or
determining the template type of the current block according to a size of the current block.

In a forty-fourth clause, according to the forty-third clause, where determining the template type of the current block includes:
in response to that the left neighbouring reference samples of the current block, the top neighbouring reference samples of the current block, and the top-left neighbouring reference samples of the current block are all available, determining that the template type of the current block is a first value;
in response to that the left neighbouring reference samples of the current block are available, determining that the template type of the current block is a second value;
in response to that the top neighbouring reference samples of the current block are available, determining that the template type of the current block is a third value;
in response to that the left neighbouring reference samples of the current block and the top-left neighbouring reference samples of the current block are both available, determining that the template type of the current block is a fourth value;
in response to that the left neighbouring reference samples of the current block and the bottom-left neighbouring reference samples of the current block are both available, determining that the template type of the current block is a fifth value; and
in response to that the top neighbouring reference samples of the current block and the top-right neighbouring reference samples of the current block are both available, determining that the template type of the current block is a sixth value.

In a forty-fifth clause, according to the forty-first clause, where determining the matching template includes:
determining an initial vector parameter of the current block;
determining a search region according to the initial vector parameter;
performing a search within the search region based on template matching, to determine a target vector parameter; and
determining the matching template according to the target vector parameter and the first template.

In a forty-sixth clause, according to the forty-fifth clause, where determining the initial vector parameter of the current block includes:
determining to construct a vector parameter candidate list of the current block according to a prediction mode parameter of the current block; and
determining the initial vector parameter according to the vector parameter candidate list.

In a forty-seventh clause, according to the forty-sixth clause, where determining to construct the vector parameter candidate list of the current block according to the prediction mode parameter of the current block includes:
determining to construct a merge vector parameter candidate list of the current block according to the prediction mode parameter of the current block; or
determining to construct an advanced motion vector prediction (AMVP) vector parameter candidate list of the current block according to the prediction mode parameter of the current block.

In a forty-eighth clause, according to the forty-fifth clause, where determining the initial vector parameter of the current block includes:
determining that the initial vector parameter of the current block is a preset vector parameter according to a prediction mode parameter of the current block.

In a forty-ninth clause, according to the forty-eighth clause, where the preset vector parameter is 0.

In a fiftieth clause, according to the forty-fifth clause, where determining the search region according to the initial vector parameter includes:
determining the search region according to the initial vector parameter and a preset search range.

In a fifty-first clause, according to the fiftieth clause, where a determining method of the preset search range includes at least one of:
using a preset horizontal component search range as a horizontal component search range of the preset search range;
using a preset vertical component search range as a vertical component search range of the preset search range; or
determining a horizontal component search range of the preset search range and/or a vertical component search range of the preset search range according to a size of the current block.

In a fifty-second clause, according to the forty-fifth clause, where determining the search region according to the initial vector parameter includes:
in response to that an inter prediction mode is determined according to a prediction mode parameter of the current block, determining the search region within a reference picture according to the initial vector parameter; or
in response to that an intra prediction mode is determined according to the prediction mode parameter of the current block, determining the search region within a current picture according to the initial vector parameter.

In a fifty-third clause, according to the forty-fifth clause, where in response to that an intra prediction mode is determined according to a prediction mode parameter of the current block, the search region includes at least one of: a partial region of a reconstructed coding tree block of a current picture, an entire region of a reconstructed coding tree block of a current picture, an entire reconstructed region of a current coding tree block where the current block is located, or a partial reconstructed region of a current coding tree block where the current block is located.

In a fifty-fourth clause, according to the forty-fifth clause, where performing the search within the search region based on the template matching, to determine the target vector parameter includes:
performing the search within the search region, to determine reference templates, and calculating a respective matching cost value between each of the reference templates and the first template; and
determining a vector parameter of a reference template corresponding to a minimum matching cost value as the target vector parameter.

In a fifty-fifth clause, according to the fifty-fourth clause, where performing the search within the search region, to determine the reference templates includes:
performing the search within the search region, to determine available reference templates.

In a fifty-sixth clause, according to the fifty-fifth clause, where a determination condition for availability of the reference templates includes at least one of:
a first sample within a template not exceeding a boundary of a picture where the first sample is located;
a second sample within a reference block corresponding to a template not exceeding a boundary of a picture where the second sample is located;
a first sample within a template not exceeding the search region;
a second sample within a reference block corresponding to a template not exceeding the search region;
a first sample within a template having been reconstructed; or a second sample within a reference block corresponding to a template having been reconstructed.

In a fifty-seventh clause, according to the fifty-fifth clause or the fifty-sixth clause, where a determination condition for availability of the reference templates includes at least one of:
a first sample within a template and the current block being within a same sub-picture;
a second sample within a reference block corresponding to a template and the current block being within a same sub-picture; or
a second sample within a reference block corresponding to a template not being within the current block.

In a fifty-eighth clause, according to the fifty-sixth clause, where the first sample is each sample within the template, or the first sample is a first identification sample which is preset.

In a fifty-ninth clause, according to the fifty-eighth clause, where the first identification sample includes at least one sample located in a corner position within the template.

In a sixtieth clause, according to the fifty-sixth clause, where the second sample is each sample within the reference block corresponding to the template, or a second identification sample which is preset.

In a sixty-first clause, according to the sixtieth clause, where the second identification sample includes at least one sample located in a corner position within the reference block corresponding to the template.

In a sixty-second clause, according to the forty-fifth clause, where performing the search within the search region based on the template matching, to determine the target vector parameter includes:
performing a first search within the search region, to determine the target vector parameter; or
performing a second search within the search region, to determine the target vector parameter;
where a search step corresponding to the first search is greater than a search step corresponding to the second search.

In a sixty-third clause, according to the forty-fifth clause, where performing the search within the search region based on the template matching, to determine the target vector parameter includes:
performing a first search within the search region, to determine a first vector parameter, and determining an initial matching template according to the first vector parameter; and
determining a first search region according to the initial matching template, and performing a second search within the first search region, to determine the target vector parameter;
where a search step corresponding to the first search is greater than a search step corresponding to the second search, and the first search region is smaller than the search region.

In a sixty-fourth clause, according to the forty-fifth clause, where the search region includes at least one sub-search region; and performing the search within the search region based on the template matching, to determine the target vector parameter includes:
performing the search within each of the at least one sub-search region respectively, to determine a respective best vector parameter corresponding to each sub-search region and a matching cost value corresponding to each best vector parameter;
determining a best vector parameter corresponding to a minimum matching cost value according to the respective best vector parameter corresponding to each sub-search region and the respective matching cost value corresponding to each best vector parameter; and
using the best vector parameter corresponding to the minimum matching cost value as the target vector parameter.

In a sixty-fifth clause, according to the sixty-fourth clause, where performing the search within the search region based on the template matching, to determine the target vector parameter includes:
performing a first search within each of the at least one sub-search region respectively, to determine a respective best vector parameter corresponding to each sub-search region and a respective second search region corresponding to each best vector parameter;
performing region determination according to the respective best vector parameter corresponding to each sub-search region and the respective second search region corresponding to each best vector parameter, to determine at least two target sub-search regions participating in a second search;
performing the second search within the at least two target sub-search regions, to determine a best vector parameter corresponding to the at least two target sub-search regions; and
using the best vector parameter corresponding to the at least two target sub-search regions as the target vector parameter.

In a sixty-sixth clause, according to the forty-fifth clause, where determining the reference block includes:
determining the reference block according to the target vector parameter.

In a sixty-seventh clause, according to the forty-first clause, further including:
determining a value of first syntax element flag information; where the first syntax element flag information is used for indicating whether template matching is applied to the current block; and
encoding the value of the first syntax element flag information, and signalling an obtained encoded bit into a bitstream.

In a sixty-eighth clause, according to the forty-first clause, further including:
determining a value of third syntax element flag information; where the third syntax element flag information is used for indicating the reference block of the current block; and
encoding the value of the third syntax element flag information, and signalling an obtained encoded bit into a bitstream.

In a sixty-ninth clause, according to the forty-first clause or the sixty-eighth clause, where determining the reference block includes:
in a case where template matching being applied to the current block is determined, traversing a search region to search for multiple reference blocks, and filtering each of the multiple reference blocks according to a respective model parameter, to determine a respective filtered reference block;
calculating a respective distortion parameter between the respective filtered reference block and the current block;
determining a reference block corresponding to a minimum distortion parameter as the reference block.

In a seventieth clause, according to the forty-first clause or the sixty-eighth clause, where determining the reference block includes:
traversing a search region to search for multiple reference templates, and determining a respective model parameter according to the first template and each of the multiple reference templates;
filtering each of the multiple reference templates according to the respective model parameter, to obtain a respective filtered reference template;
calculating a respective matching cost value between the respective filtered reference template and the first template; and
determining a reference block of a reference template corresponding to a minimum matching cost value as the reference block of the current block.

In a seventy-first clause, according to the forty-first clause, where the model parameter includes coefficients of a target filter.

In a seventy-second clause, according to the seventy-first clause, where filtering the reference block according to the model parameter, to determine the filtered reference block includes:
calculating a product of a sample reconstructed value of the reference block and a coefficient of the target filter corresponding to the sample reconstructed value;
setting a first output value of the target filter to be equal to a sum of n products; where n represents a number of coefficients of the target filter, and n is a positive integer; and
determining the filtered reference block according to the first output value of the target filter.

In a seventy-third clause, according to the seventy-second clause, where calculating the product of the sample reconstructed value of the reference block and the coefficient of the target filter corresponding to the sample reconstructed value includes:
calculating a product of a sample reference value of a second boundary padding region corresponding to the reference block and a coefficient of the target filter corresponding to the sample reference value of the second boundary padding region; and/or
calculating a product of a sample reference value of a reference template corresponding to the reference block and a coefficient of the target filter corresponding to the sample reference value of the reference template.

In a seventy-fourth clause, according to the forty-first clause, further including:
determining a boundary padding region of the reference block and a reference template corresponding to the reference block; and
performing boundary sample padding on the boundary padding region.

In a seventy-fifth clause, according to the seventy-fourth clause, where
the boundary padding region includes at least one of: an edge neighbouring region of the matching template, a point neighbouring region of the matching template, an edge neighbouring region of the reference block, or a point neighbouring region of the reference block.

In a seventy-sixth clause, according to the seventy-fourth clause, where performing the boundary sample padding on the boundary padding region includes:
performing the boundary sample padding on a first boundary padding region corresponding to the matching template by using neighbouring sample reconstructed values within the matching template; and
performing the boundary sample padding on a second boundary padding region corresponding to the reference template by using neighbouring sample reconstructed values within the reference block.

In a seventy-seventh clause, according to the seventy-fourth clause, where performing the boundary sample padding on the boundary padding region includes:
performing the boundary sample padding on the boundary padding region by using a preset sample value.

In a seventy-eighth clause, according to the seventy-fourth clause, further including:
determining that a sample at a first position within the boundary padding region is unavailable, and performing the boundary sample padding on the first position within the boundary padding region.

In a seventy-ninth clause, according to the seventy-eighth clause, where
a determination condition for availability of the sample includes at least one of:
the sample at the first position having been reconstructed;
the first position being located within a search region;
the first position being located within a picture where the reference block is located; or
the first position being located within a sub-picture where the reference block is located.

In an eightieth clause, according to any one of the forty-first clause, the sixty-seventh clause and the sixty-eighth clause, further including:
determining a value of second syntax element flag information, where the second syntax element flag information is used for indicating whether a filter model is applied to the current block;
encoding the value of the second syntax element flag information, and signalling an obtained encoded bit into a bitstream.

In an eightieth-first clause, according to the eightieth clause, further including:
in response to that the filter model is not applied to the current block, a reconstructed sample value within the reference block is used as the prediction value of the current block.

In an eightieth-second clause, a bitstream is provided, where the bitstream is generated by bit coding according to information to be encoded; and the information to be encoded includes at least one of:
a prediction residual value of a current block, a number of coefficients of a target filter, a shape of a target filter, a value of first syntax element flag information, a value of second syntax element flag information, or a value of third syntax element flag information; where the first syntax element flag information is used for indicating whether template matching is applied to the current block, the second syntax element flag information is used for indicating whether a filter model is applied to the current block, and the third syntax element flag information is used for indicating a reference block of the current block.

In an eightieth-third clause, an encoder is provided, which includes a first determining unit, a first filtering unit and a first prediction unit; where
the first determining unit is configured to determine a first template of a current block, and determine a matching template and a reference block; and the first determining unit is further configured to determine a model parameter according to the first template and the matching template;
the first filtering unit is configured to filter the reference block according to the model parameter, to determine a filtered reference block;
the first prediction unit is configured to determine a prediction value of the current block according to the filtered reference block; and
the first determining unit is further configured to determine a prediction residual value of the current block according to the prediction value of the current block.

In an eightieth-fourth clause, an encoder is provided, which includes a first memory and a first processor; where

the first memory is configured to store a computer program executable on the first processor; and
the first processor is configured to, when running the computer program, perform the method according to any one of the forty-first clause to the eightieth-first clause.

In an eightieth-fifth clause, a decoder is provided, which includes a second determining unit, a second filtering unit and a second prediction unit; where
the second determining unit is configured to determine a first template of a current block, and determine a matching template and a reference block; and the second determining unit is further configured to determine a model parameter according to the first template and the matching template;
the second filtering unit is configured to filter the reference block according to the model parameter, to determine a filtered reference block;
the second prediction unit is configured to determine a prediction value of the current block according to the filtered reference block; and
the second determining unit is further configured to determine a reconstructed value of the current block according to the prediction value of the current block.

In an eightieth-sixth clause, a decoder is provided which includes a second memory and a second processor; where
the second memory, configured to store a computer program executable on the second processor; and
the second processor, configured to, when running the computer program, perform the method according to any one of the first clause to the fortieth clause.

In an eightieth-seventh clause, a computer-readable storage medium is provided, where the computer-readable storage medium stores a computer program, where when the computer program is executed, the method according to any one of the first clause to the fortieth clause is implemented, or the method according to any one of the forty-first clause to the eightieth-first clause is implemented.

What is claimed is:

1. A decoding method, applied to a decoder and comprising:
determining a first template of a current block, and determining a matching template and a reference block;
determining a model parameter according to the first template and the matching template;
filtering the reference block according to the model parameter, to determine a filtered reference block;
determining a prediction value of the current block according to the filtered reference block; and
determining a reconstructed value of the current block according to the prediction value of the current block.

2. The method according to claim 1, wherein determining the first template of the current block comprises:
determining a template type of the current block; and
determining the first template of the current block according to the template type of the current block.

3. The method according to claim 2, wherein determining the template type of the current block comprises:
determining the template type of the current block according to reference samples of the current block;
wherein the reference samples of the current block comprise at least one of: left neighbouring reference samples of the current block, top neighbouring reference samples of the current block, top-left neighbouring reference samples of the current block, bottom-left neighbouring reference samples of the current block, or top-right neighbouring reference samples of the current block;
or
decoding a bitstream, to determine the template type of the current block;
or
determining the template type of the current block according to a size of the current block.

4. The method according to claim 3, wherein determining the template type of the current block comprises:
in response to that the left neighbouring reference samples of the current block, the top neighbouring reference samples of the current block, and the top-left neighbouring reference samples of the current block are all available, determining that the template type of the current block is a first value;
in response to that the left neighbouring reference samples of the current block are available, determining that the template type of the current block is a second value;
in response to that the top neighbouring reference samples of the current block are available, determining that the template type of the current block is a third value;
in response to that the left neighbouring reference samples of the current block and the top-left neighbouring reference samples of the current block are both available, determining that the template type of the current block is a fourth value;
in response to that the left neighbouring reference samples of the current block and the bottom-left neighbouring reference samples of the current block are both available, determining that the template type of the current block is a fifth value; or
in response to that the top neighbouring reference samples of the current block and the top-right neighbouring reference samples of the current block are both available, determining that the template type of the current block is a sixth value.

5. The method according to claim 1, wherein determining the matching template comprises:
determining to construct a vector parameter candidate list of the current block according to a prediction mode parameter of the current block; and
determining a target vector parameter according to the vector parameter candidate list; and
determining the matching template according to the target vector parameter and the first template.

6. The method according to claim 5, wherein determining to construct the vector parameter candidate list of the current block according to the prediction mode parameter of the current block comprises:
determining to construct a merge vector parameter candidate list of the current block according to the prediction mode parameter of the current block; or
determining to construct an advanced motion vector prediction (AMVP) vector parameter candidate list of the current block according to the prediction mode parameter of the current block.

7. The method according to claim 1, wherein the model parameter comprises coefficients of a target filter.

8. The method according to claim 7, wherein filtering the reference block according to the model parameter, to determine the filtered reference block comprises:
calculating a product of a sample reconstructed values of the reference block and a coefficient of the target filter corresponding to the sample reconstructed value;
setting a first output value of the target filter to be equal to a sum of n products; wherein n represents a number of coefficients of the target filter, and n is a positive integer; and
determining the filtered reference block according to the first output value of the target filter.

9. The method according to claim 1, further comprising:
determining a boundary padding region of the reference block and a reference template corresponding to the reference block; and
performing boundary sample padding on the boundary padding region.

10. The method according to claim 9, wherein
the boundary padding region comprises at least one of: an edge neighbouring region of the matching template, a point neighbouring region of the matching template, an edge neighbouring region of the reference block, or a point neighbouring region of the reference block.

11. The method according to claim 9, wherein performing the boundary sample padding on the boundary padding region comprises:
performing the boundary sample padding on a first boundary padding region corresponding to the matching template by using neighbouring sample reconstructed values within the matching template; and
performing the boundary sample padding on a second boundary padding region corresponding to the reference template by using neighbouring sample reconstructed values within the reference block.

12. The method according to claim 9, further comprising:
determining that a sample at a first position within the boundary padding region is unavailable, and performing the boundary sample padding on the first position within the boundary padding region.

13. The method according to claim 12, wherein
a determination condition for availability of the sample comprises at least one of:
the sample at the first position having been reconstructed;
the first position being located within a search region;
the first position being located within a picture where the reference block is located; or
the first position being located within a sub-picture where the reference block is located.

14. An encoding method, applied to an encoder and comprising:
determining a first template of a current block, and determining a matching template and a reference block;
determining a model parameter according to the first template and the matching template;
filtering the reference block according to the model parameter, to determine a filtered reference block;
determining a prediction value of the current block according to the filtered reference block; and
determining a prediction residual value of the current block according to the prediction value of the current block.

15. The method according to claim 14, wherein determining the first template of the current block comprises:
determining a template type of the current block; and
determining the first template of the current block according to the template type of the current block.

16. The method according to claim 15, wherein determining the template type of the current block comprises:
determining the template type of the current block according to reference samples of the current block;
wherein the reference samples of the current block comprise at least one of: left neighbouring reference samples of the current block, top neighbouring reference samples of the current block, top-left neighbouring reference samples of the current block, bottom-left neighbouring reference samples of the current block, and top-right neighbouring reference samples of the current block;
or
determining the template type of the current block according to a size of the current block.

17. The method according to claim 16, wherein determining the template type of the current block comprises:
in response to that the left neighbouring reference samples of the current block, the top neighbouring reference samples of the current block, and the top-left neighbouring reference samples of the current block are all available, determining that the template type of the current block is a first value;
in response to that the left neighbouring reference samples of the current block are available, determining that the template type of the current block is a second value;
in response to that the top neighbouring reference samples of the current block are available, determining that the template type of the current block is a third value;
in response to that the left neighbouring reference samples of the current block and the top-left neighbouring reference samples of the current block are both available, determining that the template type of the current block is a fourth value;
in response to that the left neighbouring reference samples of the current block and the bottom-left neighbouring reference samples of the current block are both available, determining that the template type of the current block is a fifth value; or
in response to that the top neighbouring reference samples of the current block and the top-right neighbouring reference samples of the current block are both available, determining that the template type of the current block is a sixth value.

18. The method according to claim 14, wherein determining the matching template comprises:
determining to construct a vector parameter candidate list of the current block according to a prediction mode parameter of the current block; and
determining a target vector parameter according to the vector parameter candidate list; and
determining the matching template according to the target vector parameter and the first template.

19. The method according to claim 18, wherein determining to construct the vector parameter candidate list of the current block according to the prediction mode parameter of the current block comprises:
determining to construct a merge vector parameter candidate list of the current block according to the prediction mode parameter of the current block; or
determining to construct an advanced motion vector prediction (AMVP) vector parameter candidate list of the current block according to the prediction mode parameter of the current block.

20. A non-transitory computer-readable storage medium, wherein the non-transitory computer-readable storage medium stores a computer program and a bitstream, wherein when the computer program is executed by a processor, following operations are implemented to generate the bitstream:
determining a first template of a current block, and determining a matching template and a reference block;
determining a model parameter according to the first template and the matching template;
filtering the reference block according to the model parameter, to determine a filtered reference block;
determining a prediction value of the current block according to the filtered reference block; and
determining a prediction residual value of the current block according to the prediction value of the current block.
